(19) United States
(12) Patent Application Publication
(10) Pub. No.: US 2025/0312666 A1
(43) Pub. Date: Oct. 9, 2025

(54) PICKLEBALL PADDLE

(71) Applicant: Wilson Sporting Goods Co., Chicago, IL (US)

(72) Inventors: William D. Severa, Lombard, IL (US); Dale J. Zwack, Bartlett, IL (US); Shanoli Kumar, Novi, MI (US)

(73) Assignee: Wilson Sporting Goods Co., Chicago, IL (US)

(21) Appl. No.: 19/242,203

(22) Filed: Jun. 18, 2025

Related U.S. Application Data
(63) Continuation-in-part of application No. 17/177,899, filed on Feb. 17, 2021.
(60) Provisional application No. 62/978,101, filed on Feb. 18, 2020.

(51) Int. Cl. A63B 59/42; A63B 60/54; A63B 102/08; B32B 3/12

(52) U.S. Cl. CPC A63B 59/42; B32B 3/12; A63B 60/54; A63B 2102/08; A63B 2209/02; B32B 2250/03

(57) ABSTRACT

An example pickleball paddle may include a handle and a head coupled to the handle. The head portion includes a first plate extending in a first plane, a second plate extending in a second plane parallel to the first plane and a honeycomb arrangement of unit cells between the first plate and the second plate. Each of the unit cells has a centerline extending non-perpendicular to the first plane and the second plane.

### CROSS REFERENCE TO RELATED APPLICATIONS

The present application is continuation-in-part patent application claiming priority from co-pending U.S. patent application Ser. No. 17/177,899 filed on Feb. 17, 2021 by Thurman et al. and entitled PICKLEBALL PADDLE which claims priority from U.S. Provisional Patent Application Ser. No. 62/978,101 filed on Feb. 18, 2020 entitled PICKLEBALL PADDLE, the full disclosures both of which are hereby incorporated by reference.

### BACKGROUND

Pickleball is the fastest growing racquet sport. There is a continuing need to provide a pickleball paddle that is quieter and that improves a player's performance.

### BRIEF DESCRIPTION OF THE DRAWINGS

FIG. 1A is a front perspective view of an example pickleball paddle.

FIG. 1B is a top, side perspective view of set of example lattice structures for a pickleball paddle

FIG. 2 is a front, side perspective view of another example pickleball paddle.

FIG. 3A is a front, side perspective view of an example inner core of a pickleball paddle.

FIG. 3B is a is an enlarged side perspective view of the inner core of FIG. 3A.

FIG. 4A is a front view of a portion of another example inner core of a pickleball paddle.

FIG. 4B is a side view of the portion of the example inner core of a pickleball paddle of FIG. 4A.

FIG. 5 is a transverse sectional view of another example pickleball paddle.

FIG. 6 is a front, side perspective view of another example pickleball paddle.

FIGS. 7, 8, 9, 10 and 11 are transverse sectional views of other example pickleball paddles taken along line 7-7 of FIG. 6.

FIG. 12 is a front, side perspective view of another example pickleball paddle.

FIG. 13 is a transverse sectional view of the pickleball paddle taken along line 13-13 of FIG. 12.

FIG. 14 is a front side perspective view of another example pickleball paddle.

FIG. 15 is a transverse sectional view of the pickleball paddle taken along line 15-15 of FIG. 14.

FIG. 16 is a transverse sectional view of the pickleball paddle taken along line 15-15 of FIG. 14.

FIG. 17 is a transverse sectional view of the pickleball paddle taken along line 17-17 of FIG. 14.

FIG. 18 is a front side perspective view of another example pickleball paddle.

FIG. 19 is a transverse sectional view of the pickleball paddle taken along line 19-19 of FIG. 18.

FIG. 20 is a transverse sectional view of the pickleball paddle taken along line 20-20 of FIG. 18.

FIG. 21 is a front side perspective view of another example pickleball paddle.

FIG. 22 is a partially exploded perspective view illustrating portions of an example pickleball paddle.

FIG. 23 is a side view of the example pickleball paddle of FIG. 22.

FIG. 24 is a partially exploded perspective view illustrating portions of an example pickleball paddle.

FIG. 25 is a side view of the example pick ball paddle of FIG. 24.

FIG. 26 is a partially exploded perspective view illustrating portions of an example pickleball paddle.

FIG. 27 is a partially exploded perspective view illustrating portions of an example pickleball paddle.

FIG. 28 is a sectional view of the example pickleball paddle of FIG. 27.

FIG. 29 is a partially exploded perspective view illustrating portions of an example pickleball paddle.

FIG. 30 is a partially exploded perspective view illustrating portions of an example pickleball paddle.

FIG. 31 is an end view illustrating portions of an example pickleball paddle.

FIG. 32 is an end view illustrating portions of an example pickleball paddle.

FIG. 33 is an end view illustrating portions of an example pickleball paddle.

FIG. 34 is an end view illustrating portions of an example pickleball paddle.

FIG. 35 is an end view illustrating portions of an example pickleball paddle.

FIG. 36 is an end view illustrating portions of an example pickleball paddle.

FIG. 37 is a fragmentary perspective view illustrating portions of an example pickleball paddle.

FIG. 38 is a rear perspective view of an example pickleball paddle.

FIG. 39 is an end view illustrating portions of the example pickleball of FIG. 38.

FIG. 40 is a front view illustrating portions of an example pickleball paddle.

FIG. 41 is a sectional view of the pickleball paddle of FIG. 40 taken along line 41-41.

FIG. 42 is a sectional view of an example implementation of the pickleball paddle of FIG. 40 taken along line 41-41.

FIG. 43 is a sectional view of an example implementation of the pickleball paddle of FIG. 40 taken along line 41-41.

FIG. 44 is a sectional view of an example implementation of the pickleball paddle of FIG. 40 taken along line 41-41.

FIG. 45 is a sectional view of an example implementation of the pickleball paddle of FIG. 40 taken along line 41-41.

FIG. 46 is a front view illustrating portions of an example pickleball paddle.

FIG. 47 is a front view illustrating portions of an example pickleball paddle.

FIG. 48 is a front view illustrating portions of an example pickleball paddle.

FIG. 49 is a sectional view of the pickleball paddle of FIG. 48.

FIG. 50 is a front view illustrating portions of the example pickleball paddle of FIG. 48.

FIG. 51 is a sectional view of the pickleball paddle of FIG. 50 along line 51-51.

FIG. 52 is an end view of the pickleball paddle of FIG. 51.

FIG. 53 is a sectional view of the pickleball paddle of FIG. 50 taken along line 53-53.

FIG. 54 is a perspective view of a layup or arrangement of layers of fiber composite material.

FIG. 55 is a top perspective view of a layup of layers of fiber composite material.

FIG. 56 is a sectional view of an example pickleball paddle.

FIG. 57 is a sectional view of an example pickleball paddle.

FIG. 58 is a sectional view of an example pickleball paddle.

FIG. 59 is a sectional view of an example pickleball paddle.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION OF EXAMPLES

Disclosed are example pickleball paddles that may attenuate noise or sound produced by the impact of a pickleball with a faceplate of the pickleball paddle. Such pickleball paddles facilitate quieter play. In some implementations, such pickleball paddles also provide enhanced performance while being lightweight, less complex and easier to manufacture.

Unless otherwise indicated, the example pickleball paddles satisfy the requirements or standards for pickleball paddles used in officially sanctioned events or competitive play. Unless otherwise indicated, the example pickleball paddles satisfy the requirements set forth in the November 2023 USA Pickleball Equipment Standards Manual. Unless otherwise indicated, the example pickleball paddles each have a combined maximum length and maximum width less than or equal to 24 inches. Unless otherwise indicated, the example bucket ball paddles have opposite pickleball impacting faces that have a maximum kinetic coefficient of friction less than or equal to 0.1875 when tested pursuant to protocol IAW ASTM D1894-14. As should be appreciated, particular characteristics of the example pickleball paddles may be modified such that the pickleball paddles no longer satisfy the requirements or standards for pickleball paddles used in officially sanctioned events or competitive play, but where such modified pickleball paddles still incorporate the performance enhancement features disclosed with respect to the example pickleball paddles.

For purposes of this disclosure, the term “coupled” shall mean the joining of two members directly or indirectly to one another. Such joining may be stationary in nature or movable in nature. Such joining may be achieved with the two members, or the two members and any additional intermediate members being integrally formed as a single unitary body with one another or with the two members or the two members and any additional intermediate member being attached to one another. Such joining may be permanent in nature or alternatively may be removable or releasable in nature. The term “fluidly coupled” shall mean that two or more fluid transmitting volumes are connected directly to one another or are connected to one another by intermediate volumes or spaces such that fluid may flow from one volume into the other volume.

For purposes of this disclosure, the phrase “configured to” denotes an actual state of configuration that fundamentally ties the stated function/use to the physical characteristics of the feature proceeding the phrase “configured to”.

For purposes of this disclosure, the term “releasably” or “removably” with respect to an attachment or coupling of two structures means that the two structures may be repeatedly connected and disconnected to and from one another without material damage to either of the two structures or their functioning.

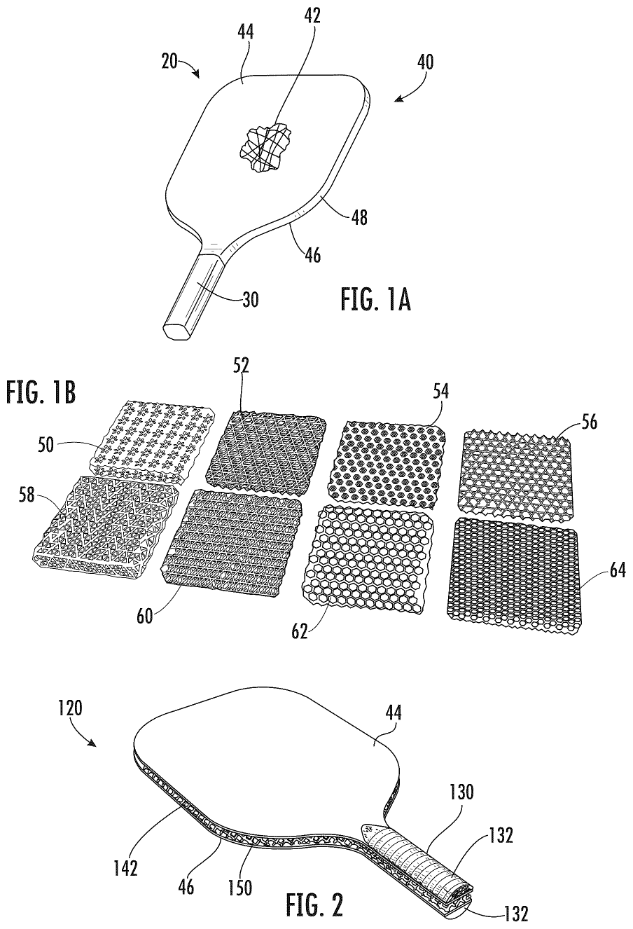

FIG. 1 illustrates an example pickleball paddle 20, or a paddle for use in the sport of pickleball. Paddle 20 provides the user with desirable sound and feel as well as a large sweet spot for striking a pickleball ball. Paddle 20 comprises handle 30 and head 40. Handle 30 extends from head 40 and is configured for being gripped by a person's hand or hands. In the example illustrated, handle 30 has a polygonal cross-sectional shape. In other implementations, handle 30 may have a circular or oval cross-sectional shape.

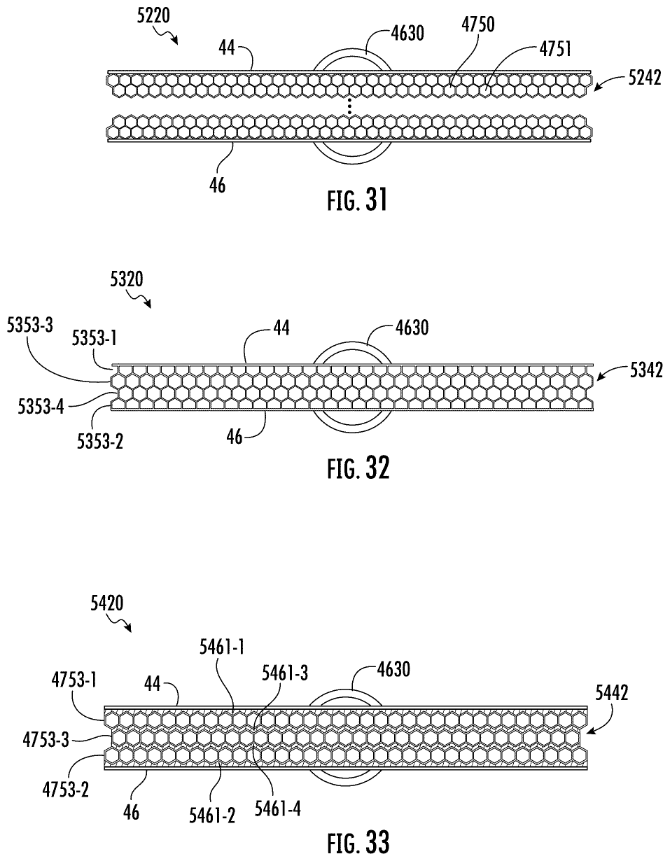

The handle 30 is a longitudinal tubular structure having a distal end and proximal end. The distal end of the handle 30 is coupled to the head 40. The handle 30 can include a grip 34 (FIG. 32A) to enhance the ability of a player to grasp, hold and manipulate the paddle 20. The handle 30 can further include a butt cap 36 (FIG. 32A) coupled to the proximal end of the handle 30. In one implementation, the butt cap 36 can be directly adhesively bonded to the proximal end. In an alternative implementation, the butt cap can be thermally bonded, mechanically fastened, or otherwise directly attached to the proximal end.

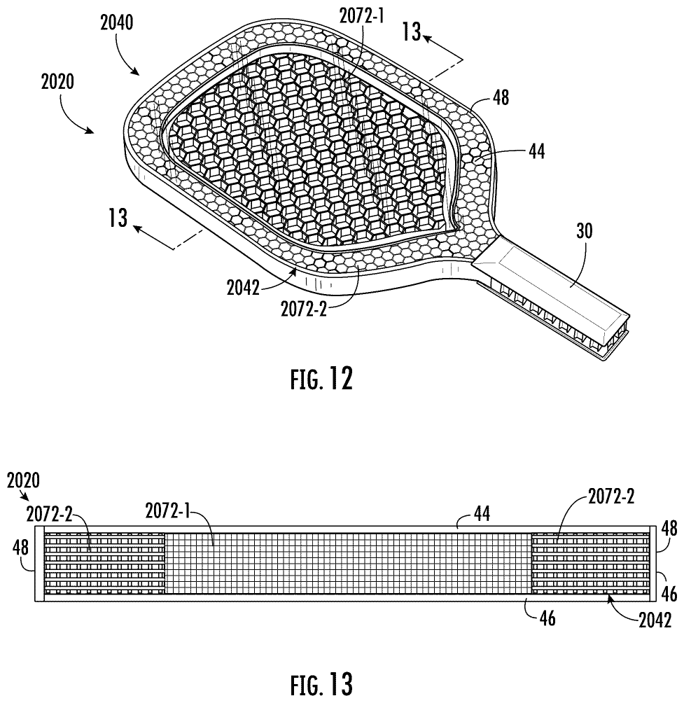

In one implementation, the handle 30 can be integrally formed with and connected to the head 40 to form a one-piece frame. Referring to FIGS. 13C and 13D, in one implementation, a perimeter of the head 40 can the handle 30 can be formed through bladder molding from a fiber composite material. The fiber composite material is molded to form the rim or perimeter of head 40 and a hair pin or pallet of the handle 30. In one implementation, a polyurethane foam, or other foam, can be applied to the hair pin to from a foamed pallet for receiving the grip 34. In another implementation, the fiber composite material can be molded to form the pallet that receives the grip 34. In another implementation, the handle 30 can be formed separate from and coupled to the head 40. The handle 30 is configured for grasping by one or more hands of a user during play. The handle 30 can be formed of one or more materials such as a carbon-fiber composite material. Alternatively, the handle portion 14 can be formed of other materials such as other composite materials, aluminum, other metallic alloys, wood, a polyurethane foam, a thermoplastic material, a thermoset material, and combinations thereof.

Head 40 is coupled to handle 30 and provides two opposing faces for striking a pickleball ball. Head 40 comprises an inner layer 42 sandwiched between a first outer faceplate 44 and a second opposite outer faceplate 46. In the example illustrated, head 40 additionally comprises an edge strip or bumper 48. For purposes of this disclosure, the term “coupled” shall mean the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate member being attached to one another. In the context of railroad cars, a caboose of a train can be directly connected to an engine of the train. Alternatively, one or more railroad cars can be positioned between the engine and the caboose. In each case, whether directly connected or separated by one or more railroad cars, the caboose is coupled to the engine.

Inner layer 42 comprises a layer composed of multiple levels of individual cells, a stack of cellular layers, which may be aligned or offset relative to one another. FIG. 1B illustrates various examples of such multi-level cellular material that may be used for inner layer 42. As shown by FIG. 1B, inner layer 42 may be formed from multi levels of rhombic cells 50, multi levels of Kagome cells 52, multi levels of Vorobom cells 54, multi levels of voro cells 56, multi levels of a first type of tetra cells 17, multi levels of a second different tetra cells 19, multi levels of Voro-1 cells 62 or multi levels of voro-2 cells 64. Each of the different candidates may be formed using a micro layer-by-micro layer additive manufacturing process. The multi levels of cells provide paddle 20 with enhanced stiffness and coefficient of restitution performance at a lower weight. In some implementations, the cells may form a nonorthogonal lattice, where the cells are not arranged so as to face in directions perpendicular to faceplates 44 and 46.

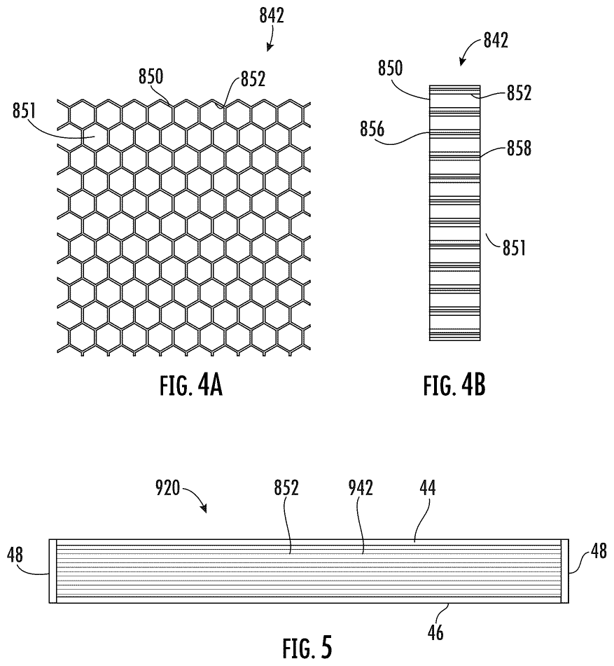

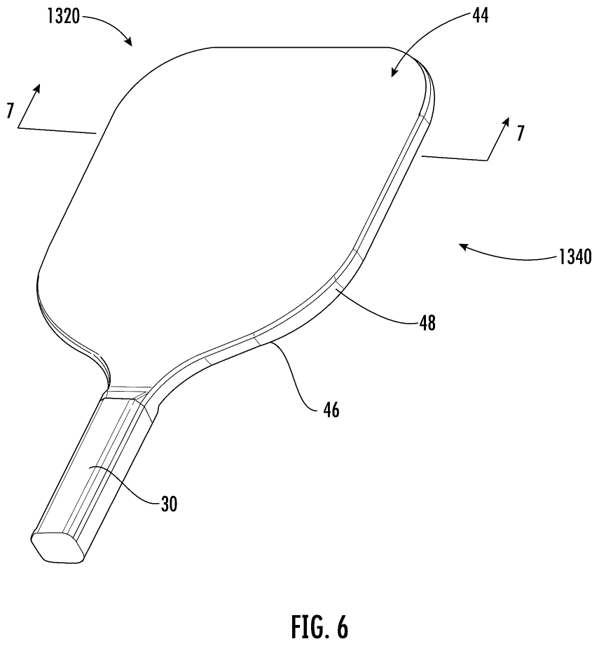

In one implementation, each of the different multilevel cellular layers may be formed from a material such as polypropylene, polyurethane, polyester, thermoplastic polyurethane (TPU), polyamide, other rigid polymer or glass/carbon filled polymer composite. In other implementations, inner layer 42 may have other layer geometries. For example, as will be described hereafter, inner layer 42 may alternatively have a closed cavity array geometry as shown in FIGS. 6-8. In yet other implementations, inner layer 42 may have variations of the example orthogonal lattice in the form of a single layer of honeycomb cells or multiple such layers of honeycomb cells, single layer of such honeycomb cells being shown in FIGS. 4A and 4B.

In some implementations, the inner layer 42 can be formed of a urethane foam, polypropylene, Nomex® polycarbonamide material, ethylene vinyl acetate (EVA), aluminum, balsa, corrugated cardboard, a rubber, polyethylene, polyvinyl chloride, a polyethylene vinyl acetate, other polymeric foams, other lightweight elastic foams, other types of wood, other metallic alloys, and combinations thereof. In some implementations, the cells of inner layer 42 may be filled or injected with a different material. For example, in one implementation, the cells of inner layer 42 may be injected with a foam material. In some implementations, selected portions of inner layer 42 may have their cells filled or injected with material, such as a foamed material or other selected portions of inner layer 42 have empty or unfilled cells. In one implementation, first selected portions may have cells filled with a first material, such as a first foamed material, second selected portions may have cells filled with a second material such as a second different foamed material and third portions having empty void cells. In such implementations, the selective filling of cells at selected locations may provide different stiffness levels and coefficient of restitution and different portions of the face of the paddle 20 to optimize performance and feel. In some implementations, the selective filling of cells may form a visually attractive design, logo, image, or other graphic which may be viewable in implementations where one or both of faceplates 44, 46 are translucent. In some implementations, different cells may be filled with different colored materials such as different colored foamed materials to provide a unique design, logo, graphic or the like which is viewable through a translucent faceplate 44 and/or 46.

Outer faceplates 44 and 46 extend on opposite sides of inner layer 42. Outer faceplates 44 and 46 comprise panels or plates that extend generally parallel to one another. In one implementation, faceplates 44 and 46 are opaque. In another implementation, one or both of faceplates 44 and 46 is formed from a translucent material. For purposes of disclosure, the term “translucent” encompasses both transparent and semi-transparent structures. Transparent structures allow light to pass through and the details of underlying structure(s) to be seen through such transparent structures. In contrast, semi-transparent structures allow diffused light, but not detailed shapes, to pass through the material without the detailed shapes and edges of structures behind the semi-transparent structure to be discernible. In one implementation, plates 44 and 46 are similar to one another in composition and stiffness. In another implementation, plates 44 and 46 are different in chemical composition, thickness and/or stiffness characteristics.

In one implementation, faceplates 44 and 46 are formed from the same material. In other implementations, faceplates 44 and 46 are formed from different materials having different material properties. In one implementation, faceplates 44 and 46 may be formed from materials such as a fiber-composite material, a braided fiber composite material, a woven material, nonwoven fibers embedded in a polymeric matrix, and combinations thereof. As used herein, the terms “composite material” or “fiber composite material” refer to a matrix or a series of plies (also referred to as sheets or layers) of fiber bundles impregnated (or permeated throughout) with a resin. The fiber bundles can be co-axially bundled and aligned in the plies. A single ply typically includes hundreds or thousands of fiber bundles that are initially arranged to extend coaxially and parallel with each other through the resin that is initially uncured. Each of the fiber bundles includes a plurality of fibers. The fibers are formed of a high tensile strength material such as carbon. Alternatively, the fibers can be formed of other materials such as, for example, glass, graphite, boron, basalt, carrot, Kevlar®, Spectra®, poly-para-phenylene-2, 6-benzobisoxazole (PBO), hemp and combinations thereof. In one set of preferred embodiments, the resin is preferably a thermosetting resin such as epoxy or polyester resins. The resin can be formed of the same material from one ply to another ply. Alternatively, each ply can use a different resin formulation. During heating and curing, the resin can flow between plies and within the fiber bundles. The faceplates 44 and/or 46 can be coated with one or more layers of paint and/or clear coats. Examples of translucent materials which may be used to form faceplate 44 and/or 46 include, but are not limited to, polycarbonate, poly methyl methacrylate, polyamide 5, polyolefins (e.g., polyethylene), or polyurethane.

In one implementation, plates 44 and 46 are adhesively bonded to opposite faces of inner layer 42. In yet another implementation, plates 44 and 46 are welded or fused to inner layer 42. In some implementations, plates 44 and 46 are integrally formed as a single unitary body with inner layer 42, such as where inner layer 42 and layers or faceplates 44 and 46 are formed through additive manufacturing techniques. As will be described hereafter, in yet other implementations, plates 44 and/or 46 may be removably mounted to paddle 20, over inner layer 42, facilitating exchange of faceplates 44 and/or 46 for customization or modification of paddle 20.

Bumper 48 comprises a strip of material covering the outer peripheral edge of inner layer 42. In one implementation, bumper 48 is opaque, concealing inner layer 42. In other implementations, bumper 48 is translucent, facilitating a view of inner layer 42. In one implementation, bumper 48 may be formed from a thin strip of a polymeric film or tape adhesively bonded to the exterior of inner layer once 42. In yet other implementations, bumper 48 may be a layer that is coated about the peripheral edge of inner layer 42. Examples of materials from which bumper 48 may be formed include, but are not limited to, nylon, rubber, a thermoplastic material, a thermoset material, wood, and combinations thereof. In other implementations, the paddle may be formed without a bumper.

FIG. 2 illustrates an example pickleball paddle 120. Pickleball paddle 120 comprises handle 130 and head 140. Paddle 120 is similar to paddle 20 except that paddle 120 is illustrated without bumper 48 to illustrate the example nonorthogonal lattice 150 forming inner layer 142 sandwiched between faceplates 44 and 46. The non-orthogonal lattice 150 comprises a three-dimensional array of lattice segments joining interconnecting nodes and forming a two dimensional array or three-dimensional array of pockets or cells having faces facing in directions or centerlines extending in directions nonparallel (non-orthogonal) to the plane of the outer faceplate 44 and 46. Because the cells face in directions nonorthogonal to the faceplates 44 and 46, the cells may produce generate a lower volume of sound when striking a pickleball ball. In addition, the cells may provide a more desirable stiffness and coefficient of restitution when striking a pickleball.

In one implementation, paddle 120 includes bumper 48 which is opaque. In another implementation, paddle 120 includes a bumper 48 which is translucent. In yet another implementation, paddle 120 may omit bumper 48, reducing the weight of paddle 120 and revealing inner layer 142. As shown by FIG. 2, in addition to forming an interior core of head 140, inner layer 142 extends from head 140 to also form an inner core or middle layer of handle 130. A pallet 132 can be applied over the inner core or middle layer of handle 130. As a result, paddle 120 provides enhanced stiffness and enhanced feel.

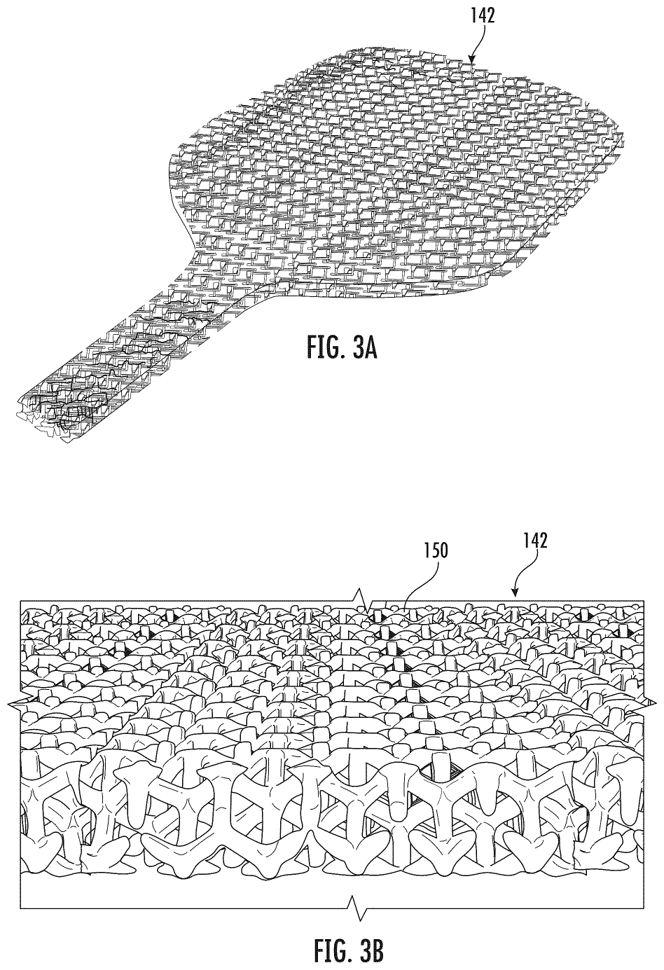

FIGS. 3A and 3B illustrate inner layer 142 in more detail. FIG. 3B illustrates the orientation and configuration of the individual cells forming nonorthogonal lattice 150. In one implementation, nonorthogonal lattice 150 comprises a polymer such as rigid polyurethane. In other implementations, lattice 50 may be formed from other materials such as thermoplastic polyurethane, polypropylene, Nomex® polycarbonamide material, ethylene vinyl acetate (EVA), polyethylene, polyvinyl chloride, a polyethylene vinyl acetate, polyamide, acrylonitrile butadiene styrene (ABS), poly ether (ether) ketone, polylactic acid, acrylate-based polymeric system mimicking one of the aforementioned polymers, other polymeric materials, other lightweight elastomeric, thermoplastic or thermoset materials, and combinations thereof. In one implementation, the nonorthogonal as 150 comprise a single layer of lattices having a thickness of at least 0.1 mm and no greater than 10 mm. In one implementation, the nonorthogonal lattice 150 is formed by additive manufacturing, wherein the lattice 150 is formed on a continuous or discrete layer-by-layer basis and wherein lattice 50 may be formed from multiple individual and consecutively deposited layers of material.

FIGS. 4A and 4B illustrate portions of an example inner layer 842 which may have the same shape and dimensions as that of inner layers 42 and 142 described above. Inner layer 842 comprises an orthogonal lattice 850 in the form of a two-dimensional array of orthogonal lattices such as honeycomb cells 852. The honeycomb cells 852 may be formed from an additive manufacturing process or may be formed from an extrusion process. FIG. 4A provides dimensions for one example lattice 850. In other implementations, lattice 850 and its individual cells 852 may have other corresponding dimensions. In the example illustrated, cells 852 have centerline 851 that extends between plates 44 and 46 as shown in FIG. 1, or between opposing faces of inner layer 842. In particular, lattice 850 has a first face 856 that abuts or faces plate 44 and a second opposite face 817 that faces or abuts plate 46.

FIG. 5 is a sectional view of an example pickleball paddle 920. Paddle 920 is similar to paddle 20 described above except that paddle 920 comprises an inner layer 942 in place of inner layer 42. Inner layer 942 is similar to inner layer 842 described above except that the individual cells 852 are oriented so as to have centerline that extend parallel to plates 44 and 46 rather than orthogonal to plates 44 and 46. In one implementation, the individual cells 852 are centered along lines that extend perpendicular to the longitudinal axis of handle 30 (shown in FIG. 1), yet parallel to plates 44 and 46. In another implementation, the individual cells 852 are centered along lines that extend parallel to the longitudinal axis of handle 30 shown in FIG. 1 yet parallel to face plates 44 and 46. In yet another implementation, the individual cells 852 centered along lines that extend oblique to the longitudinal axis of handle 30, yet parallel to face plates 44 and 46.

Lattice 942 can provide an alternative feel, stiffness and/or coefficient of restitution as compared to lattice 150. In one implementation, lattice 942 may be formed by an additive manufacturing process. In yet another implementation, lattice 942 may be formed from an extrusion process. In one implementation, lattice 942 may be formed from a polymer such as rigid polyurethane. In other implementations, lattice 942 may be formed from other materials such as thermoplastic polyurethane, polypropylene, Nomex® polycarbonamide material, ethylene vinyl acetate (EVA), polyethylene, polyvinyl chloride, a polyethylene vinyl acetate, polyamide, acrylonitrile butadiene styrene (ABS), poly ether (ether) ketone, polylactic acid, acrylate-based polymeric system mimicking one of the aforementioned polymers, other polymeric materials, other lightweight elastomeric, thermoplastic or thermoset materials, and combinations thereof.

FIGS. 6 and 7 illustrate an example pickleball paddle 1320. Pickleball paddle 1320 comprises handle 30 and head 1340. As shown by FIG. 6, head 1340 comprises outer plates 44 and 46 sandwiching an inner layer 1342 therebetween. Head 1340 further comprises bumper 48 extending about the perimeter of inner layer 1342 (shown in FIG. 7). As described above, plates 44, 46 and bumper 48 may be opaque in some implementations or may be translucent or transparent in other implementations.

Inner layer 1342 comprises sub layers 1370-1 and 1370-2 (collectively referred to as sub layers 1370). Sub layers 1370 comprise layers of different open celled material. In one implementation, each layer 1370 comprises a different layer of a nonorthogonal lattice. For example, in one implementation, layers 1370 may comprise a first layer selected from a group of layers consisting of a nonorthogonal lattice, a closed cell cavity array, a mesh, or a honeycomb array, and a second layer, different than the first layer, also selected from a group of layers consisting of a nonorthogonal lattice, a closed cell cavity array, a mesh, or a honeycomb array. By providing inner layer 1342 with two different sub layers 1370-1 and 1370-2, paddle 1320 comprises two different striking performance capabilities: a first striking performance for balls struck by faceplate 44 and a second striking performance for ball struck by faceplate 46. As a result, a player may, depending upon the game circumstances, select which face, 44 or 46, to use to strike the ball depending upon the desired result.

In one implementation, layers 1370 are adhesively bonded to one another. In yet another implementation, layers 1370 are integrally formed from a single unitary body of material formed by an additive manufacturing process. In yet other implementations, layers 1370 simply rests alongside one another without an adhesive. In such an embodiment, the layers 1370 may be able to move independently with respect with each upon impact with a pickleball. In one implementation, layers 1370 have similar thicknesses. In yet other implementations, layers 1370 may have differing thicknesses.

In some implementations, layers 1370-1 and 1372 may be formed from different colored materials, while layers 44 and 46 are translucent, to visibly differentiate the layers and their different hitting characteristics. In certain implementations, selected portions of layer 1370-1 and/or layer 1370-2 may be filled with material. For example, portions of layer 1370-1 and/or 1370-2 may be selectively filled with material. In such an implementation, plates 44 and 46 may be opaque, may be translucent or may be selectively opaque and selectively translucent in different portions. In one implementation, each of layers 1370-1 and 1370-2 are filled with different materials. In such an implementation, one or both of plates 44 and 46 may be opaque with a transparent or translucent window.

FIG. 8 is a sectional view illustrating head 1440 which may be used in place of head 1340 described above. Head 1440 is similar to head 1340 except that head 1440 omits bumper 48. As a result, the peripheral edges of layers 1370 are viewable.

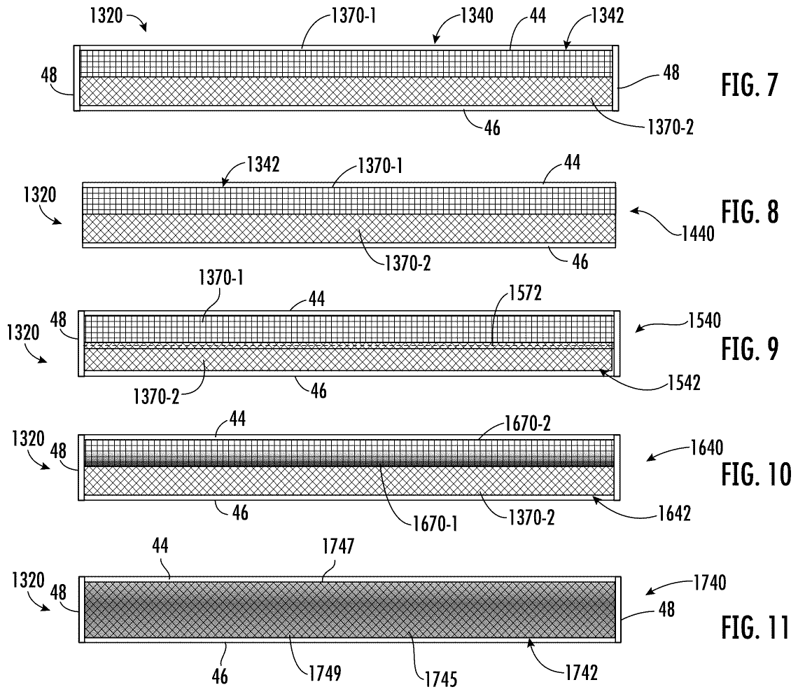

FIG. 9 is a sectional view illustrating head 1540 which may be used in place of head 1340 described above. Head 1540 is similar to head 1340 except that head 1540 comprises an inner layer 1542. Inner layer 1542 is similar to inner layer 1342 except that inner layer 1542 additionally comprises release layer 1572. Release layer 1572 is sandwiched between layers 1370. Release layer 1572 facilitates transverse, sliding, or independent movement of layer 1370-1 relative to layer 1370-2 upon the impact of the head 1540 of the paddle 1320 with a pickleball. In one implementation, release layer 1572 is bonded to, fused to, or coated upon layer 1370-1 so as to move with layer 1370-1, yet slide relative to layer 1370-2 or move independently with respect to layer 1370-2. In yet other implementations, release layer 1572 can be bonded to, fused to, or coated upon layer 1370-2 so as to move with layer 1370-2, yet slide or move independently relative to layer 1370-1. In yet other implementations, release layer 1572 is not secured to either of layers 1370, being movable relative to each of layers 1370. In one implementation, release layer 1572 may be formed from a layer of low friction material such as polytetrafluoroethylene. In yet other implementations, release layer 1572 may be formed from other materials such as polydimethylsiloxane (PDMS) or other low surface energy and/or lubricating polymers.

FIG. 10 is a sectional view illustrating head 1640 which may be used in place of head 1340 described above. Head 1640 is similar to head 1340 except that head 1640 comprises an inner layer 1642. Inner layer 1642 comprises sub layers 1370-2 (described above), 1670-1 and 1670-2. Sublayer 1670-1 is sandwiched between sub layers 1370-2 and 1670-2. Sublayer 1670-1 comprises a solid layer of material disposed between such layers. In implementations where faceplates 44 and 46 are translucent, sublayer 1670-1 separates layers 1370-2 and 1670-2 such that closed cavities or cells of the different layers 1370-2 and 1670-2 are not simultaneously viewable through a single one of faceplates 44, 46, providing a clear differentiation of such layers. In one implementation, sublayer 1670-1 may comprise a reflective material such as a white colored material or a metallic mirror-like layer of material. In some implementations, layer 1670-1 may be omitted, where an empty void is provided between layers 1370-2 and 1670-2 or where the thickness of one of layers 1370-2 and/or 1670-2 is increased to fill the void formed by the omission of layer 1670-1.

Sublayer 1670-2 may comprise a nonorthogonal lattice, similar to that described above with respect to FIGS. 2-4B. As schematically shown by the different depicted gradient, sublayer 1670-2 has a varying density of cells in a direction perpendicular to the plane of faceplates 44 and 46. In one implementation, the density of the individual cells of sublayer 1670-2 is greatest near sublayer 1670-1 and gradually decreases as layer 1670-2 approaches faceplates 44. In other implementations, this transition may be reversed where sublayer 1670-2 has the greatest density of cells near faceplates 44 and wherein the density gradually decreases as sublayer 1670-2 approaches faceplates 46. In still other implementations, instead of gradually transitioning between the highest density to the lowest density of cells, layer 1670-2 may provide one or more transitions in a stepwise fashion. Such a density variation may provide a selected stiffness and/or coefficient of restitution for the ball striking surface of faceplates 44 four enhanced ball striking performance. In some implementations, sublayer 1670-2 may have a uniform or homogeneous density of cells.

In one implementation, layer 1670-2 is formed on a micro layer by micro layer basis with an additive manufacturing process, facilitating the variation of the density of the individual cells, yet providing layer 1670-2 as a single integral unitary body of material. In one implementation, layers 1670-1 and 1370-2 are bonded, fused, or laid (without bonding or fusing) next to layer 1670-2. In yet other implementations, each of layers 1370-2, 1670-1 and 1670-2 are formed as a single integral unitary body of material such as with a micro layer by law micro layer additive manufacturing process. In some implementations, faceplates 44 and/or 46 as well as bumper 48 may also be formed as a single integral unitary body of material with layers 1670-2, 1670-1 and 1370-2 using a micro layer by micro layer additive manufacturing process. In some implementations, layer 1670 may be originally formed as a single unitary body with faceplates 44 while layers 1670-1 and/or 1370-2 are integrally formed as a single unitary body with faceplates 46 using an additive manufacturing (3D printing) process, wherein the two integral bodies are then subsequently fused, bonded or retained adjacent to one another to form head 1640.

FIG. 11 is a sectional view illustrating head 1740 which may be used in place of head 1340 described above. Head 1740 is similar to head 1340 except that head 1740 comprises an inner layer 1742. Inner layer 1742 comprise a single integral unitary body of open celled material such as a nonorthogonal lattice as illustrated in FIGS. 2-3B. Inner layer 1742 sandwiched between faceplates 44 and 46, contacting or directly bonded to each of faceplates 44 and 46. Inner layer 1742 is itself similar to sublayer 1670-2 in that inner layer 1742 has a varying density in a direction perpendicular to the plane of faceplates 44 and 46. In the example illustrated, inner layer 1742 has a central or middle region 1745 having a greater density of cells and to opposite outer regions 1747 and 1749 having a lesser density of cells. In one implementation, the change in density of cells is gradual with no abrupt transition. In yet another implementation, the change in the density of the cells is stepped with sharp or abrupt transitions. In one implementation, layer 1742 may be formed as a single integral unitary body using a micro layer by micro layer additive manufacturing process. In some implementations, inner layer 1742 may be integrally formed as a single unitary body with one or both of faceplates 44 and 46 (and in some implementations bumper 48) using a micro layer by micro layer additive manufacturing process. The varying density of cells across the thickness of layer 1742 provides a customized ball stiffness and ball striking performance for the paddle 1320 including head 1740.

Although layer 1742 is illustrated as being more dense in a central region and changing to a lower density of cells approaching faceplates 44 and 46, in other implementations, the central portion or core of layer 1742 may have a lesser density of cells, or the density of cells increases when approaching faceplates 44 and 46. Although region 1745 is illustrated as being symmetrically located, equidistantly spaced from, faceplates 44 and 46, in some implementations, region 1745 may be asymmetrically positioned between faceplates 44 and 46, being closer to one of faceplates 44, 46 as compared to the other of faceplates 44 and 46. In still other implementations, inner layer 1742 may have a first region adjacent to one of faceplates 44, 46 with a greater density, wherein the density of cells decreases as layer 1742 approaches the other of faceplates 44, 46. In such an implementation, the two different faces of head 1740 may offer distinct feel coefficient of restitution and other hitting performance qualities.

As described above, in some implementations, one or both of faceplates 44, 46 may be translucent to allow a player to visibly discern between the two opposite faces or to visibly see the layer 1742. In some implementations, the cells of layer 1742 may be selectively filled with material. For example, in one implementation, layer 1742 may be selectively filled with different materials. Layer 1742 may include unfilled portions and filled portions. In such implementations, selected portions of faceplates 44 and 46 may be opaque while the portions may be translucent to facilitate viewing of the selectively field regions.

FIGS. 12 and 13 illustrate an example pickleball paddle 2020. Pickleball paddle 2020 comprises handle 30 and head portion 2040. Head portion 2040 comprises inner layer 2042. Inner layer 2042 is sandwiched between faceplates 44 and 46 and bordered by bumper 48. In the example illustrated, bumper 48 is opaque while faceplates 44 and 46 are translucent. In some implementations, bumper 48 may also be translucent or may be omitted.

Inner layer 2042 comprises sublayers 2072-1 and 2072-2 (collectively referred to as sublayers 2072). Sublayers 2072 extend side-by-side within a single plane between faceplates 44 and 46. Sublayers 2072 are each formed from a different material having a different chemical composition and/or a different architecture or geometry. As a result, sublayers 2072 provide distinct portions of head 2040 with distinct and customized coefficient of restitution, stiffness and other ball striking qualities.

In the example illustrated, sublayer 2072-2 extends along the peripheral edge of head 2040, adjacent to bumper 48 and from handle 30. Sublayer 2072-1 is surrounded or enclosed by sublayer 2072-2 within the plane between faceplates 44, 46. In other implementations, sublayers 2072 may have different shapes and relative sizes. In still other implementations, inner layer 2042 may include greater than two distinct sublayers form from different materials or geometries.

In the example illustrated, sublayers 2072 are each formed from a same material having the same chemical composition, with different geometries. In the example illustrated, sublayers 2072 are each formed from a same material having honeycomb cells, wherein sublayers 2072 have differing densities of honeycomb cells. In other implementations, sublayers 2072 are formed from the same material having a single nonorthogonal lattice geometry/architecture, wherein sublayers 2072 have different densities of the lattice, different densities of cells. In other implementations, sublayers 2072 may be formed with different densities of cells, one or more orthogonal lattices, and/or out of different materials. In another implementation, such sublayers may be integrally formed as a single unitary body using a micro layer by micro layer additive manufacturing process.

In still other implementations, sublayers 2072 may be formed from different cell/lattice geometries. For example, one of sublayers 2072 may have a nonorthogonal lattice while the other of sublayers 2072 is a honeycomb cell layout. One of sublayers 2072 may have a first nonorthogonal lattice geometry while the other of sublayers 2072 has a second different nonorthogonal lattice geometry. In some implementations, the differing sublayers 2072 may have different cell/lattice geometries and be formed from different materials. In each of the above-described example implementations, the cells/lattices of sublayers 2072 may be differently filled with a filling material as described above with respect to inner layer 1242. In each of such implementations, the cells/lattices of each individual sublayer 2070-1, 2070-2 may have the same or differing cell density variations, extending perpendicular to the plane of faceplates 44, 46 as described above with respect to sublayer 1670-2 or inner layer 1742, or extending parallel to the plane of faceplates 44, 46 as described above with respect to inner layer 1942.

In each of the implementations, sublayers 2072 may be formed from material having the same color or may be formed from the same material different material having different colors. The differing colors, when in combination with a translucent faceplate 44, 46 may further assist in the user identifying the boundaries of the different sublayers 2070-2 to assist in determining how to position a paddle when striking a pickleball such that the ball is struck with a desired result in a given game circumstance. For example, in a first circumstance, the player may decide to strike the pickleball with a first one of sublayers 2072-1 and in a different circumstance may decide to strike the ball with sublayer 2072-2 to produce a different result. In one implementation, a top half of head 2040 may include a first sublayer while the bottom half of head 2040 includes a second different sublayer to provide distinct ball striking qualities. In yet another implementation, a left side of head 2040 may include a first sublayer of the right side of head 2040 as a second different sublayer to provide distinct ball striking qualities. During particular circumstances in a game, a player may choose to use the top/bottom or left side/right side to attain different ball striking results.

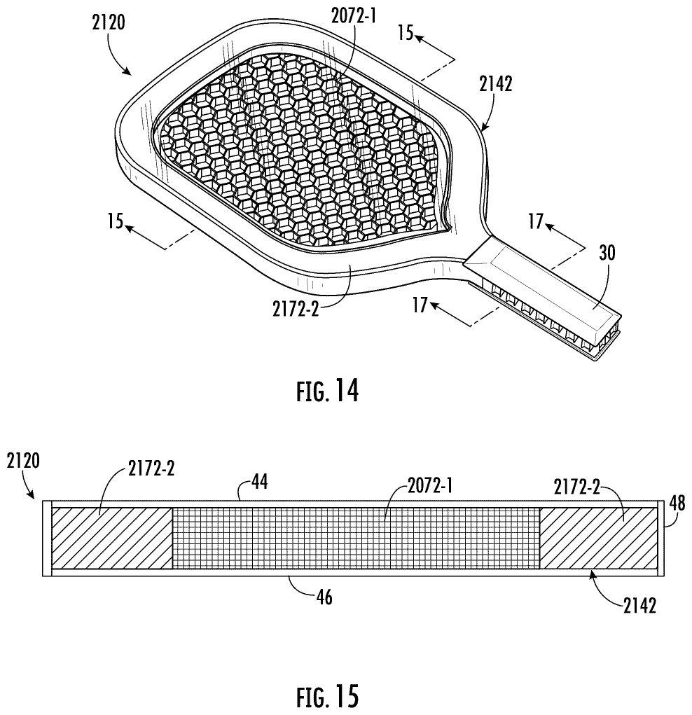

FIGS. 14 and 15 illustrate an example pickleball paddle 2120. Paddle 2120 is similar to paddle 2020 described above except that paddle 2120 comprises a head portion 2140 having inner layer 2142. Inner layer 2142 is similar to inner layer 2042 except the inner layer 2142 replaces sublayer 2072-2 with sublayer 2172-2. Sublayer 2072-1 forms the central region or portion of the head portion 2140. Sublayer 2172-2 comprises a layer of material omitting open cells or lattices. In one implementation, sublayer 2172 comprise a closed cell foam material. In another implementation, sublayer 2172-2 comprises a solid polymer. Sublayer 2172-2 may provide enhanced stiffness or weight distribution. In other implementations, sublayers 2172-2 and/or 2072-1 can be formed of a wood, a plastic, a closed cellular material, a composite material, an alloy, and combinations thereof.

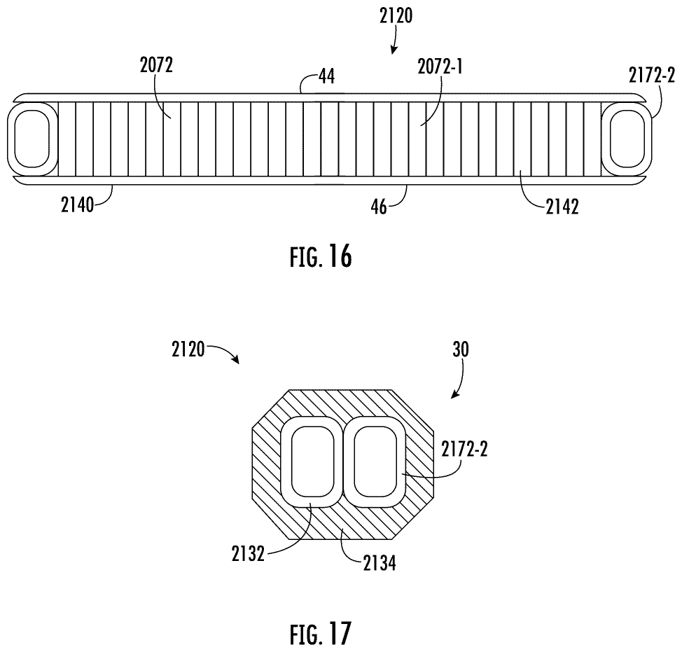

FIGS. 14, 15, 16 and 17 illustrate another example of pickleball paddle 2120. Paddle 2120 includes head portion 2140 that includes the inner layer 2142. In the implementation of FIG. 16, sublayer 2172-2 is a tubular body formed of fiber composite material, similar to a composite tennis racquet frame. In one implementation, the sublayer 2172-2 is one elongate tube of fiber composite material that is molded into the shape of the perimeter of the head portion 2140. In another implementation, the two ends of the tubular body of fiber composite material of sublayer 2172-2 can be drawn together and positioned side by side through the handle 30 to form a hairpin 2132 beneath the handle 30. The handle 30 can also include a pallet 2134 positioned over the hairpin 2132 of sublayer 2172-2 within the handle 30. The pallet 2134 provides the polygonal cross-sectional shape to the handle 30. The pallet 2134 is preferably formed of a lightweight durable material such as, for example, wood, a rigid polyurethane foam, a plastic, other foams, or lattice structures similar to sublayer 2072-1. Faceplates 44 and 46 can be positioned over each side of the head portion 2140. In one implementation, the paddle 2120 can be formed without a bumper 48. In such an implementation, the tubular body of the sublayer 2172-2 provides the outer peripheral edge surface. In another implementation, a bumper can be positioned over the outer peripheral edge surface of the tubular body of sublayer 2072-2. Sublayer 2072-1 can be positioned within the closed curved opening defined by the tubular body of sublayer 2072-2. Sublayer 2072-1 can be a single orthogonal layer of cells. In other implementations, sublayer 2072 can be two or more layers of cells, and each layer can be an orthogonal and/or a nonorthogonal cell layer.

FIGS. 18, 19 and 20 illustrate an example pickleball paddle 2220. Pickleball paddle 2220 is similar to paddle 2020 or paddle 2120 described above except that paddle 2220 additionally comprises crossbeams 2274-1 and 2274-2 (collectively referred to as crossbeams 2274). Crossbeams 2274 extend through and across sublayers 2072-1 and 2072-2 to divide such sublayers 2072 into distinct portions. In other implementations, the crossbeams can extend through, over or under sublayer 2072-1 and/or 2072-2, such that the crossbeams 2274 do not fully divide sublayers 2072 into distinct portions. In one implementation, each of crossbeams 2274 comprises a solid rail or wall providing enhanced stiffness where crossbeams 2274 extend. In the example illustrated, crossbeam 2274-1 extends parallel to the longitudinal axis 31 of handle 30 substantially from handle 30 to the opposite end of head 2240. Crossbeam 2274-2 extends across head 2240 in a direction perpendicular to axis 31 through a center of head 2240. Crossbeams 2274 intersect one another at a center point of head 2240. In another implementation, at least one of the crossbeams 2274 can be formed of a fiber composite material and take an elongate tubular shape. The crossbeams can be molded in conjunction with the fiber composite sublayer 2072-2 of FIG. 10. In other implementations, the crossbeams can be formed of other rigid durable materials, such as, for example, wood, aluminum, other alloys, a plastic, a thermoset material, a rigid thermoplastic material, and combinations thereof.

Although crossbeams 2274 are illustrated as extending perpendicular to one another and intersecting one another at a center point of head 2240, in other implementations, crossbeams 2274 may extend through and across head portion 2240 in other locations and may extended other angles relative to one another. Although head 2240 is illustrated as comprising two intersecting cross rails 2274, in other implementations, head 2240 may include a single cross beam 2274 or may include greater than two crossbeams 2274, wherein the multiple crossbeams 2274 intersect at multiple points or wherein the crossbeams 2274 do not intersect one another when extending across head 2240.

Although each of the portions of head 2240 are separated from other portions by crossbeams 2274, FIG. 18 illustrates the head 2240 as having the same combination of cells/lattices (the cells of layer 2072-1 and the cells of layer 2072-2). In other implementations, each of the four quadrants formed by crossbeams 2274 may be filled with different sublayers or different cells/lattices. For example, in one implementation, each of the different quadrants may include a different arrangement or array of cells/lattices. One quadrant may include a nonorthogonal lattices one another quadrant may include a honeycomb cell array. One quadrant may include nonorthogonal lattices of a first lattice density while another quadrant may include nonorthogonal lattices of a second greater lattice density. Different quadrants may be provided with different customized pickleball striking characteristics.

As described above, in some implementations, selected portions of sublayers 2072-1 and 2072-2, or different quadrants formed by cross beams 2274, may be filled to further alter the sound or stiffness characteristics of selected portions of head 2240. For example, selected portion may be filled with materials as described above with respect to inner layer 1242. In some implementations, one or both of the faceplates 44, 46 may be opaque, may be translucent or may have selected portions that are translucent to facilitate viewing. In some implementations, the cells/lattice densities within the different quadrants may vary in direction perpendicular to faceplates 44, 46, and/or in directions parallel to faceplates 44, 46. For example, in some implementations, sublayer 2072-1 may gradually or stepwise increase in density as such sublayers approach the intersection of crossbeams 2274. In other implementations, inner layer 2072 may gradually or stepwise decrease in density as the sublayer distances itself from the intersection of crossbeams 2274. This varying density may provide for more uniform density given the increased density at the intersection of crossbeams 2274.

FIG. 21 is a perspective view of an example pickleball paddle 2320. Paddle 2330 is similar to paddle 2120 except that pickleball paddle 2320 comprises crossbeams 2374-1, 2374-2 and 2374-3 (collectively referred to as crossbeams 2374 are similar to crossbeams 2274 except that crossbeams 2374 radially spread out our fan out from proximate handle 30 towards the distal end of head 2340. Crossbeams 2374 provide enhanced stiffness is selected portions of head 2340 for customized pickleball striking performance. In other implementations, additional crossbeams may extend across crossbeams 2374. As shown by FIG. 21, each of faceplates 44 and 46 are translucent, similar to faceplates 44 and 46 of paddle 2220. In other implementations, one or both of faceplates 44 and 46 may be opaque or may be partially opaque. The crossbeams 2374 can be formed in a manner similar to crossbeams 2274 in that the crossbeams may be solid rigid bars, ribs or walls, or the crossbeams can be formed of fiber composite material resulting in an elongate tubular fiber composite section. Similarly, crossbeams 2374 may be configured to divide inner layer 2072-1 in separate spaced apart sections or regions. In other implementations, the crossbeams 2374 may extend over, under or through a portion of the inner layer 2072-1 in a manner that does not fully space apart or separate the inner layer 2072-1 into separate portions or sections.

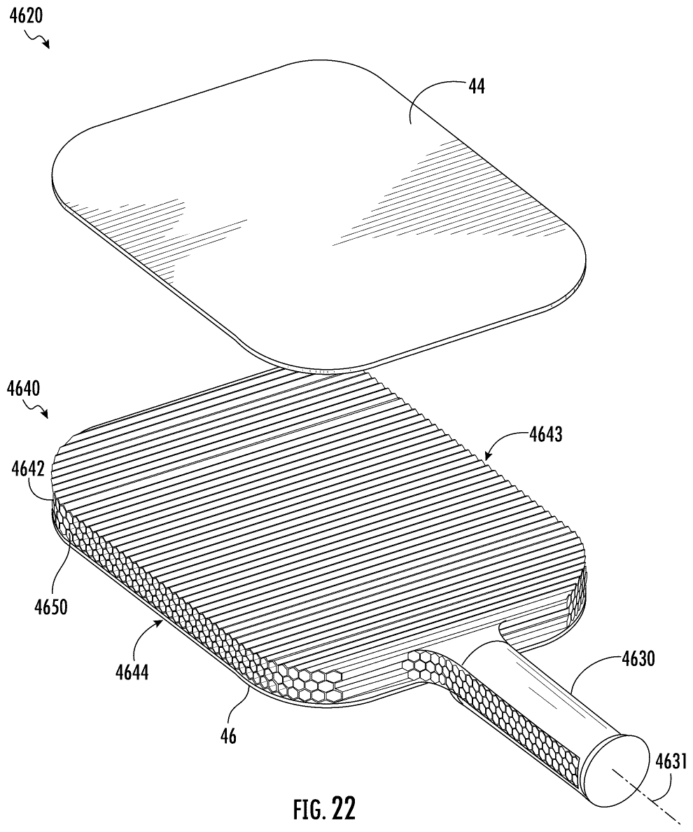

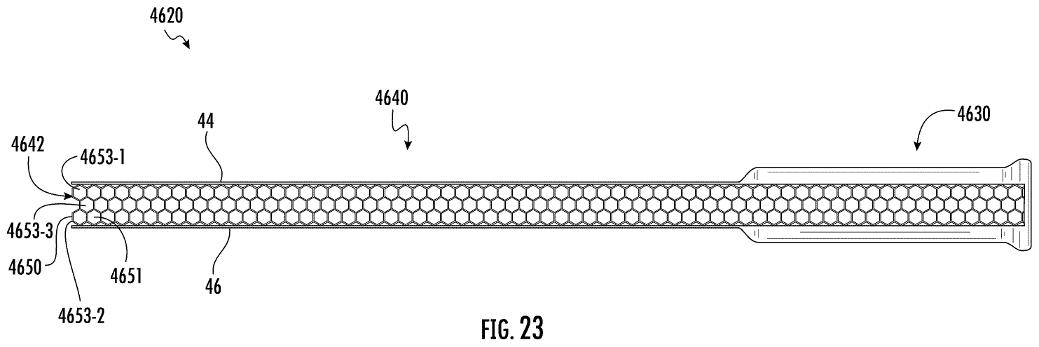

FIGS. 22 and 23 illustrate portions of an example pickleball paddle 4620. FIG. 22 is a partially exploded perspective view illustrating portions of an example pickleball paddle 4620. FIG. 23 is a side view of the portions of the paddle 4620 shown in FIG. 22.

Pickleball paddle 4620 is an example of one of the pickleball paddles described with respect to FIG. 5 above. Pickleball paddle 4620 comprises handle 4630 and head 4640. Paddle 4620 is similar to paddle 20 except that paddle 4620 is illustrated without bumper 48 to illustrate the example honeycomb arrangement of unit cells 4650 forming inner layer 4642 sandwiched between faceplates 44 and 46 (described above). The unit cells 4650 each have a centerline 4651 extending non-perpendicular to planes of the outer plates 44, 46. In the example illustrated, the centerlines 4651 of the unit cells extend parallel to the planes of the outer plates 44, 46 and perpendicular to the longitudinal axis 4631 of the handle 4630. Because the cells 4650 and their centerlines 4651 face in directions non perpendicular to the faceplates 44 and 46, the cells 4650 may produce a lower volume of sound when striking a pickleball ball.

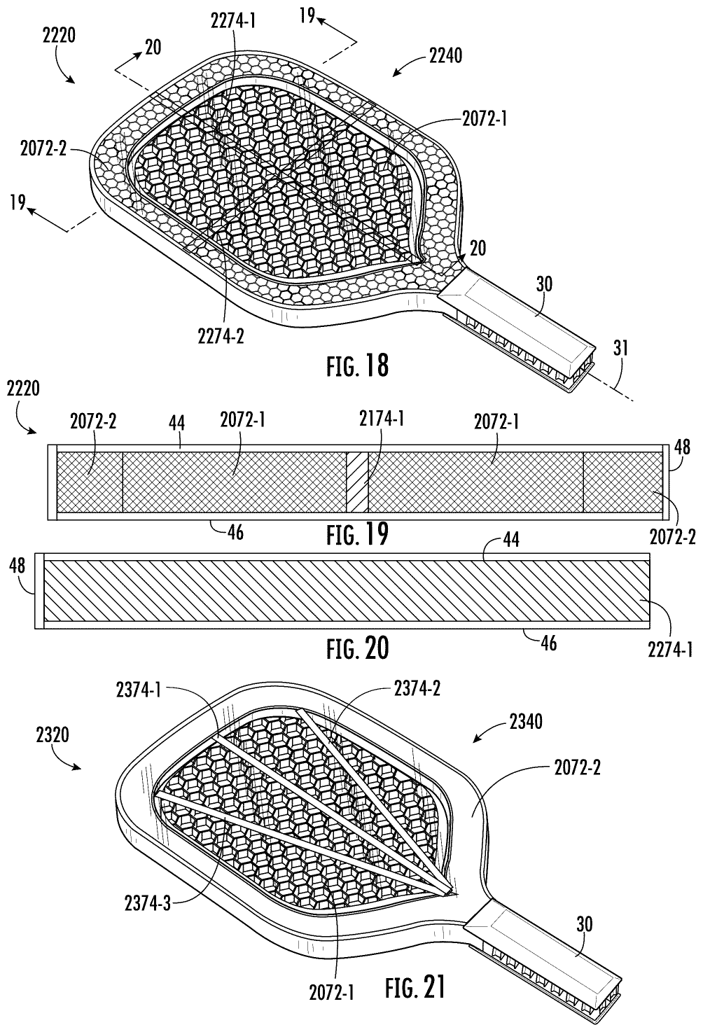

In the example illustrated, the inner layer 4642 comprises a stack of multiple layers of unit cells 4650, each layer comprising multiple end-to-end unit cells (in a row as seen in FIG. 17). In the illustrated example, inner layer 4642 comprises three stacks of layers, layer 4653-1, 4653-2, and 4653-3 (collectively referred to as layers 4653). Layer 4653-1 extends directly adjacent to plates 44. Layer 4653-2 extends directly adjacent to plates 46. Layer 4653-3 is sandwiched between and in contact with each of layers 4653-1 and 4653-2. In the example illustrated, layers 4653 of unit cells 4650 continue beyond head 4640 and form an interior core portion of handle 4630. In other implementations, layers 4653 of unit cells 4650 terminate prior to handle 4630, forming just interior portions of head 4640.

As shown by FIG. 22, in the example illustrated, each of unit cells 4650 comprise a continuous elongate tube extending from a first lateral side 4643 to a second opposite lateral side 4644 of head 4640. In other implementations, one or more of the layers 4653 of inner layer 4642 may be formed from multiple individual tubes aligned end-to-end (or spaced from one another but aligned along a common axis) so as to collectively extend between sides 4643 and 4644. In the example illustrated, each continuous elongate tube forming a unit cell 4650 has a hexagonal cross-section. In the example illustrated, each continuous elongate tube forming unit cell 4650 is complete or whole in that none of the unit cells 4650 are cut (each of the unit cells 4650 has all of its six walls). For example, each of the unit cells 4650 in layer 4653-1 are complete and adjacent to plate 44. Likewise, each of unit cells 4650 of layer 4653-2 are complete and adjacent to plate 46. With respect to the recitation that unit cells are adjacent or directly adjacent to plate 44 or plate 46 means that the unit cells either directly contact and abut such plates 44, 46 or that the unit cells are directly opposite to plates 44, 46 and would otherwise abut plates 44, 46 but for a thin layer of adhesive that may be provided between the unit cells and plates 44, 46 for bonding to plates 44, 46 to the unit cells.

In other implementations, each of unit cells 4650 may alternatively comprise a continuous elongate tube having other cross-sectional shapes or base geometries, other polygon shapes, oval cross-sectional shapes are circular cross-sectional shapes. In other implementations, regardless of their particular cross-sectional shape, each of unit cells 4650 in layer 4653-1 and/or layer 4653-2 may be partial in nature, cut such that the hollow interior of the unit cell extends along the adjacent plate 44 or 46.

In other implementations, inner layer 4642 may be formed from differently configured stacks of layers of unit cells. For example, instead of being formed by a stack of three layers of unit cells 4650, inner layer 4642 may be formed from a single layer of unit cells 4650, a pair of layers of unit cells 4650 or more than three layers of unit cells 4650. As will be described hereafter, in other implementations, additional layers of material may be disposed between the outermost layers 4653-1 and the adjacent plate 44 and/or between the outermost layer 4653-2 in the adjacent plate 46. Likewise, in other implementations, additional layers may be disposed between the layers of unit cells 4650.

In other implementations, the cross-sectional areas of each unit cell 4650 may be larger or smaller than what is shown. Although unit cells 4650 are illustrated as having the same or uniform cross-sectional shapes and cross-sectional areas/sizes, in other implementations, the unit cells 4650 forming one of multiple layers forming inner layer 4642 may have a different cross-sectional shape and/or different cross-sectional area/size then those unit cells 4650 forming another layer of the multiple layers forming inner layer 4642. For example, the unit cells forming layer 4653-3 may have a larger cross-sectional area as compared to those unit cells that are adjacent to plates 44, 46 (those unit cells forming layers 4653-1 and 4653-2 in the example).

In the illustrated example where the unit cells have polygon cross-sectional shapes, the points of such polygons are bonded, welded, fused or otherwise secured to plates 44 and 46. In other implementations where the polygon cross-sectional shapes, the orientation of the individual unit cells 4650 may be rotated about the centerline 4651 from what is shown. For example, the sides, rather than the points, such polygons may be bonded, fused or otherwise secured to plates 44 and 46.

In some implementations, the multiple layers 4653 are integrally formed as a unit, as part of a single unitary body, being extruded. As noted above, the cross-sectional shape and areas of the individual unit cells 4650 in such layers 4653 may have other shapes than that shown and may be different from layer to layer. In some implementations, layers 4653 may be individually extruded and then bonded or joined to one another in a stack to form inner layer 4642. In some implementations, one or both of plates 44, 46 may be integrally formed as part of a single unitary body with inner layer 4642 or a particular layer 4653 of inner layer 4642. For example, in some implementations, a layer and adjacent plate 44 (and additional layers 4653 in some implementations) may be coextruded. In some implementations, one or more of layers 4653 and plates 44, 46 may be integrally formed as part of a single unitary body by being 3D printed.

As should be appreciated, those examples illustrating a layer sublayer having a uniform density of cells may alternatively have a nonuniform density of cells, wherein the nonuniformity extends parallel to and/or perpendicular to the plane of the faceplates. In each of the examples, the continuous or discrete layers or combination of multiple sublayers may be adhesively bonded to one another, fused or welded to one another, interlocked with one another or integrally formed as a single unitary body using a micro layer by micro layer additive manufacturing process such as a powder bed an inkjet or dropped on powder printing additive manufacturing process, a stereolithography process, fused deposition modeling process, a selective laser sintering process, an additive manufacturing process polymerizing via ultraviolet radiation or a laminated object manufacturing process.

In one implementation, inner layer 4642 and its unit cells 4650 may be formed from a polymer such as rigid polyurethane. In other implementations, inner layer 4642 may be formed from other materials such as thermoplastic polyurethane, polypropylene, Nomex® polycarbonamide material, ethylene vinyl acetate (EVA), polyethylene, polyvinyl chloride, a polyethylene vinyl acetate, polyamide, acrylonitrile butadiene styrene (ABS), poly ether (ether) ketone, polylactic acid, acrylate-based polymeric system mimicking one of the aforementioned polymers, other polymeric materials, other lightweight elastomeric, thermoplastic or thermoset materials, and combinations thereof. In still other implementations, inner layer 4642 may be formed from other non-polymer materials, such as ceramics, cellulose-based materials and metals.

Handle 4630 is a longitudinal tubular structure having a distal end and proximal end. The distal end of the handle 4630 is coupled to the head 4640. The handle 4630 can include a grip to enhance the ability of a player to grasp, hold and manipulate the paddle 20. The handle 4630 can further include a butt cap coupled to the proximal end of the handle 30. In one implementation, the butt cap 4636 can be directly adhesively bonded to the proximal end. In an alternative implementation, the butt cap can be thermally bonded, mechanically fastened, or otherwise directly attached to the proximal end.

In one implementation, the handle 4630 can be integrally formed with and connected to the head 4640 to form a one-piece frame. In one implementation, a perimeter of the head 4640 can the handle 4630 can be formed through bladder molding from a fiber composite material. The fiber composite material is molded to form the rim or perimeter of head 4640 and a hair pin or pallet of the handle 4630. In one implementation, a polyurethane foam, or other foam, can be applied to the hair pin to form a foamed pallet for receiving the grip. In another implementation, the fiber composite material can be molded to form the pallet that receives the grip. In another implementation, the handle 4630 can be formed separate from and coupled to the head 4640. The handle 4630 is configured for grasping by one or more hands of a user during play. The handle 4630 can be formed of one or more materials such as a carbon-fiber composite material. Alternatively, the handle 4630 can be formed of other materials such as other composite materials, aluminum, other metallic alloys, wood, a polyurethane foam, a thermoplastic material, a thermoset material, and combinations thereof.

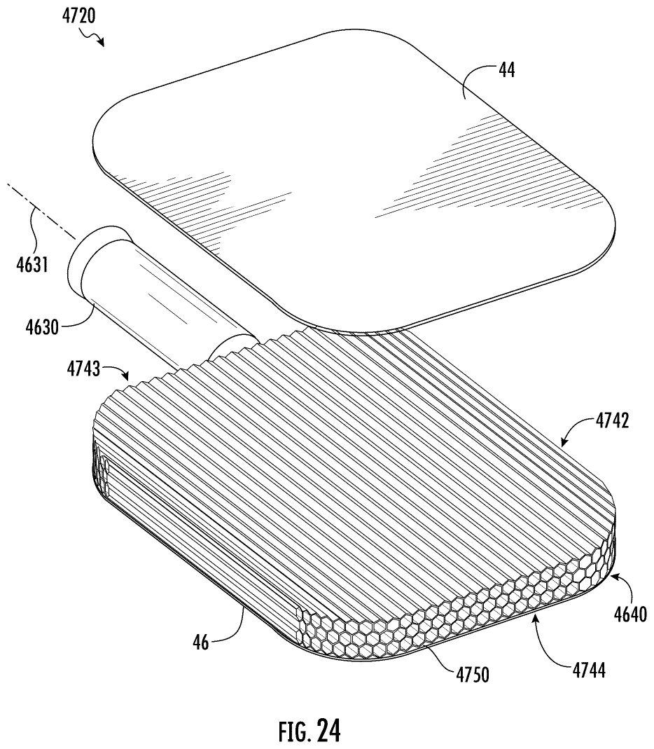

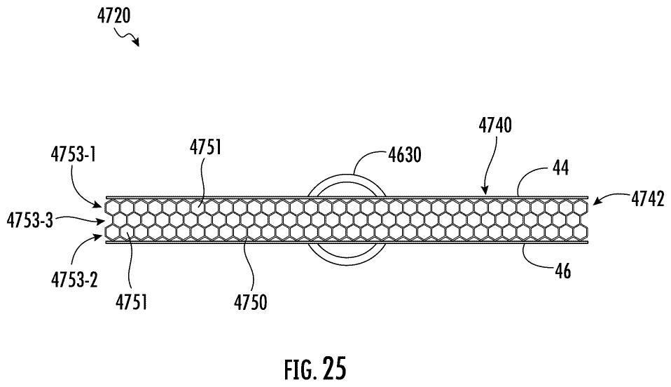

FIGS. 24 and 25 illustrate portions of an example pickleball paddle 4720. FIG. 24 is a partially exploded perspective view illustrating portions of an example pickleball paddle 4720. FIG. 25 is an end view of the portions of the paddle 4720 shown in FIG. 24.

Pickleball paddle 4720 is an example of one of the pickleball paddles described with respect to FIG. 5 above. Pickleball paddle 4620 comprises handle 4630 (above) and head 4740. Like paddle 4620, paddle 4720 has an inner layer 4742 formed by a honeycomb arrangement of unit cells that are non-perpendicular to faceplates 44, 46. In contrast to inner layer 4642 of paddle 4620, inner layer 4742 is formed from a honeycomb arrangement of unit cells 4750 that have centerlines 4751 that are parallel to (not perpendicular to) the longitudinal axis 4631 of handle 4630. As with paddle, paddle 4720 may or may not additionally include other components, such as the above-described bumper 48. Because the cells 4750 and their centerlines 4751 extend in directions non perpendicular to the faceplates 44 and 46, paddle 4720 may result in a lower volume of sound being produced when striking a pickleball.

In the example illustrated, the inner layer 4742 comprises a stack of multiple layers of unit cells 4750, each layer comprising multiple end-to-end unit cells (in a row as seen in FIG. 25). In the illustrated example, inner layer 4742 comprises three stacks of layers, layer 4753-1, 4753-2, and 4753-3 (collectively referred to as layers 4753). Layer 4753-1 extends directly adjacent to plates 44. Layer 4753-2 extends directly adjacent to plates 46. Layer 4753-3 is sandwiched between and in contact with each of layers 4753-1 and 4753-2. In the example illustrated, layers 4753 of unit cells 4750 continue beyond head 4740 and form an interior core portion of handle 4630. In other implementations, layers 4753 of unit cells 4750 terminate prior to handle 4630, forming just interior portions of head 4740.

As shown by FIG. 24, in the example illustrated, each of unit cells 4750 comprise a continuous elongate tube extending from a first proximal edge or end 4743 of head 4740 (excluding any outer bumper) to a second opposite distal edge or end 4744 of head 4740. In other implementations, one or more of the layers 4753 of inner layer 4742 may be formed from multiple individual tubes aligned end-to-end space from one another but aligned along a common axis) so as to collectively extend between ends 4743 and 4744. In the example illustrated, each continuous elongate tube forming a unit cell 4750 has a hexagonal cross-section. In the example illustrated, each continuous elongate tube forming unit cell 4750 is complete or whole in that none of the unit cells 4750 are cut (each of the unit cells 4750 has all of its six walls). For example, each of the unit cells 4750 in layer 4753-1 are complete and adjacent to plate 44. Likewise, each of unit cells 4750 of layer 4753-2 are complete and adjacent to plate 46. With respect to the recitation that unit cells are adjacent or directly adjacent to plate 44 or plate 46 means that the unit cells either directly contact and abut such plates 44, 46 or that the unit cells are directly opposite to plates 44, 46 and would otherwise abut plates 44, 46 but for a thin layer of adhesive that may be provided between the unit cells and plates 44, 46 for bonding to plates 44, 46 to the unit cells.

In other implementations, each of unit cells 4750 may alternatively comprise a continuous elongate tube having other cross-sectional shapes, other polygon shapes, oval cross-sectional shapes or circular cross-sectional shapes. In other implementations, regardless of their particular cross-sectional shape, each of unit cells 4750 in layer 4753-1 and/or layer 4753-2 may be partial in nature, cut such that the hollow interior of the unit cell extends along the adjacent plate 44 or 46.

In other implementations, inner layer 4742 may be formed from differently configured stacks of layers of unit cells. For example, instead of being formed by a stack of three layers of unit cells 4750, inner layer 4742 may be formed from a single layer of unit cells 4750, a pair of layers of unit cells 4750 or more than three layers of unit cells 4750. As will be described hereafter, in other implementations, additional layers of material may be disposed between the outermost layers 4753-1 and the adjacent plate 44 and/or between the outermost layer 4753-2 in the adjacent plate 46. Likewise, in other implementations, additional layers may be disposed between the layers of unit cells 4750.

In other implementations, the cross-sectional areas of each unit cell 4750 may be larger or smaller than what is shown. Although unit cells 4750 are illustrated as having the same or uniform cross-sectional shapes and cross-sectional areas/sizes, in other implementations, the unit cells 4750 forming one of multiple layers forming inner layer 4742 may have a different cross-sectional shapes and/or different cross-sectional areas/sizes than those unit cells 4750 forming another layer of the multiple layers forming inner layer 4742. For example, the unit cells forming layer 4753-3 may have a larger cross-sectional area as compared to those unit cells that are adjacent to plates 44, 46 (those unit cells forming layers 4753-1 and 4753-2 in the example).

In other implementations, where the unit cells have polygon cross-sectional shapes, the points of such polygons are bonded, welded, fused or otherwise secured to plates 44 and 46. In other implementations where the unit cells have polygon cross-sectional shapes, the orientation of the individual unit cells 4750 may be rotated about the centerline 4751 from what is shown. For example, the sides, rather than the points, of such polygons may be bonded, fused or otherwise secured to plates 44 and 46.

In some implementations, the multiple layers 4753 are integrally formed as a unit, as part of a single unitary body, rather being extruded. As noted above, the cross-sectional shape and areas of the individual unit cells 4750 in such layers 4753 may have other shapes than that shown and may be different from layer to layer. In some implementations, layers 4753 may be individually extruded and then bonded or joined to one another in a stack to form inner layer 4742. In some implementations, one or both of plates 44, 46 may be integrally formed as part of a single unitary body with inner layer 4742 or a particular layer 4753 of inner layer 4742. For example, in some implementations, a layer and adjacent plate 44 (and additional layers 4753 in some implementations) may be coextruded. In some implementations, one or more of layers 4753 and plates 44, 46 may be integrally formed as part of a single unitary body by being 3D printed.

In some implementations, individual unit cells 4750 of a particular layer may not be secured to one another, permitting relative movement between consecutive and adjacent unit cells 4750 in a layer. In other implementations, the individual unit cells 4750 in a particular layer may be fused, bonded otherwise affixed to one another. In some implementations, the individual layers 4753 are bonded, fused or otherwise fixed to one another against relative movement. In some implementations, the individual layers 4753 may not be bonded fused or otherwise secured to one another. As result, relative movement of adjacent consecutive layers 4753 is facilitated. For example, a first layer of unit cells may have first surfaces that abut or contact second surfaces of a second adjacent layer. During impact with a pickle ball and the resulting deflection, the first surfaces may deform and undergo tension and may correspondingly deform the second surfaces, causing the second surfaces to undergo compression. As a result, such surfaces may move relative to one another during ball impact. Such relative movement may provide a more dynamic touch and response as compared to implementations where the layers are fixed to one another.

In one implementation, inner layer 4742 and its unit cells 4750 may be formed from a polymer such as rigid polyurethane. In other implementations, inner layer 4742 may be formed from other materials such as thermoplastic polyurethane, polypropylene, Nomex® polycarbonamide material, ethylene vinyl acetate (EVA), polyethylene, polyvinyl chloride, a polyethylene vinyl acetate, polyamide, acrylonitrile butadiene styrene (ABS), poly ether (ether) ketone, polylactic acid, acrylate-based polymeric system mimicking one of the aforementioned polymers, other polymeric materials, other lightweight elastomeric, thermoplastic or thermoset materials, and combinations thereof. In still other implementations, inner layer 4742 may be formed from other non-polymer materials, such as ceramics, cellulose-based materials and metals.

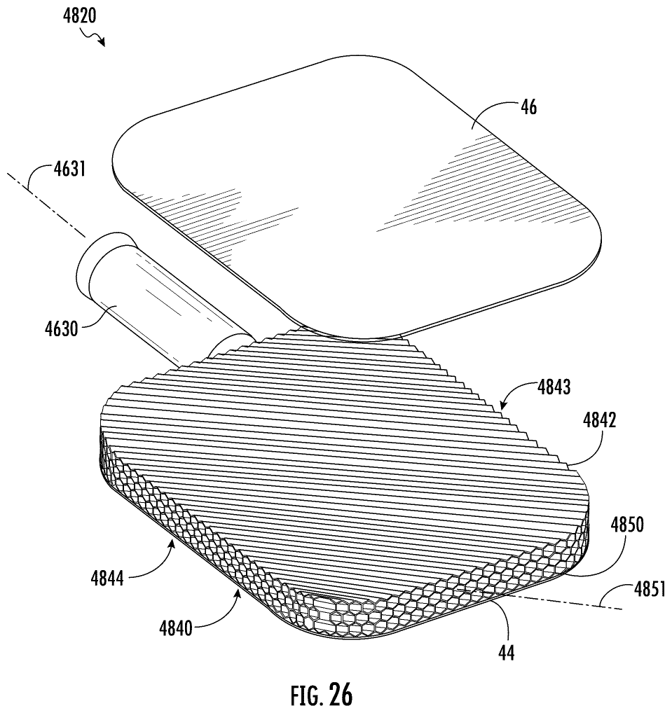

FIG. 26 illustrates portions of an example pickleball paddle 4820. FIG. 26 is a partially exploded perspective view illustrating portions of an example pickleball paddle 4820. Pickleball paddle 4820 is an example of one of the pickleball paddles described with respect to FIG. 5 above. Pickleball paddle 4820 comprises handle 4830 (described above) and head 4840. Like paddle 4620, paddle 4820 has an inner layer 4742 formed by a honeycomb arrangement of unit cells that are non-perpendicular to faceplates 44, 46. In contrast to inner layer 4642 of paddle 4620, inner layer 4842 is formed from a honeycomb arrangement of unit cells 4750 that have centerlines 4751 that are oblique to (not parallel or perpendicular to) the longitudinal axis 4631 of handle 4630. As with paddles 4620 and 4820, paddle 4820 may or may not additionally include other components, such as the above-described bumper 48. Because the cells 4850 and their centerlines 4851 face in directions non perpendicular to the faceplates 44 and 46, paddle 4820 may produce or generate a lower volume of sound when striking either the faceplates 44, 46 of the pickleball paddle.

In the example illustrated, the inner layer 4842 comprises a stack of multiple layers of unit cells 4850, each layer comprising multiple end-to-end unit cells. In the illustrated example, inner layer 4842 comprises three stacks of layers, layer 4853-1, 4853-2, and 4853-3 (collectively referred to as layers 4853). Layer 4853-1 extends directly adjacent to plates 44. Layer 4853-2 extends directly adjacent to plates 46. Layer 4853-3 is sandwiched between and in contact with each of layers 4853-1 and 4853-2. In the example illustrated, layers 4853 of unit cells 4850 continue beyond head 4840 and form an interior core portion of handle 4630. In other implementations, layers 4853 of unit cells 4850 terminate prior to handle 4630, forming just interior portions of head 4840.

In the example illustrated, each of unit cells 4850 comprises a continuous elongate tube extending diagonally from a first proximal edge or end 4843 of head 4840 (excluding any outer bumper) to a second opposite distal edge or end 4844 of head 4840. In other implementations, one or more of the layers 4853 of inner layer 4842 may be formed from multiple individual tubes aligned end-to-end space from one another but aligned along a common axis) so as to collectively extend between ends 4843 and 4844. In the example illustrated, each continuous elongate tube forming a unit cell 4850 has a hexagonal cross-section. In the example illustrated, each continuous elongate tube forming unit cell 4850 is complete or whole in that none of the unit cells 4850 are cut (each of the unit cells 4850 has all of its six walls). For example, each of the unit cells 4850 in layer 4853-1 are complete and adjacent to plate 44. Likewise, each of unit cells 4850 of layer 4853-2 are complete and adjacent to plate 46. With respect to the recitation that unit cells are adjacent or directly adjacent to plate 44 or plate 46 means that the unit cells either directly contact and abut such plates 44, 46 or that the unit cells are directly opposite to plates 44, 46 and would otherwise abut plates 44, 46 but for a thin layer of adhesive that may be provided between the unit cells and plates 44, 46 for bonding to plates 44, 46 to the unit cells.

In other implementations, each of unit cells 4850 may alternatively comprise a continuous elongate tube having other cross-sectional shapes, other polygon shapes, oval cross-sectional shapes are circular cross-sectional shapes. In other implementations, regardless of their particular cross-sectional shape, each of unit cells 4850 in layer 4853-1 and/or layer 4853-2 may be partial in nature, cut such that the hollow interior of the unit cell extends along the adjacent plate 44 or 46.

In other implementations, inner layer 4842 may be formed from differently configured stacks of layers of unit cells. For example, instead of being formed by a stack of three layers of unit cells 4850, inner layer 4842 may be formed from a single layer of unit cells 4850, a pair of layers of unit cells 4850 or more than three layers of unit cells 4850. As will be described hereafter, in other implementations, additional layers of material may be disposed between the outermost layers 4853-1 and the adjacent plate 44 and/or between the outermost layer 4853-2 in the adjacent plate 46. Likewise, in other implementations, additional layers may be disposed between the layers of unit cells 4850.

In other implementations, the cross-sectional areas of each unit cell 4850 may be larger or smaller than what is shown. Although unit cells 4850 are illustrated as having the same or uniform cross-sectional shapes and cross-sectional areas/sizes, in other implementations, the unit cells 4850 forming one of multiple layers forming inner layer 4842 may have a different cross-sectional shape and/or different cross-sectional area/size then those unit cells 4850 forming another layer of the multiple layers forming inner layer 4842. For example, the unit cells forming layer 4853-3 may have a larger cross-sectional area as compared to those unit cells that are adjacent to plates 44, 46 (those unit cells forming layers 4853-1 and 4853-2 in the example).

In other implementations, In the illustrated example where the unit cells have polygon cross-sectional shapes, the points of such polygons are bonded, welded, fused or otherwise secured to plates 44 and 46. In other implementations where the polygon cross-sectional shapes, the orientation of the individual unit cells 4850 may be rotated about the centerline 4851 from what is shown. For example, the sides, rather than the points, such polygons may be bonded, fused or otherwise secured to plates 44 and 46.

In some implementations, the multiple layers 4853 are integrally formed as a unit, as part of a single unitary body, being extruded. As noted above, the cross-sectional shape and areas of the individual unit cells 4850 in such layers 4853 may have other shapes than that shown and may be different from layer to layer. In some implementations, layers 4853 may be individually extruded and then bonded or joined to one another in a stack to form inner layer 4842. In some implementations, one or both of plates 44, 46 may be integrally formed as part of a single unitary body with inner layer 4842 or a particular layer 4853 of inner layer 4842. For example, in some implementations, a layer and adjacent plate 44 (and additional layers 4853 in some implementations) may be coextruded. In some implementations, one or more of layers 4853 and plates 44, 46 may be integrally formed as part of a single unitary body by being 3D printed.

In one implementation, inner layer 4842 and its unit cells 4850 may be formed from a polymer such as rigid polyurethane. In other implementations, inner layer 4842 may be formed from other materials such as thermoplastic polyurethane, polypropylene, Nomex® polycarbonamide material, ethylene vinyl acetate (EVA), polyethylene, polyvinyl chloride, a polyethylene vinyl acetate, polyamide, acrylonitrile butadiene styrene (ABS), poly ether (ether) ketone, polylactic acid, acrylate-based polymeric system mimicking one of the aforementioned polymers, other polymeric materials, other lightweight elastomeric, thermoplastic or thermoset materials, and combinations thereof. In still other implementations, inner layer 4842 may be formed from other non-polymer materials, such as ceramics, cellulose-based materials and metals.

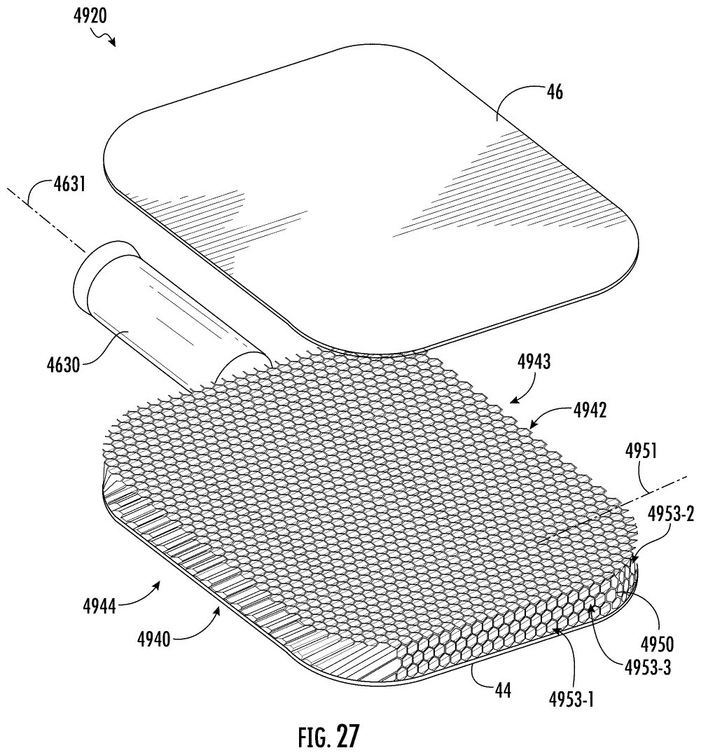

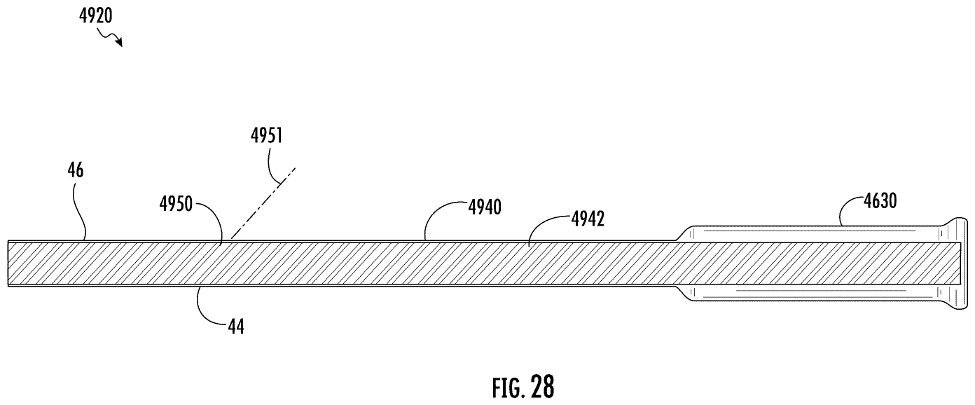

FIGS. 27 and 28 illustrate portions of an example pickleball paddle 4920. FIG. 27 is a partially exploded perspective view illustrating portions of an example pickleball paddle 4720. FIG. 25 is a sectional view of the portions of the paddle 4720 shown in FIG. 24 and taken along the longitudinal axis 4631 of handle 4630 in a plane perpendicular to faceplates 44, 46.

Pickleball paddle 4920 comprises handle 4630 (above) and head 4940. Like paddle 4620, paddle 4920 has an inner layer 4942 formed by a honeycomb arrangement of unit cells that are non-perpendicular to faceplates 44, 46. In contrast to inner layer 4642 of paddle 4620, inner layer 4942 is formed from a honeycomb arrangement of unit cells 4950 that have centerlines 4951 that are oblique to the planes of plates 44 and 46. As with paddles 4620, 4720 and 4820, paddle 4920 may or may not additionally include other components, such as the above-described bumper 48. Because the cells 4950 and their centerlines 4951 face in directions non perpendicular to the faceplates 44 and 46, paddle 4920 may produce generate a lower volume of sound when striking a pickleball ball.

As shown by FIG. 27, the inner layer 4942 comprises a stack of multiple layers of unit cells 4950, each layer comprising multiple side-by-side unit cells (in a row as seen in FIG. 27). In the illustrated example, inner layer 4942 comprises three stacks of layers, layer 4953-1, 4953-2, and 4953-3 (collectively referred to as layers 4953). Layer 4953-3 is sandwiched between and in contact with each of layers 4953-1 and 4953-2. In the example illustrated, layers 4953 of unit cells 4950 continue beyond head 4940 and form an interior core portion of handle 4630. In other implementations, layers 4953 of unit cells 4950 terminate prior to handle 4630, forming just interior portions of head 4940. Although each of unit cells 4950 is illustrated as diagonally extending in a proximal to distal direction (from closest to the handle 4630 away from handle 4630), in other implementations, each of unit cells 4950 may alternatively diagonally extend in a lateral direction, from a start point closer to the first side 4943 to an endpoint more closer to the second side 4944.

Although illustrated as having a hexagonal cross-sectional shape, in other implementations, each of unit cells 4950 may alternatively comprise a continuous elongate tube having other cross-sectional shapes, other polygon shapes, oval cross-sectional shapes or circular cross-sectional shapes

In other implementations, inner layer 4942 may be formed from differently configured stacks of layers of unit cells. For example, instead of being formed by a stack of three layers of unit cells 4950, inner layer 4942 may be formed from a single layer of unit cells 4950, a pair of layers of unit cells 4950 or more than three layers of unit cells 4950. As will be described hereafter, in other implementations, additional layers of material may be disposed between the outermost layers 4953-1 and the adjacent plate 44 and/or between the outermost layer 4953-2 in the adjacent plate 46. Likewise, in other implementations, additional layers may be disposed between the layers of unit cells 4950.

In other implementations, the cross-sectional areas of each unit cell 4950 may be larger or smaller than what is shown. Although unit cells 4950 are illustrated as having the same or uniform cross-sectional shapes and cross-sectional areas/sizes, in other implementations, the unit cells 4950 forming one of multiple layers forming inner layer 4942 may have a different cross-sectional shape and/or different cross-sectional area/size than those unit cells 4950 forming another layer of the multiple layers forming inner layer 4942. For example, the unit cells forming layer 4953-3 may have a larger cross-sectional area as compared to those unit cells that are adjacent to plates 44, 46 (those unit cells forming layers 4953-1 and 4953-2 in the example).

In some implementations, the multiple layers 4953 are integrally formed as a unit, as part of a single unitary body, being extruded. As noted above, the cross-sectional shape and areas of the individual unit cells 4950 in such layers 4953 may have other shapes than that shown and may be different from layer to layer. In some implementations, layers 4953 may be individually extruded and then bonded or joined to one another in a stack to form inner layer 4942. In some implementations, one or both of plates 44, 46 may be integrally formed as part of a single unitary body with inner layer 4942 or a particular layer 4953 of inner layer 4942. For example, in some implementations, a layer and adjacent plate 44 (and additional layers 4953 in some implementations) may be coextruded. In some implementations, one or more of layers 4953 and plates 44, 46 may be integrally formed as part of a single unitary body by being 3D printed.

In one implementation, inner layer 4942 and its unit cells 4950 may be formed from a polymer such as rigid polyurethane. In other implementations, inner layer 4942 may be formed from other materials such as thermoplastic polyurethane, polypropylene, Nomex® polycarbonamide material, ethylene vinyl acetate (EVA), polyethylene, polyvinyl chloride, a polyethylene vinyl acetate, polyamide, acrylonitrile butadiene styrene (ABS), poly ether (ether) ketone, polylactic acid, acrylate-based polymeric system mimicking one of the aforementioned polymers, other polymeric materials, other lightweight elastomeric, thermoplastic or thermoset materials, and combinations thereof. In still other implementations, inner layer 4942 may be formed from other non-polymer materials, such as ceramics, cellulose-based materials and metals.

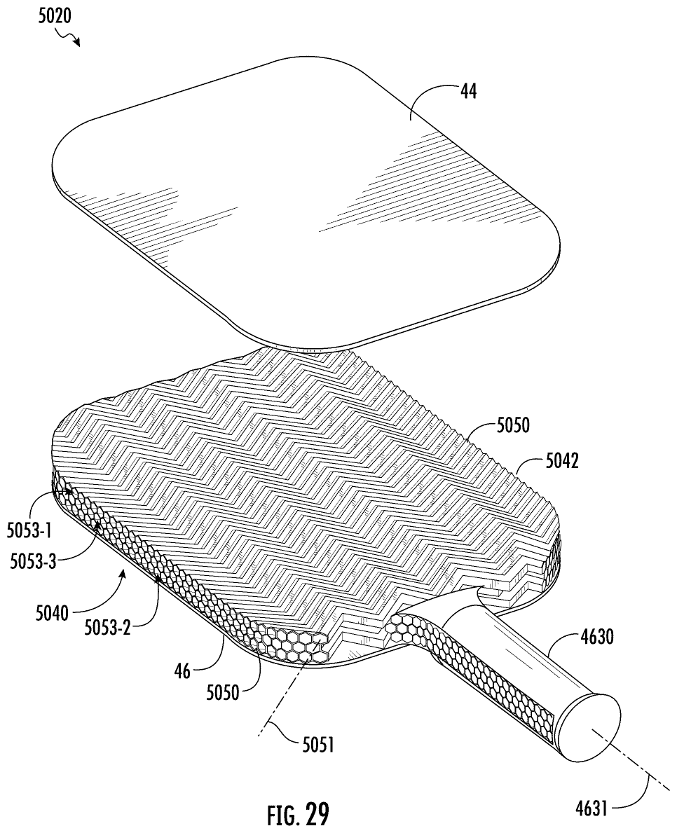

FIG. 29 illustrates portions of an example pickleball paddle 5020. Pickleball paddle 5020 is an example of one of the pickleball paddles described with respect to FIG. 5 above. Pickleball paddle 5020 comprises handle 4630 (described above) and head 5040. Like paddle 4620, paddle 5020 has an inner layer 5042 formed by a honeycomb arrangement of unit cells that are non-perpendicular to faceplates 44, 46. In contrast to inner layer 4642 of paddle 4620, inner layer 5042 is formed from a honeycomb arrangement of unit cells 5050 that have centerlines 5051 that nonlinearly extend along at least a portion of a length of the unit cell between lateral sides 5043 and 5044 of head 4940 while extending parallel to faceplates 44, 46. As with paddles 4620 and 5020, paddle 5020 may or may not additionally include other components, such as the above-described bumper 48. Because the cells 5050 and their centerlines 5051 face in directions non perpendicular to the faceplates 44 and 46, paddle 5020 may produce generate a lower volume of sound when striking a pickleball ball. Because each of the tubes serving as unit cells 5050 have non-linear centerlines (such as zigzag, wavy centerlines or serpentine), interference is enhanced which may result in even greater sound volume attenuation.

In the example illustrated, the inner layer 5042 comprises a stack of multiple layers of unit cells 5050, each layer comprising multiple side-by-side unit cells. In the illustrated example, inner layer 5042 comprises three stacks of layers, layer 5053-1, 5053-2, and 5053-3 (collectively referred to as layers 5053). Layer 5053-1 extends directly adjacent to plates 44. Layer 5053-2 extends directly adjacent to plates 46. Layer 5053-3 is sandwiched between and in contact with each of layers 5053-1 and 5053-2. In the example illustrated, layers 5053 of unit cells 5050 continue beyond head 5040 and form an interior core portion of handle 4630. In other implementations, layers 5053 of unit cells 5050 terminate prior to handle 4630, forming just interior portions of head 5040.

In the example illustrated, each of unit cells 5050 comprise a continuous elongate tube nonlinearly extending between side edges or sides 50-43 and 50-44 of head portion 5040. In other implementations comprising a continuous elongate tube nine and extending between a proximal edge of head portion 5040 (proximate to handle 4630) and a distal end of head 5040 (generally in a direction along the longitudinal axis 4631). Each continuous elongate tube has multiple end-to-end segments, wherein each segment has its own centerline that is oblique to adjacent segments on either end. In other implementations, one or more of the layers 5053 of inner layer 5042 may be formed from multiple individual tubes positioned end-to-end or spaced from one another so as to collectively extend between sides 5043 and 5044. In the example illustrated, each continuous elongate tube forming a unit cell 5050 has a hexagonal cross-section. In the example illustrated, each continuous elongate tube forming unit cell 5050 is complete or whole in that none of the unit cells 5050 are cut (each of the unit cells 5050 has all of its six walls). For example, each of the unit cells 5050 in layer 5053-1 are complete and adjacent to plate 44. Likewise, each of unit cells 5050 of layer 5053-2 are complete and adjacent to plate 46. With respect to the recitation that unit cells are adjacent or directly adjacent to plate 44 or plate 46 means that the unit cells either directly contact and abut such plates 44, 46 or that the unit cells are directly opposite to plates 44, 46 and would otherwise abut plates 44, 46 but for a thin layer of adhesive that may be provided between the unit cells and plates 44, 46 for bonding to plates 44, 46 to the unit cells.

In other implementations, each of unit cells 5050 may alternatively comprise a continuous elongate tube having other cross-sectional shapes, other polygon shapes, oval cross-sectional shapes are circular cross-sectional shapes. In other implementations, regardless of their particular cross-sectional shape, each of unit cells 5050 in layer 5053-1 and/or layer 5053-2 may be partial in nature, cut such that the hollow interior of the unit cell extends along the adjacent plate 44 or 46.

In other implementations, inner layer 5042 may be formed from differently configured stacks of layers of unit cells. For example, instead of being formed by a stack of three layers of unit cells 5050, inner layer 5042 may be formed from a single layer of unit cells 5050, a pair of layers of unit cells 5050 or more than three layers of unit cells 5050. As will be described hereafter, in other implementations, additional layers of material may be disposed between the outermost layers 5053-1 and the adjacent plate 44 and/or between the outermost layer 5053-2 in the adjacent plate 46. Likewise, in other implementations, additional layers may be disposed between the layers of unit cells 5050.

In other implementations, the cross-sectional areas of each unit cell 5050 may be larger or smaller than what is shown. Although unit cells 5050 are illustrated as having the same or uniform cross-sectional shapes and cross-sectional areas/sizes, in other implementations, the unit cells 5050 forming one of multiple layers forming inner layer 5042 may have a different cross-sectional shape and/or different cross-sectional area/size then those unit cells 5050 forming another layer of the multiple layers forming inner layer 5042. For example, the unit cells forming layer 5053-3 may have a larger cross-sectional area as compared to those unit cells that are adjacent to plates 44, 46 (those unit cells forming layers 5053-1 and 5053-2 in the example).

In other implementations, In the illustrated example where the unit cells have polygon cross-sectional shapes, the points of such polygons are bonded, welded, fused or otherwise secured to plates 44 and 46. In other implementations where the polygon cross-sectional shapes, the orientation of the individual unit cells 5050 may be rotated about the centerline 5051 from what is shown. For example, the sides, rather than the points, such polygons may be bonded, fused or otherwise secured to plates 44 and 46.

In some implementations, the multiple layers 5053 are integrally formed as a unit, as part of a single unitary body, being extruded. As noted above, the cross-sectional shape and areas of the individual unit cells 5050 in such layers 5053 may have other shapes than that shown and may be different from layer to layer. In some implementations, layers 5053 may be individually extruded and then bonded or joined to one another in a stack to form inner layer 5042. In some implementations, one or both of plates 44, 46 may be integrally formed as part of a single unitary body with inner layer 5042 or a particular layer 5053 of inner layer 5042. For example, in some implementations, a layer and adjacent plate 44 (and additional layers 5053 in some implementations) may be coextruded. In some implementations, one or more of layers 5053 and plates 44, 46 may be integrally formed as part of a single unitary body by being 3D printed.

In one implementation, inner layer 5042 and its unit cells 5050 may be formed from a polymer such as rigid polyurethane. In other implementations, inner layer 5042 may be formed from other materials such as thermoplastic polyurethane, polypropylene, Nomex® polycarbonamide material, ethylene vinyl acetate (EVA), polyethylene, polyvinyl chloride, a polyethylene vinyl acetate, polyamide, acrylonitrile butadiene styrene (ABS), poly ether (ether) ketone, polylactic acid, acrylate-based polymeric system mimicking one of the aforementioned polymers, other polymeric materials, other lightweight elastomeric, thermoplastic or thermoset materials, and combinations thereof. In still other implementations, inner layer 5042 may be formed from other non-polymer materials, such as ceramics, cellulose-based materials and metals.

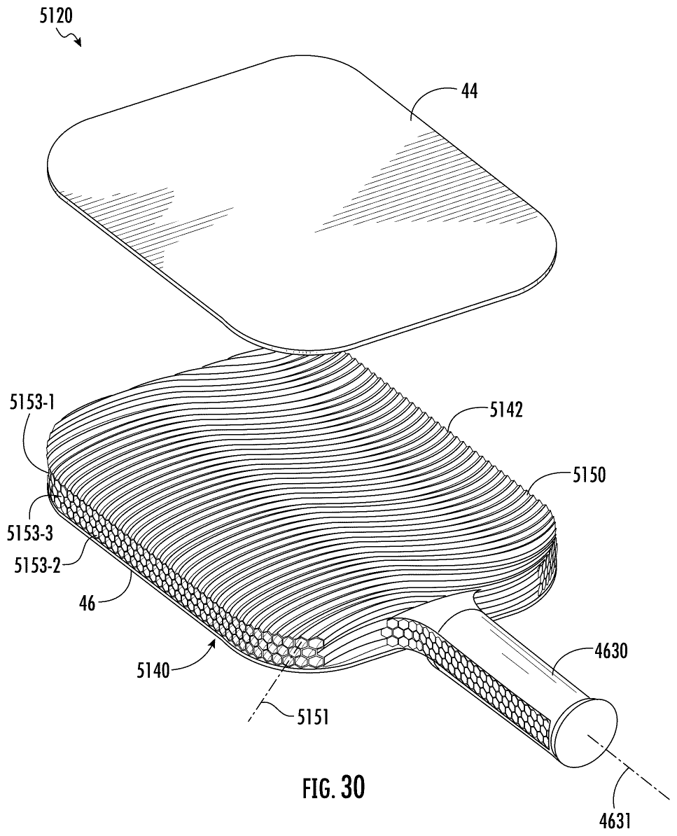

FIG. 30 illustrates portions of an example pickleball paddle 5120. Pickleball paddle 5120 is an example of one of the pickleball paddles described with respect to FIG. 5 above. Pickleball paddle 5120 is similar to pickleball paddle 5020 except that rather than zigzagging along its length, each of the elongate continuous tubes forming unit cells 5150 are wavy, sinusoidally extending along their respective lengths. In other implementations, the elongate continuous tubes forming unit cells 5150 may extend across or at least partially across the surface areas of plates 44, 46 in a serpentine fashion, winding back-and-forth in one or more planes parallel to that of plates 44, 46. In still other implementations, the inner layer of the paddle may be formed by one or more continuous elongate tube that have helical or spiral centerlines that extend parallel to the planes of plates 44, 46. Those remaining aspects of unit cells 5050 and the multitude of variations/modifications/alternatives of unit cells 5050 and inner layer 5042 described above are equally applicable to unit cells 5150 and inner layer 5142. As with unit cells 5050, because unit cells 5150 non-linearly extend along their lengths, sound attenuation may be even further enhanced

As further shown by FIG. 30, inner layer 5142 comprises a stack of three layers 5153-1, 5153-2 and 5153-3 (collectively referred to as layers 5153). Each of the three layers 5153 is longitudinally offset from any adjacent layer of cells 5150 such that the cells 5150 of a particular layer 5153 nest between consecutive adjacent cells 5150 of an underlying or overlying layer 5153. As with each of the inner layers disclosed in each of the implementations in FIGS. 24-29, the unit cells 5150 of adjacent layers 5153 may alternatively be directly stacked upon one another without nesting and without an offset (with the apexes or points of the unit cells 5150 of particular layer contacting the apexes or points of the unit cells 5150 of the layer above in the layer below the particular layer. Such a configuration creates additional larger elongate passages between the mutually contacting apexes or points tween the layers, wherein such additional passages may further diminish noise from a pickle ball impacting the face of the paddle.

As with each of the inner layers disclosed in each of the implementations in FIGS. 24-29, the inner layer 5142 of paddle may be composed of a greater or fewer number of such layers of unit cells 5150. For example, inner layer 5142 may be formed from a single layer of unit cells 5150 or two layers of unit cells 5150. In other implementations, inner layer 5142 may include greater than three layers of unit cells 5150. As with each of the inner layers disclosed in each of the implementations in FIGS. 24-29, adjacent layers of unit cells may be fixed to one another or may not be fixed one to one another such that the layers may shift or move relative to one another during impact with a pickle ball. Likewise, layers of unit cells adjacent to the faceplates 44, 46 may be fixed to the faceplates or may not be fixed to the faceplates such that a layer may move relative to the adjacent faceplate.

FIG. 31 is an end view illustrating portions of an example pickleball paddle 5220. Paddle 5220 is similar to paddle 4720 except that paddle 5220 is illustrated as comprising a larger number of layers of unit cells 4750 between panels forming face plates 44 and 46 (as schematically illustrated by the ellipses. In one implementation, paddle 5220 comprises an inner layer 5242 of at least four layers of unit cells 4750. In still other implementations, paddle 5220 may comprise at least five layers of unit cells 4750. In a similar fashion, the inner layers 4842, 4942, 5042 and 5142 of paddles 4820, 920, 5020 and 5120, respectively, may likewise include at least four layers of unit cells, and in some implementations, at least five layers of unit cells.

As described above with respect to FIG. 25 illustrating inner layer 4742 of paddle 4720, the rows or layers of unit cells 4750 are uncut or unsevered. Those unit cells in those rows or layers adjacent to face plates 44 and 46 are complete and similar in shape those unit cells of those rows or layers sandwiched between the rows or layers of unit cells 4750 that are adjacent to plates 44, 46. FIG. 32 is an end view illustrating pickleball paddle 5320. Pickleball paddle 5320 is similar to paddle 4720 except paddle 5320 comprises an inner layer 5342 formed by outermost layers 5353-1, 5353-2 and sandwiched layers 5353-3 and 5353-4. Layers 5353-3 and 5353-4 sandwiched between layers 5353-1 and 5353-2 and are whole or complete in shape. In contrast, the unit cells 4750 of layer 5353-1 and 5353-2 are partial or cut. In the example illustrated, each of the unit cells 4750 are cut to have a semi-hexagonal cross-sectional shape, wherein one of the sides along the cut is provided by face plates 44 or 46 or an additional layer. With such an implementation, the unit cells 4750 are more closely compacted or arranged along plates 44 and 46. Although the partial or cut layers 5353-1 and 5353-2 extending along plates 44 and 46 are illustrated as sandwiching two intermediate layers of unit cells 4750, in other implementations, layers 5353-1 and 5353-2 may alternatively sandwich zero additional layers, a single additional layer of unit cells 4750 are more than two layers of unit cells 4750 therebetween. Although the partial or cut layers 5353-1 and 5353-2 are illustrated as having unit cells 4750 that have centerline extending parallel to plates 44, 46 and parallel to the longitudinal axis of handle 4630, in other implementations, the unit cells 4750 of layers 5353-1 and 5353—may alternatively extend (1) perpendicular to the longitudinal axis of handle 4630 (similar to those unit cells of paddle 4620, (2) oblique to the longitudinal axis of handle 4630 (similar to those unit cells of paddle 4820), (3) oblique to plates 44, 46 (similar to those unit cells of paddle 4920), or (4) nonlinearly along their lengths (similar to those unit cells of paddles 5020 and 5120).

FIG. 33 is an end view illustrating portions of an example pickleball paddle 5420. Paddle 5420 is similar to paddle 4720 except that paddle 5420 comprises an inner layer 5442 that additionally comprises spacing layers 5461-1, 5461-2, 5461-3 and 5461-4 (collectively referred to as layers 5461). Layer 5461-1 comprises a layer of material sandwiched between layer 4753-1 and plate 44. In one implementation, layer 5461-1 has a thickness less than the maximum height or thickness of an individual unit cell 4750. In one implementation, layer 5461 comprises a foamed material, such as a foamed polymer. In some implementations, such layers may comprise a layer of adhesive or a hot melt polymer. Layer 5461-2 is similar to layer 5461-1 except that layer 5461-2 is sandwiched between layer 4753-1 and plate 46.

Layer 5461-3 comprises a layer sandwiched between layers 4753-1 and 4753-3. Likewise, layer 5461-4 comprises a layer sandwiched between layers 4753-2 and 4753-3. Layers 5461-3 and 5461-4 each have a thickness less than the maximum height or thickness of an individual unit cell 4750. In some implementations, each of such layers may comprise a foamed material. In some implementations, each of such layers may comprise an adhesive material or a layer of a hot melt material or polymer. In some implementations, layers 5461-3 and 5461-4 may have a material composition or a thickness different than that of layers 5461-1 and 5461-2. In some implementations, one or more of layers 5461 may be omitted. Although such layers 5461 are illustrated as being formed adjacent to the layers 4753 of inner layer 5442, such layers 5461 may likewise be applied or incorporated into the inner layers of any of the above describe pickleball paddles.

In each of the above-described paddles 4620, 4720, 4820, 4920, 5020, 5120, 5220, 5320, 5420, the inner layers are illustrated as being formed by of layers of unit cells which each comprise elongate, partial or complete, tubes. As described above, such tubes may be formed by manufacturing methods such as 3D printing or by extrusion. In some implementations, instead of the unit cells comprising elongate tubes, the unit cells may alternatively comprise continuous elongate passages or channels molded into a mass of material or formed by removing portions of a mass of material by a material removing technique such as laser cutting, mechanical cutting, chemical removal or the like.

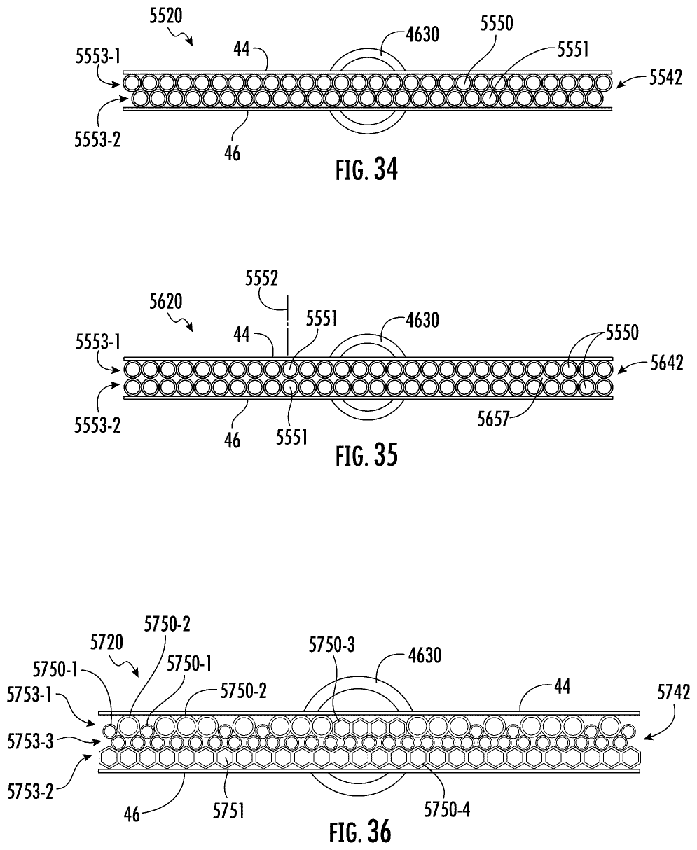

FIG. 34 is an end view illustrating pickleball paddle 5520. FIG. 34 illustrates an example of how an inner layer of the pickle ball paddle may be formed from two layers of tubes or unit cells having other cross-sectional shapes, such as circular or oval cross-sectional shapes. Pickleball paddle 5520 is similar to paddle 4720 except paddle 5520 comprises an inner layer 5542. Inner layer 5542 comprises unit cells 5550 having centerlines (axes extending along and through the middle of each of the tubes) that extend parallel to the planes of the faceplates 44 and 46 and parallel to the longitudinal axis 4631 of handle 4630. Unlike unit cells 4750, unit cells 5550 have non-polygon cross-sectional shapes. In the example illustrated, cells 5550 have circular cross-sectional shapes. In other implementations, unit cells 5550 may have oval cross-sectional shapes.

In the example illustrated, the unit cells 5550 of inner layer 5542 are arranged in two stacked and nested layers 5553-1 and 5553-2. The two layers have a combined thickness of at least 10 mm and up to 20 mm, and in one implementation, at least 13 mm and no greater than 16 mm. The two layers 5553 are transversely offset relative to one another such that the unit cells of layer 5553-1 nest within the gaps between consecutive and adjacent unit cells 5550 of layer 5553-2. Said another way, the centerlines 5551 of the unit cells 5550 of one layer are staggered relative to the centerlines 5551 of the unit cells 5550 of an adjacent layer. This arrangement provides for greater compactness and a larger number of tubes for structural strength and sound dissipation.

Each of the above-described pickle ball paddles 4620-5420 may alternatively have an inner layer formed from just two layers of unit cells and/or may have other cross-sectional shapes such as circular or oval cross-sectional shapes. The unit cells of the two layers may be complete along the respective faceplates 44, 46 or may be broken along the respective faceplates 44, 46 (as described above with respect to FIG. 32). In some implementations, additional layers may be provided between the two layers or between one or both the layers and their respective faceplates 44, 46 (as described above with respect to paddle 5420 in FIG. 33). As described above with respect to the other examples, in other implementations, the two layers of unit cells may alternatively extend at other non-perpendicular angles relative to the faceplate and/or relative to the longitudinal axis of the handle 4630.

FIG. 35 is an end view illustrating pickleball paddle 5620. FIG. 35 illustrates an example of how an inner layer of the pickle ball paddle may be formed from layers of unit cells that are directly stacked upon one another without being offset relative to one another and without being inter-nested. In other words, the centerlines of the unit cells of a first layer are directly aligned with the centerlines of the unit cells of a second adjacent layer, with an imaginary axis intersecting two centerlines of two unit cells of two layers, the imaginary axis extending perpendicular to the respective planes of faceplates 44 and 46. This nested stacking arrangement of unit cells layers may be provided with any of the above-described pickle ball paddles. Because adjacent cells of adjacent layers are not offset and not nested, elongate interlayer spaces, gaps or voids having larger cross-sectional areas are formed between the layers, wherein each of the voids may function similar to a tube, providing enhanced sound dissipation.

Pickle ball paddle 5620 is similar to pickle ball paddle 5520 except that paddle 5620 comprises inner layer 5642. Inner layer 5642 is similar to inner layer 5542 except that layer 5642 comprises layers 5653-1 and 5653-2 of unit cells 5550 directly stacked upon one another with each unit cell 5550 of layer 5653-1 being aligned with a corresponding unit cell 5550 of layer 5653-2 such that their centerlines 5551 are aligned along an axis 5552 that extends perpendicular to the planes of faceplates 44 and 46. Because adjacent cells 5550 of adjacent layers 5653-1 and 5653-2 are not offset and not nested, elongate interlayer spaces, gaps or voids 5657 having a larger cross-sectional areas are formed between the layers 5653-1 and 5653-2, wherein each void 5657 may function similar to a tube, providing enhanced sound dissipation. Although paddle 5620 is illustrated as having non-polygon cells 5550 (having circular or oval cross-sections), in other implementations, paddle 5020 may be formed by polygon cells similar to those described above with respect to other implementations, wherein the polygon unit cells of the different layers are directly stacked upon one another with their centerlines being aligned along respective axes perpendicular to the planes of faceplates 44, 46.

FIG. 36 is an end view illustrating pickleball paddle 5720. FIG. 36 illustrates an example of how an inner layer of the pickle ball paddle may be formed from a combination of different unit cells having different geometries and/or different sizes in a single layer and/or amongst different layers. Pickle ball paddle 5720 is similar to pickle ball paddle 4720. Each of the unit cells 5750 have centerlines 5751 that extend parallel to faceplates 44, 46 and parallel to the longitudinal axis of handle 4630. Paddle 5720 is different from paddle 4720 in that pickle ball paddle 5720 comprises an inner layer 5742 comprising layers 5753-1, 5753-2 and 5753-3. Layer 5753-1 comprises unit cells 5750-1, 5750-2 and 5750-3 arranged end to end proximate the faceplate 44 between faceplates 44 and 46. Unit cells 5750-1 are hollow tubes and have non-polygon cross-sectional geometries, circular in the illustrated example. Unit cells 5750-2 are hollow tubes and are similar to unit cells 5750-1 in that they also have non-polygon cross-sectional geometries (circular in the illustrated example), but are differently sized (have different cross-sectional areas). Unit cells 5750-3 are hollow tubes having polygon cross-sectional shapes (hexagonal in the illustrated example). In the example illustrated, the distribution and location of unit cells 5750 in layer 5753-1 is chosen to provide particular stiffness qualities and sound dissipation performance. In other implementations layer 5753-1 may have other combinations of cells/tubes with varying sizes and geometries as well as other patterns of differently sized and/or shaped unit cells.

Layer 5753-2 extends adjacent to faceplate 46 between faceplates 44 and 46. Layer 5753-2 is formed from a series or row of a single type of unit cell 5750-4 (each of the unit cells 5750-4 in layer 5753-2 having the same size and geometry). Layer 5753-3 is sandwiched between layers 5753-1 and 5753-2. Layer 5753-3 is formed from a series or roll of a single type of unit cell, 5750-2. In some implementations, layers 5753-2 and 5753-3 may alternatively have other types of unit cells with other geometries and/or cross-sectional areas. In some implementations, one or both of layers 5753-2 and/or 5753-3 may each be formed from a hybrid or mixture of different types of unit cells having different geometries and/or different sizes. Although inner layer 5742 is illustrated as being formed from three layers, in other implementations, inner layer 5742 may be formed from a single layer, two layers, or more than three layers as described above with respect to other implementations. In some implementations the layers may be fixed (such as by adhesive or fusing), to adjacent layers and/or to faceplates 44, 46. In some implementations, the layers may not be fixed to one another to permit relative movement of the layers during impact with a pickle ball. In some implementations, the individual cells of a layer are fixed to one another such as bio adhesives, fusing, or being integrally formed as a single unitary body (a single extruded layer). In yet other implementations, all or a portion of the individual cells of a layer may not be fixed to one another so as to be movable relative to one another.

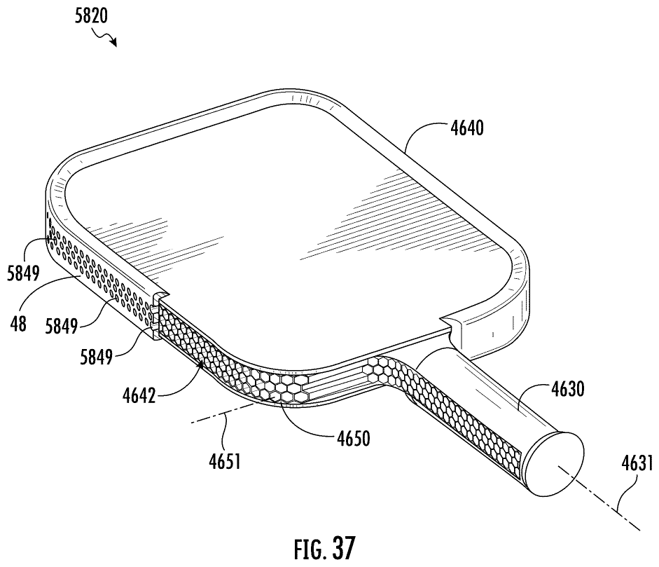

FIG. 37 is a perspective view of pickleball paddle 5820. Pickle ball paddle 5820 is similar to pickle ball paddle 4620 described above that paddle 5820 additionally comprises a bumper 48, wherein portions are shown broken away to illustrate the inner layer 4642 (described above). As shown by FIG. 37, bumper 48 wraps about the edges of inner layer 5042, along the perimeter of head 5040. Bumper 48 may be formed from a flexible or inflexible polymer or rubber-like material. Bumper 48 protects the edges of inner layer 5042. In some implementations, bumper 48 may be translucent or transparent.

As further shown by FIG. 37, the lateral sides of bumper 48 are perforate, including openings 5849 that extend completely through the walls of bumper 48 and which communicate with the interior of the laterally extending tubes of unit cells 4650. In the example illustrated, those portions of bumper 48 covering or extending opposite to and across the open ends of the tubes forming unit cells 4650 are perforate. In other implementations, an entirety of bumper 48 may be perforate. The provision of openings 5849 across from the open ends of the tubes forming unit cells 4650 may enhance noise dissipation.

In the example illustrated, openings 5849 have diameters or cross-sectional areas less than those of unit cells 4650. Openings 5849 facilitate airflow and may reduce the volume of sound produced by paddle 5820 when impacting a pickle ball. In some implementations, openings 5849 have a uniform distribution or density along the lateral sides of bumper 48. In other implementations, openings 5849 have a nonuniform distribution or density along the lateral sides of bumper 48 to accommodate different sound generating characteristics when a pickle ball paddle is directly different portions of the faceplate 44 or faceplate 46. In the example illustrated, the lateral sides of bumper 48 have a number of openings 5849 equal to or larger than the number of open ends of the tubes serving as unit cells 4650. In the example illustrated, each of the openings 5849 are aligned with a respective centerline of a unit cell for enhanced sound dissipation. In the example illustrated, each unit cell has a corresponding opening 5849 in bumper 48. In other implementations, openings 5849 may be at other locations, being offset with respect to the centerlines.

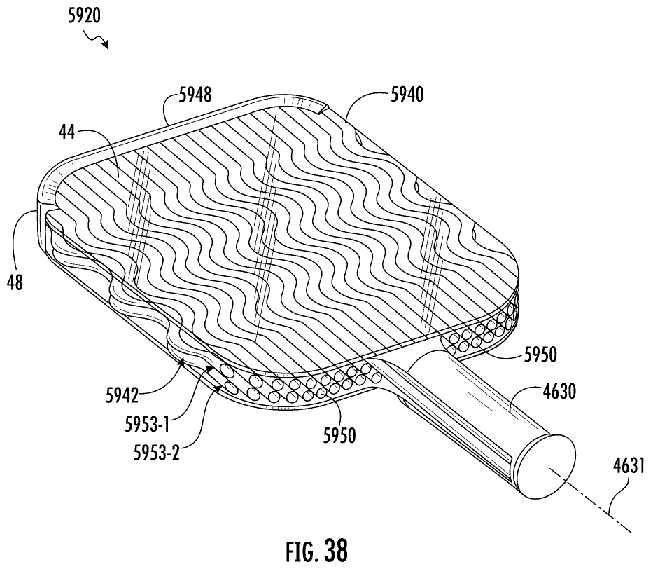

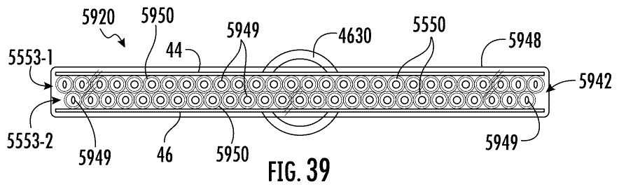

FIGS. 38 and 39 illustrate portions of an example pickle ball paddle 5920. FIG. 38 is a perspective view of pickleball paddle 5920 while FIG. 39 is an end view of paddle 5920. Pickle ball paddle 5920 comprises a handle 4630 (described above) and a head 5940. Head 5940 comprises an inner layer 5942 sandwiched between faceplates 44 and 46 (described above). Inner layer 5942 comprises layers 5953-1 and 5953-2 (collectively referred to as layers 5953) of unit cells 5950. In the example illustrated, the layers 5953 are transversely offset such that the unit cells 5950 of one layer nest between consecutive unit cells of an adjacent layer. In other implementations, layers 5953 may be directly aligned and stacked upon one another as described above with paddle 5620. Although inner layer 5942 is illustrated as having two layers, in other implementations, inner layer 5942 may have a single layer or more than two layers. In other implementations, layer 5942 may have additional layers between the layers of unit cells and/or between the layers of unit cells in the adjacent faceplates 44, 46 as described above with respect to paddle 5420 of FIG. 33.

As shown by FIG. 38, each of unit cells 5950 comprises an elongate hollow tube having a non-polygon geometry or cross sectional area/shape. Each unit cell 5950 has a linear portion 5960 and a nonlinear portion 5961. Linear portions 5960 extend from the opposite longitudinal ends of head 5940 on opposite ends of nonlinear portions 5961. The linear portions 5960 of each of unit cells 6050 have centerlines that extend parallel to the longitudinal axis 4631 of handle 4630.

The nonlinear portion 5961 of each of unit cells 5950 has a centerline that is not linear, but is sinusoidal or wavy. In other implementations, the nonlinear portion 5961 may have other nonlinear configurations from that shown. For example, the nonlinear portion 5961 may be sinusoidal but have a different amplitude, different frequency or different duty cycle from that shown. In some implementations, one or more of the amplitude, frequency or duty cycle of each unit cell may vary or change gradually or sharply as it extends across the opening 6039. Rather than having rounded amplitudes, the nonlinear portion 6061 of each unit cell 6050 may have a squared amplitudes (a square wave). In some implementations, the nonlinear portion 6061 may alternatively be zigzagged, similar to unit cells 5050 with respect to paddle 5020. In some implementations, the linear portions on one or both ends of portions 5961 may be omitted, where the wavy or zig zag nonlinear portion extends further towards the longitudinal edge of the head 5940. The non-linear path along which the tubes, forming unit cell 5950, extend may further enhance sound dissipation.

In the example illustrated, the nonlinear portion 5961 is generally situated so as to extend across a midpoint or central portion of head 5940, intersecting and extending from either side of the longitudinal midpoint of head 5940. In other implementations, the length of each of linear portion 5960 may be shortened or lengthened. In some implementations, the density of unit cells 5950 at different lateral points or locations across head 5940 may vary. In some implementations, the interior size or cross-sectional area of the unit cells 5950 may vary as each unit cell extends across head 5940.

In the example illustrated, paddle 5920 additionally comprises a guard, bumper or edge cover 5948. Edge cover 5948 extends across and covers the axial openings of the tubes forming unit cells 5950. In the example illustrated, edge cover 5948 extends across the longitudinal distal edge of head 5940, laterally to either side of longitudinal axis 4631 along the distal edge of head 5940. Edge cover 5948 covers each of the axial openings of unit cells 5950 along the entire longitudinal distal edge of head 5950. In the example illustrated, the longitudinal proximal edge of head 5940 is uncovered, wherein the axial openings of the tubes forming unit cell 5950 are open and exposed on either lateral side of handle 4630. In other implementations, bumper 5958 may also extend along the longitudinal proximal edge of head 5940, on both lateral sides of handle 4630. In such implementations, edge cover 5948 may comprise two separate portions, a first portion along the longitudinal distal edge of head 5940 and a second portion along the longitudinal proximal edge of head 5940. In yet other implementations, edge cover 5948 may continuously extend about the entirety of head 5940 or spaced locations along the edges of head 5940.

In some implementations, edge cover 5948 overlaps portions of both of faceplates 44, 46 while extending across the entire edge of at least portions of head 5940. In other implementations, edge cover 5948 terminate at faceplates 44 and 46. In some implementations, the edges of edge cover 5948 are substantially flush with the outermost faces of faceplates 44 and 46. In some implementations, edge cover 5948 is opaque. In yet other implementations, edge cover 5948 is translucent or transparent, permitting the axial openings of the tubes and/or the sides of the tubes forming unit cells 5950 to be seen.

In the example illustrated, edge cover 5948 is perforate, similar to bumper 48 shown in FIG. 37. Edge cover 5948 comprises openings 5949 that extend completely through the walls of edge cover 5948 and which communicate with the interior of the laterally extending tubes of unit cells 5950. In the example illustrated, those portions of edge cover 5948 covering or extending opposite to and across the open ends of the tubes forming unit cells 5950 are perforate. In other implementations, an entirety of edge cover 5948 may be perforate. The provision of openings 5949 across from the open ends of the tubes forming unit cells 5950 may enhance noise dissipation.

In the example illustrated, openings 5949 have diameters or cross-sectional areas less than those of unit cells 5950. In the illustrated example, those openings 5949 closer to the longitudinal axis of handle 4630 have a larger opening size as compared to those openings 5949 extending further away from the longitudinal axis 4631 of handle 4630. Openings 5949 facilitate airflow and may reduce the volume of sound produced by paddle 5920 when impacting a pickle ball. In some implementations, openings 5949 have a uniform distribution or density along the edge cover 5948. In other implementations, openings 5949 have a nonuniform distribution or density along edge cover 5948 to accommodate different sound generating characteristics when a pickle ball paddle is directly different portions of the faceplate 44 or faceplate 46. In the example illustrated, edge cover 5948 has a number of openings 5949 equal to or larger than the number of open ends of the tubes serving as unit cells 5950. In the example illustrated, each of the openings 5949 are aligned with a respective centerline of a unit cell for enhanced sound dissipation. In the example illustrated, each unit cell has a corresponding opening 5949. In other implementations, openings 5849 may be at other locations, being offset with respect to the centerlines.

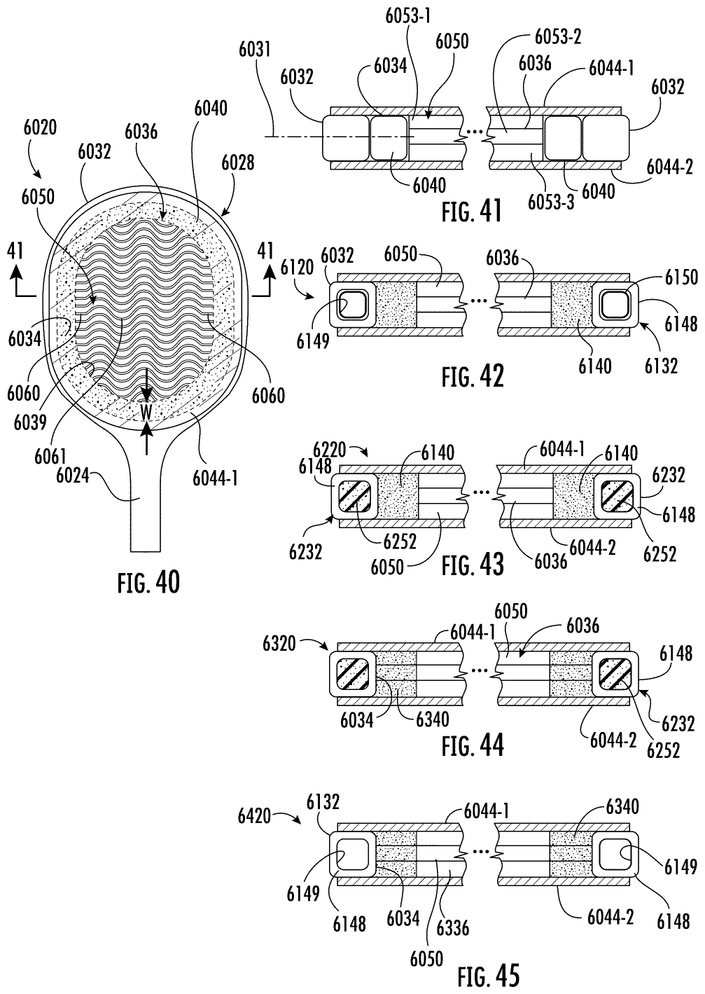

FIGS. 40 and 41 illustrate portions of an example pickleball paddle 6020. Pickleball paddle 6020 has a construction that may enhance a player's performance. FIG. 41 is a sectional view of paddle 6020 taken along line 30-30 of FIG. 41. Pickleball paddle 6020 has an internal construction that assists in isolating the primary sweet spot or central point and impact regions of the paddle from the handle portions of the paddle. The internal construction dampens vibration and other forces resulting from impact with the pickleball, inhibiting such forces from being transmitted to the handle portion of the pickleball paddle. The internal construction of pickleball paddle 6020 facilitates enhanced responsiveness of the impact portion of the pickleball by facilitating a degree of floating or movement of the impact region (sometimes referred to as the core) relative to the handle portion.

Pickleball paddle 6020 satisfies the requirements or standards for pickleball paddles used in officially sanctioned events or competitive play.

Pickleball paddle 6020 satisfies the requirements set forth in the November 2023 USA Pickleball Equipment Standards Manual. Pickleball paddle 5020 has a combined maximum length and maximum width less than or equal to 24 inches. Pickleball paddle 6020 has opposite pickleball impacting faces that have a maximum kinetic coefficient of friction less than or equal to 0.1875 when tested pursuant to protocol IAW ASTM D1894-14.

Pickleball paddle 6020 comprises a handle portion 6024 and a head portion 6028. The head portion 6028 is coupled to the handle portion 6024 and comprises an outer frame 6032 extending about an opening 6034, core 6036, core flexor 6040 and faceplates 6044-1 and 6044-2 (collectively referred to as faceplates 6044). Handle portion 6024 is dimensioned so as to be gripped by a player's hand. In some implementations, handle portion 6024 may have a round or oval cross-sections. In other implementations, handle portion 6024 may have a polygonal cross-section. Handle portion 6024 may include an outer wrap such as a polymer, rubber or leather material. In some implementations, handle portion 6024 has an internal core provided by an extending portion of outer frame 6032. In other implementations, handle portion 6024 may be joined or affixed to outer frame 6032.

Head portion 6028 provides the hitting surface for paddle 6020. Outer frame 6032 forms an outer rim extending about opening 6034 and forming a perimeter of head portion 5028. In some implementations, bumpers, cushions, weights or wraps of protective material may be provided on exterior portions of outer frame 6032. Outer frame 6032 and handle portion 6024 define the maximum width and together, define the maximum length of pickleball paddle 6020. Outer frame 6032 and handle portion 6024 satisfy the requirements set forth in the November 2023 USA Pickleball Equipment Standards Manual. The entire length of paddle 6020, extending from the butt of handle portion 6024 to the top of head portion 6028 form the maximum length of paddle 6020. The maximum width of head portion 6028 (measured perpendicular to the central axis of handle portion 6024) forms a maximum width of paddle 6020. The sum of the maximum length and the maximum width of paddle 6020 is less than or equal to 24 inches.

Outer frame 6032 may be a shaped band or tube of material that forms a loop defining the opening 6034. As indicated above, in some implementations, portions of the band or tube may further extend in a parallel fashion to form a core of handle portion 6024. In some implementations, the band or tube or tube forming outer frame 6032 may be solid, omitting any internal voids, lumens or internal cavities. Where the band or tube has an interior void, the void may be filled with another material, such as a foam. In some implementations, the band or tube forming outer frame 6032 may have a hollow interior, void of any solid material or filler. For example, the hollow band or tube may have an interior containing a gas, such as air.

Core 6036 (sometimes referred to as an inner layer) extends across and fills a majority of the area of the opening 6034 defined by outer frame 6032. In the example illustrated, core 6036 has a honeycomb configuration similar to inner layer 4642 of paddle 4620 and inner layer 5142 of pickle ball paddle 5120. In the illustrated example, core 6036 comprises a stack unit cells 6050 forming layers 6053-1, 6053-2 and 6053-3 (collectively referred to as layers 6053). As shown by FIG. 41, each of unit cells 6050 generally extends across the opening perpendicular to the longitudinal axis of handle 6024. In other implementations each unit cell 6050 may have a similar shape but being oriented 90° from what is shown, generally along or in a direction parallel to the longitudinal axis of handle 6024. Each of layers 6053 may have any of the above-described configurations. Although core 6036 is illustrated as having three layers 6053, in other implementations, core 6036 may have fewer than or more than three of such layers of unit cells 6050. As described above with respect to inner layer 4642, core 6036 comprises multiple layers 6053-1, 6053-2, 6053-3 of cells 6050 which have respective centerlines 6051 (one of which is labeled in FIG. 41).

As further shown by FIG. 41, each of unit cells 6050 comprises linear portion 6060 and a nonlinear portion 6061. Linear portions 6060 (which are similar to unit cells 4650) extend along the perimeter of opening 6039 on opposite ends of nonlinear portion 6061. The linear portion 6060 of unit cells 6050 have centerlines that extend perpendicular to the longitudinal axis of handle 6024. Nonlinear portion 6061 of each of unit cells 6050 is similar to unit cells 5150 described above. The nonlinear portion 6061 of each of unit cells 6050 has a centerline that is not linear, but is sinusoidal or wavy.

In other implementations, the nonlinear portion 6061 may have other nonlinear configurations from that shown. For example, the nonlinear portion 6061 may be sinusoidal but have a different amplitude, different frequency or different duty cycle from that shown. In some implementations, one or more of the amplitude, frequency or duty cycle of each unit cell may vary or change gradually or sharply as it extends across the opening 6039. Rather than having rounded amplitudes, the nonlinear portion 6061 of each unit cell 6050 may have a squared amplitudes. In some implementations, the nonlinear portion 6061 may alternatively be zigzagged, similar to unit cells 5050 with respect to paddle 5020.

In the example illustrated, the nonlinear portion 6061 is generally situated so as to extend across a midpoint or central portion of opening 6039, intersecting and extending from either side of the longitudinal axis of handle 6024 within opening 6039. In other implementations, the length of each of linear portion 6060 may be shortened or lengthened. In some implementations, the density of unit cells 6050 a different points or locations across opening 6039 may vary. In some implementations, the interior size or cross-sectional area of the unit cells may vary as each unit cell extends across opening 6039 or may vary with respect to where the unit cell 6050 is located relative to the base of handle 6024.

Each of the modifications and variations described above with respect to unit cells 4650 and inner layer 4642 of paddle 4620 may be equally applied to those corresponding components of core 6036. Although the core 6036 is illustrated as having unit cells 4650 that have centerline extending parallel to plates 6044 and parallel to the longitudinal axis of handle 6630, in other implementations, the unit cells 4650 of layers 4653-1, 4653-2 and 4650-3 (or a greater or fewer number of such layers, whether whole (a complete unit cell) or partial (a partial unit cell), and/or with or without layers, such as layers 5461, as described above with respect to FIGS. 31-33), may alternatively extend (1) perpendicular to the longitudinal axis of handle 6024 (similar to those unit cells of paddle 4620, (2) oblique to the longitudinal axis of handle 6024 (similar to those unit cells of paddle 4820), (3) oblique to plates 6044-1 and 6044-2 (similar to those unit cells of paddle 4920), or (4) nonlinearly along their lengths (similar to those unit cells of paddles 5020 and 5120).

Each of the unit cells 6050 comprises an elongate tubes. In some implementations, each of unit cells 6050 may have a polygon cross-sectional shape, such as a hexagonal shape. In some implementations, each of unit cells 6050 may have a non-polygon cross-sectional shape, such as an circular cross-sectional shapes or an oval cross-sectional shape. Although illustrated as having three layers 6053, in other implementations, core 6036 may have a single layer, to layers or more than three layers. In some implementations, the layers are longitudinally offset such that unit cells of one layer nest within gaps between adjacent unit cells of an adjacent layer (such as described above with respect to FIG. 34). In some implementations, layers are directly aligned on top of one another (such as described above with respect to FIG. 35. In some implementations, the unit cells of a particular layer are amongst different layers may have different geometries or sizes (such as described above with respect to FIG. 36). In some implementations, spacers layers may be provided between consecutive layers or between layers and faceplates 44, 46 (such as described above with respect to FIG. 33).

In some implementations, core 6036 can be formed of a polymeric material, such as polyethylene. In other implementations, the core 6036 can be formed of other materials, such as other polymers or plastics. In some implementations, the core 6036 has a compressive stiffness of at least 200 psi (pounds per square inch) and no greater than 300 psi (as measured pursuant to American Society for Testing Materials (ASTM) C365). In other implementations, the core 6036 can have other compressive stiffness values outside of 200 to 300 psi. In some implementations, core 6036 may be formed through an extrusion, wherein an extruded layer or sheet of side-by-side tubes having one or more of the layers of unit cells which is cut to a shape and a size to fill the opening 6039. In other implementations is formed through an additive process, such as 3D printing or is formed by molding a sheet to the size and shape of opening 6039 or as a sheet that is subsequently cut to the size and shape of opening 6039. In some implementations, core may be formed with a subtractive process or may be formed from multiple pieces or plates joined together to form the unit cells.

Core flexor 6040 (schematically illustrated in FIG. 41) comprises a structure extending between handle portion 6024 and core 6036, wherein the structure has a greater degree of compressibility and/or a lesser degree of stiffness or rigidity as compared to core 6036. In the example illustrated, the core flexor 6040 may completely wrap about or extend about a perimeter of the core 6036 without interruption, in a continuous manner. In the example illustrated, the core flexor 6040 has a width W of at least 5 mm in regions between the core 6036 and the handle portion 624. In some implementations, the core flexor 6040 has a width W within the range of 5 mm to 25 mm and, in some implementations a width W of at least 10 mm.

The core flexor 6040 has a stiffness or rigidity less than that of the core. The core flexor 6040 may have a greater degree of compressibility as compared to the compressibility of the core. In some implementations, the core flexor 640 comprises a foam material. In one example implementation, the core flexor 6040 an ethylene-vinyl acetate (EVA) foam having a density of 2 to 6 pounds. In some examples, the core flexor has a Shore 00 hardness of 40 to 60. In some implementations, the core flexor is formed from other polymeric foam materials such as urethane foams or polyurethan foams.

In other implementations, the core flexor 6040 may comprise a flexible compressible sleeve, tube or film having a hollow interior or an interior that is filled with a material having a degree of flexibility and/or compressibility that is greater than that of the material forming the core. In yet other implementations, core flexor 6040 may have other configurations or may be formed from other materials. In some implementations, the core flexor 6040 may be glued, welded, fastened or mechanically interlocked to one or both of outer frame 632 and core 6036.

In some implementations, the core 6036 is inset within the core flexor 6040 without being directly bonded or fixed to core flexor 6040. As result, the core 6036 may be compressed in a direction perpendicular to or normal to the face of the paddle (such as during impact with a pickleball), being compressed relative to core flexor 6040. In some implementations, the core 6036 is supported in a fashion similar to that of a trampoline by the flexor 6040 which serves as a support similar to the springs in a trampoline. In such implementations, the coefficient of restitution of core 6036 may be enhanced. In some implementations, core 6036, at least partially supported by core flexor 6040, is provided with a coefficient of restitution of at least 0.40, and in some implementations, at least 0.46. In such implementations, the opposite faces of the core 6036 and the core flexor 6040 may be directly bonded to the interior faces of faceplates 6044.

Core flexor 6040 assists in isolating the primary sweet spot or center point and impact regions of the paddle 6020 from the handle portions 6024 of the paddle 6020. Core flexor 6040 may dampen vibration and other forces resulting from impact with the pickleball, inhibiting such forces from being transmitted to the handle portion 6024 of the pickleball paddle 6020. Core flexor 6040 may enhance responsiveness of the impact portion of the pickleball by facilitating a degree of floating or movement of the impact region (sometimes referred to as the core) relative to the handle portion 6024. In some implementations, core flexor 6040 may reduce the noise produced during pickleball impact. The core flexor 6040 is positioned between the core 6036 and the handle portion 6024 such that the core 6036 does not directly contact the handle portion 6024. In some implementations, the core flexor 6040 can enable the core 6036 to move independently from the handle portion 6024 during impact with a pickleball.

Faceplates 6044 extend on opposite faces of head portion 6028 and provide the surfaces against which the pickleball impacts. Faceplates 6044 extend over, cover and span both core 6036 and core flexor 6040. In some implementations, faceplates 6044 completely cover front and rear faces of outer frame 6032. In other implementations, faceplates 6044 partially extend over and partially cover the front and rear faces of outer frame 6032. Faceplates 6044 are generally smooth and may be formed from a polymer, cellulose material or other materials or combinations of materials. In the example illustrated, faceplates 6044 satisfy the requirements set forth in the November 2023 USA Pickleball Equipment Standards Manual. Each of faceplates 6044 has a maximum kinetic coefficient of friction less than or equal to 0.1875 when tested pursuant to protocol in accordance with American Society for Testing and Materials (ASTM) D1894-14.

FIGS. 42-46 are sectional views of various particular examples of paddle 6020 taken along line 2-2 of FIG. 41. FIG. 42 illustrates pickleball paddle 6120. Pickleball paddle 6120 is similar to pickleball paddle 6020 described above except that paddle 6120 comprises outer frame 6132 and core flexor 6140, particular examples of outer frame 6032 and core flexor 6040 described above. Those remaining components of paddle 6120 which correspond to components of paddle 6020 are numbered similarly and/or are shown and described with respect to FIG. 41.

Outer frame 6132 comprises a tube 6148 shaped into the loop shown in FIG. 41. As noted above, in some implementations, tube 6148 may have end portions extending substantially parallel to one another to form an internal core portion of handle portion 24. The tube 6148 has a hollow interior 6149 which omits or is void of any solid material. In the example illustrated, tube 6148 has an internal bladder 6150 containing a gas, such as air. In some implementations, bladder 6150 is pressurized with air to maintain the shape of tube 6148 as it cures or takes on a permanent shape. In some implementations, tube 6148 may be formed from one or more plies of a fiber composite material, wherein bladder 6150 is formed from a flexible polymer, rubber or synthetic rubber material. In other implementations, bladder 6150 may be omitted, such as where tube 6148 is extruded and shaped into the loop shown in FIG. 35. After molding and curing of the tube 6148, the bladder 6150 can be removed from within the tube. In some implementations, the film or one or more layers are molded or wrapped about a sacrificial mandrel or core, wherein the mandrel or core is removed, leaving the hollow tube 6148. Although tube 6148 is illustrated as having a generally rectangular or square cross-section, in other implementations, tube 6148 may have external or internal grooves, an oval cross-section, a round cross-section or a polygon cross-section.

Core flexor 6140 comprises one or more layers of foam material sandwiched between plies 44-1 and 44-2 between core 6036 and handle portion 6024. In the example illustrated, core flexor 6140 comprise one or more layers of foam material that completely encircle core 6036 in a continuous uninterrupted manner. In other words, core flexor 6140 comprise a continuous unbroken ring about core 6036.

Core flexor 6140 has a width W (shown in FIG. 41) between handle portion 6024 and core 6036. In some implementations, the width W is at least 5 mm and no greater than 25 mm. In some implementations, the width W is uniform along the entire length of core flexor 6040 about core 6036. In other implementations, the width W may vary as it extends about core 6036. In some implementations, core flexor 6040 comprises a foam material. In one example implementation, the core flexor 6040 comprises an ethylene-vinyl acetate (EVA) foam having a density of 2 to 6 pounds. In some examples, the core flexor 6040 has a Shore 00 hardness of 40 to 60. In some implementations, the core flexor 6040 is formed from other polymeric foam materials such as urethane foams or polyurethan foams.

In some implementations, the material forming core flexor 6040 is preformed and cut or molded to the desired size and shape prior to being inserted into the opening 6034 formed by outer frame 6032. The preformed core flexor 6040 may be positioned within the opening 6034 prior to the insertion of core 6036 or after the insertion of core 6036 in opening 6034. In some implementations, no adhesives or other fasteners are used between the core flexor 6040 and the core 6036. In some implementations, the core flexor 6040 may be formed by depositing a fluid foam or foaming material into opening 6034 about core 6036 (or about a temporary removable piece in the shape of core 6036), between core 6036 and outer frame 6032. In some implementations, the fluid foam or foaming material may be injected into the space or volume defined on its sides by to 6148 and core 6036 and defined on its top and/or bottom by plate 6044-1 and/or plate 6044-2.

FIG. 43 illustrates pickleball paddle 6220. Pickleball paddle 6220 is similar to pickleball paddle 6120 described above except that paddle 6220 comprises outer frame 6232, a particular example of outer frame 6032 described above. Those remaining components of paddle 6220 which correspond to components of paddle 6020 and/or paddle 6120 are numbered similarly and/or are shown and described with respect to FIGS. 41 and 42.

Outer frame 6232 is similar to outer frame 6132 described above except that tube 6148 omits the internal bladder 6158 and that the to 6148 surrounds an internal solid frame core 6252. In some implementations, the frame core 6252 comprises a foam or foaming material. In some implementations, frame core 6252 comprises a foam such as EVA foam, urethane foam or polyurethan foam. The foam may be injected or otherwise provided into the interior of tube 6148 during the shaping and molding of tube 6148 to assist in maintaining the structural integrity and shape of tube 6148 during the molding and shaping of tube 6148 into the loop of outer frame 6032. In other implementations, the foam material forming frame core 6252 may be injected into the interior of tube 6148 after tube 6148 has been shaped. In still other implementations, one or more layers may be molded about frame core 6252 or wrapped about frame core 6252, prior to being shaped and solidified or cured or after being shaped, solidified or cured, to form the tube 6148 about core 6252; the combined tube 6148 and core 6252 forming the outer frame 6232.

FIG. 44 illustrates pickleball paddle 6320. Pickleball paddle 6320 is similar to pickleball paddle 6220 described above except that paddle 6320 comprises core 6336 and core flexor 6340, particular examples of core 6036 and core flexor 6040. Those remaining components of paddle 6320 which correspond to components of paddle 6020 and/or paddle 6220 are numbered similarly and/or are shown and described with respect to FIGS. 35 and 39.

Core flexor 6340 comprises one or more layers of material or materials extending between portions of core 6336 and outer frame 6232. In the example illustrated, the one or more layers of material or materials encapsulate and/or impregnate the hollow portions of the honeycomb forming core 6036 to mechanically interlock flexor 6340 and core 6036. In some implementations, core flexor 6340 is injected as a fluid into the interiors of core 6036 along the perimeter of core 60366036, along the interior sides of opening 6034 and outer frame 6232, wherein the fluid is allowed to cure or solidify forming the final core flexor 6340. In some implementations, the fluid material is a foam or foaming material. In some implementations the injection of the fluid material to form core flexor 6340 occurs while core 6336 is positioned within the opening defined by outer frame 6232. In other implementations, the injection of the fluid material to form core flexor 6340 may occur prior to positioning of core 6336 into opening 6034, wherein the interlocked core 036 and core flexor 6340, (solidified) are subsequently inserted into opening 6034 and otherwise secured, such as by adhesive, fusing, melting the like, to outer frame 6032.

FIG. 45 illustrates pickleball paddle 6420. Pickleball paddle 6420 is similar to pickleball paddle 6320 described above except that paddle 6420 comprises frame 6132, described above, in place of outer frame 6232. Those remaining components of paddle 6420 which correspond to components of paddle 6020 and/or paddle 6320 are numbered similarly and/or are shown and described with respect to FIGS. 35 and 40.

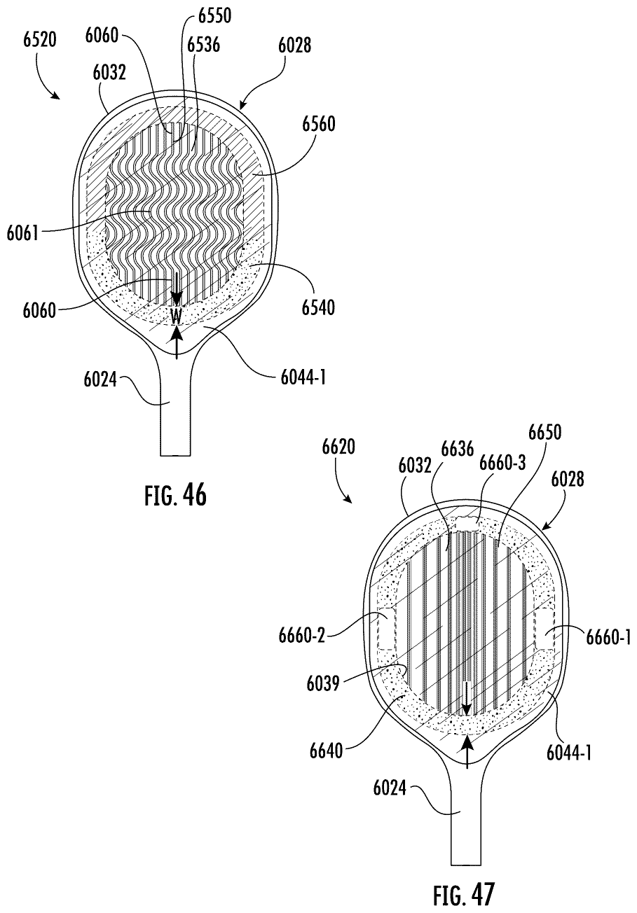

FIG. 46 illustrates an example pickleball paddle 6520. Pickleball paddle 6520 is similar to pickleball paddle 6020 except that paddle 6520 comprises core 6536 in place of core 6036, core flexor 6540 in place of core flexor 6040 and upper wrap 6560. Those remaining components of pickleball paddle 6520 which correspond to components of pickleball paddle 6020 are numbered similarly and/or are described above with respect to FIG. 40.

Core 6636 may be formed from one or more materials and in a manner similar to that described above with respect to the forming of core 6036. Core 6536 is similar to core 6036 except that core 6536 extends in a direction generally parallel to the longitudinal axis of handle 6024. In other words, the orientation of unit cells 6550 is rotated 90° with respect to what is shown in FIG. 40. As with unit cells 6050 of core 6036, unit cells 6550 of core 6636 have linear portions 6060 and a nonlinear portion 6061.

Core flexor 6540 is similar to core flexor 6040 except that core flexor 6540 does not comprise a continuous uninterrupted ring or does not continuously extend around core 6536 in an uninterrupted fashion. In contrast, core flexor 6540 extends along a lower portion of core 6536 between core 6536 and handle portion 6024, terminating at upper wrap 6560. In the example illustrated, core flexor 6540 has a semicircular, semioval or U-shape. As with pickleball paddle 6020, pickleball paddle 6520 may have any of the particular example configurations shown and described above with respect to FIG. 41-45, but terminating at wrap 6560. For example, outer frame 6032 may be in the particular form of outer frame 6132 or outer frame 6232. Core 6536 may be in the form of core 6036 or core 6336. Core flexor 6540 may have a composition and cross-sectional architecture of flexor 6140 or flexor 6340.

Core wrap 6560 extends along the distal end of paddle 6520, the end of paddle 6520 most distant from handle portion 6024. In the example illustrated, wrap 6560 is illustrated as extending about a majority of core 6536, at least 180° about the center of core 6536. In other implementations, wrap 6560 may extend to a greater degree or to a lesser degree about core 6536. Wrap 6560 provides different feel or different pickleball impact properties towards a distant end of paddle 6520 as compared to those portions more proximate to handle portion 6024.

In some implementations, wrap 6560 is formed from a more rigid, less flexible material than that of core flexor 6540, such as a more rigid or more incompressible polymer or metal. In some implementations, wrap 6560 is fastened, welded, fused, bonded otherwise secured to outer frame 6032. In some implementations, wrap 6560 is alternatively secured to core 6036. In some implementations, wrap 6660 may be integrally formed as part of a single unitary body with core 6036, comprising outwardly protruding portions of core 6036. In some implementations, wrap 6560 and core 6536 may be molded as a single body. Core 6536 may have a general oval shape as shown, but additionally with extending portions forming core wrap 6560. In such implementations, wrap 6560 may be perforate.

FIG. 47 illustrates an example pickleball paddle 6620. Pickleball paddle 6620 is similar to pickleball paddle 6020 except that paddle 6620 comprises core 6636 in place of core 6036, core flexor 6640 in place of core flexor 6040 and additionally comprises spacers 6660-1, 6660-2, and 6660-3 (collectively referred to as spacers 6660). Those remaining components of pickleball paddle 6620 which correspond to components of pickleball paddle 6020 are numbered similarly and/or are described above with respect to FIG. 40.

Core 6636 may be formed from one or more materials and in a manner similar to that described above with respect to the forming of core 6036. Core 6636 comprises an internal layer (formed from a stack of layers of unit cells having a configuration similar to the example stacks shown in FIGS. 24, 31, 32 and 33) similar to inner layer 4742 of paddle 4720 (having centerlines that extend parallel to the longitudinal axis of handle 6024) except that unit cell 6650 of core 6636 have varying cross-sectional areas. In the example illustrated, those unit cells closer to the longitudinal axis of handle 6024 have smaller cross-sectional areas (narrower interiors) as compared to those unit cells farther away from the longitudinal axis of handle 6024. In some implementations, this results in the density of unit cells being highest along the longitudinal axis 6024, wherein the density gradually or abruptly reduces towards the lateral sides of the head portion (farthest away from the longitudinal axis 6024).

In some implementations, the unit cells 6650 forming core 6636 may have other orientations. For example, the unit cells 6650 may alternatively extend horizontally across the head, with their centerlines perpendicular to axis 6024. In such implementations, the unit cell 6550 may have the greatest density closest to the longitudinal midpoint of opening 6039, or the density decreases as the unit cells approach either longitudinal end of opening 6039. In still other implementations, unit cell 6650 may diagonally extend across opening 6039, wherein the density of such unit cells (the number of unit cells per area) is greatest for those unit cells that intersect the center point or near a center point of opening 6039.

Core flexor 6640 is similar to core flexor 6040 except that core flexor 6640 does not comprise a continuous uninterrupted ring or does not continuously extend around core 6036 in an uninterrupted fashion. In contrast, core flexor 6640 is interrupted by spacers 6660. As with pickleball paddle 6020, pickleball paddle 6620 may have any of the particular example configurations shown and described above with respect to FIG. 42-45, but with the addition of spacers 6660 at particular locations about core 6636. For example, outer frame 6032 may be in the particular form of outer frame 6132 or outer frame 6232. Core 6636 may be in the form of core 6036 or core 6336. Core flexor 6540 may have a composition and cross-sectional architecture of flexor 6140 or flexor 6340.

Spacers 6660 interrupt the otherwise continuous nature of core flexor 6540. In some implementations, spacers 6660 are formed from a material or materials that are more rigid and less flexible as compared to flexor 6640. In some implementations, spacers 6660 may be formed from polymers or metals. In some implementations, spacers 6660 are fastened, welded, fused, bonded or otherwise secured to outer frame 6032. In some implementations, spacers 6660 are alternatively secured to core. In some implementations, spacers 6660 may be integrally formed as part of a single unitary body with core 6636, comprising outwardly protruding portions of core 6636. For example, core 6636 may have a general oval shape shown, but with protruding tabs or protuberances forming spacers 6660. In such implementations, spacers 6660 may be perforate. In some implementations, spacers 6660 and core 6636 may have a honeycomb configuration, and the spacers 6660 can be extensions of the core 6636. In some implementations, the spacers 6660 may have a reduced thickness, wherein the core flexor 6640 fills or impregnates the perforations to mechanically interlock core flexor 6640 with the protruding portions of core 6636 as described above with respect to paddle 6320 or paddle 6420.

Spacers 6660 may limit or control any relative movement of core flexor 6640 with respect to outer frame 6032. In the example illustrated, spacers 6660-1, 6660-2 and 6660-3 are provided at the 3 o'clock, 9 o'clock and 12 o'clock positions, respectively, as shown in FIG. 47. In other implementations, such spacers 6660 may be provided at other locations. In other implementations, a greater or fewer number of spacers may be employed and the relative size of each of spacers 6660 may be adjusted.

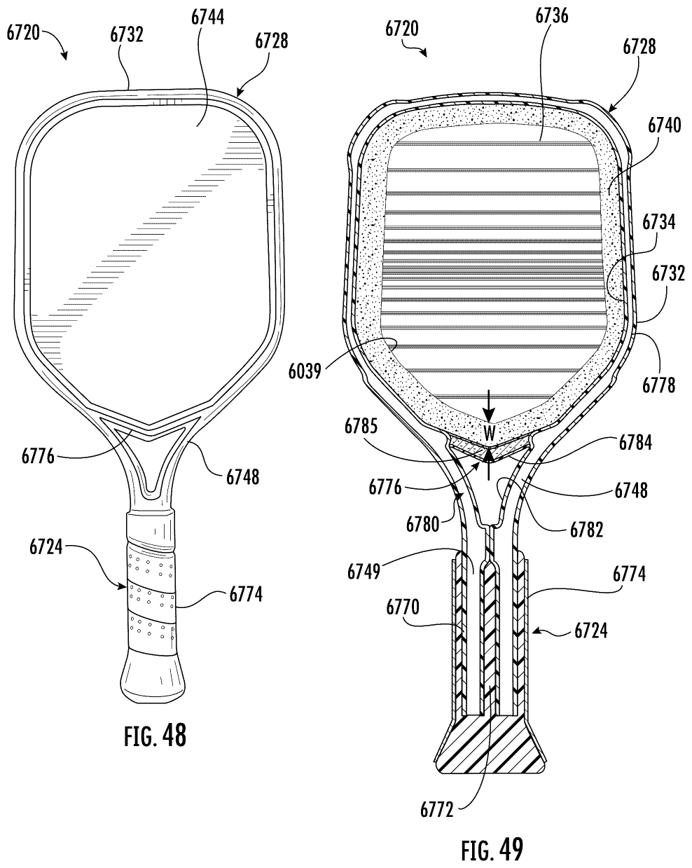

FIGS. 48 and 49 illustrate an example pickleball paddle 6720. FIG. 49 is a sectional view of paddle 6720. Paddle 6720 comprises handle portion 6724 and head portion 6728. The head portion 6728 is coupled to the handle portion 6724 and comprises an outer frame 6732 extending about an opening 6734, core 6736, core flexor 6740 and faceplates 6744 (one of which is shown). Handle portion 6724 is dimensioned so as to be gripped by a player's hand. In some implementations, handle portion 6724 may be round or oval. In other implementations, handle portion 6024 may have a polygon cross-section.

As shown by FIG. 49, hollow tube 6748 forms a portion of both outer frame 6732 and handle portion 6724. The hollow tube 6748 has end portions 6749 that are shaped so as to extend substantially parallel to one another to form a handle core 6770. Handle portion 6724 further comprises a pallet 6772 and an outer wrap 6774. Pallet 6772 extends about the end portion 6749 of tube 6748 to form a uniform outer surface for handle portion 6724. The pallet 6772 can form an outer polygonal shape. In other implementations, the pallet 6772 may for other outer shapes. In some implementations, pallet 6772 may be formed from a wood, such as balsa wood, a foam material or other materials.

Outer wrap 6774 wraps about end portion 6749 and pallet 6772. Outer wrap 6774 provides a gripping surface and texture for handle portion 6724. Outer wrap 6774 may comprise a sleeve or a wrapped band. Outer wrap 6774 may be formed from a polymer, rubber or leather material. In other implementations, handle portion 6724 may not be partially formed from the outer tube 6748, wherein handle portion 6724 may be separately performed and coupled to head portion 6728.

Head portion 6728 provides the hitting surface for paddle 6720. Outer frame 6732 forms an outer rim extending about opening 6734 and forms a perimeter of head portion 6728. In some implementations, bumpers, cushions, weights or wraps of protective material may be provided on exterior portions of outer frame 6732. In other implementation, the outer tube 6748 of the outer frame 6732 can form the outer edge of the head portion 6728. Outer frame 6732 and handle portion 6724 define the maximum width and together, define the maximum length of pickleball paddle 6720.

Outer frame 6732 is formed by the shaped tube 6748 and yoke 6776. Tube 6748 forms a loop which has a lower end closed by yoke 6776 to define opening 6734. As indicated above, in the example illustrated, portions of the tube may further extend in a parallel fashion to form a core of handle portion 6724. In the example illustrated, the tube 6748 forming outer frame 6732 is hollow, having a hollow interior 6778, void of any solid material or filler. For example, the hollow band or tube may have an interior containing a gas, such as air. In some implementations, a bladder may be a hollow tube 6748 containing the air or other gas. In other implementations tube 6748 may be solid, omitting any internal voids, lumens or internal cavities, such as where tube has an interior void filled with another material, such as a foam.

Yoke 6776 comprises a band or tube bridging between opposite portions of tube 6748 at the top of a paddle 6720, opposite to handle portion 6724. Yoke 6776 forms a portion of the outer frame 6732 just above handle portion 6724. Tube 6748 continues to extend below yoke 6776 to form the throat 6780 of paddle 6720 which extends between handle portion 6724 and head portion 6728. The throat 6778 has an opening 6782, defined by tube 6748 and yoke 6776, between yoke 6776 and handle portion 6724.

In the example illustrated, yoke 6776 comprises a tube 6784 having end portions that are fused, bonded otherwise integrated with tube 6748. In the example illustrate, tube 6784 is filled with a filler 6785, such as a foam. In other implementations, tube 6784 may be hollow, omitting any filling or may have other configurations. In other implementations, yoke 6776 may be omitted, such as where and portions 6749 of tube 6748 are brought together at a 90 degree angle so as to omit any opening, such as opening 6782.

Core 6736 comprises an internal layer similar to internal layer 4642 of paddle 4620 (each of the unit cells having centerlines extending perpendicular to the longitudinal axis of the handle 6724 but parallel to the planes of faceplates 6744) except that the density of unit cells 6050 varies across the face of paddle 6720. In the example illustrated, the density of unit cells 6050 (number of unit cells per area) is largest near the longitudinal midpoint of opening 6039 and gradually or abruptly as the unit cells 6050 approach longitudinal ends of opening 6039. The unit cell 6050 closer to the longitudinal midpoint of opening 6039 may have a smaller cross-sectional area (being narrower or smaller) than those unit cells closer to the longitudinal ends of opening 6039. In some implementations, the change in density may be a gradual transition. In other implementations, the change in density of unit cells may be abrupt. Core 6736 may be formed from one or more materials and in a manner similar to that described above with respect to the forming of core 6036.

Core flexor 6740 comprises a structure extending between handle portion 6724 and core 6736, wherein the structure has a greater degree of compressibility and/or a lesser degree of stiffness or rigidity as compared to core 6736. In the example illustrated, the core flexor 6740 completely wraps about or extends about a perimeter of the core 6736 without interruption, in a continuous manner. In the example illustrated, the core flexor 6740 has a width of at least 5 mm at least in regions between the core 6736 and the handle portion 6724, and in some implementations, at least 10 mm. In other implementations, core flexor 6740 may not extend completely about core 6736, such as where core flexor 6740 has a configuration similar to core flexor 6540 (with spacers 6560) or similar to core flexor 6640 (with wrap 6660).

The core flexor 6740 has a stiffness or rigidity less than that of the core. The core flexor 6740 may have a greater degree of compressibility as compared to the compressibility of the core. In some implementations, the core flexor 6740 comprises a foam material. In one example implementation, the core flexor 6740 comprises a foam material. In one example implementation, the core flexor 6740 comprises an ethylene-vinyl acetate (EVA) foam having a density of 2 to 6 pounds. In some examples, the core flexor 6740 has a Shore 00 hardness of 40 to 60. In some implementations, the core flexor 6740 is formed from other polymeric foam materials such as urethane foams or polyurethan foams. In some implementations, the core flexor 6740 can be positioned between the core 6740 and the frame 6732 without the use of an adhesive or other fasteners on the surfaces between the core flexor 6740 and the core 6740, and between the core flexor 6740 and the frame 6732.

In other implementations, the core flexor 6740 may comprise a flexible compressible sleeve, tube or film having a hollow interior or an interior that is filled with a material having a degree of flexibility and/or compressibility that is greater than that of the material forming the core. In yet other implementations, core flexor 6740 may have other configurations or may be formed from other materials. In some implementations, the core flexor 6740 may be glued, welded, fastened or mechanically interlocked to one or both of outer frame 6732 and core 6736.

In other implementations, the core flexor 6740 may comprise a flexible compressible sleeve, tube or film having a hollow interior or an interior that is filled with a material having a degree of flexibility and/or compressibility that is greater than that of the material forming the core 6736. In yet other implementations, core flexor 6740 may have other configurations or may be formed from other materials. In the example illustrated, the core flexor 6740 may be glued, welded, fastened or mechanically interlocked to one or both of outer frame 6732 and core 6736.

In the illustrated example, the core 6736 is inset within the core flexor 6740 without being directly bonded or fixed to core flexor 6740. As result, the core 6736 may be compressed in a direction perpendicular to or normal to the face of the paddle (such as during impact with a pickleball), being compressed relative to core flexor 6740. In some implementations, the core 6736 is supported in a fashion similar to that of a trampoline by the flexor 6740 which serves as a support similar to the springs in a trampoline. In such implementations, the coefficient of restitution of core 6736 may be enhanced. In some implementations, core 6736, at least partially supported by flexor 6740, is provided with a coefficient of restitution of at least 0.40, and in some implementations, at least 0.46. In such implementations, the opposite faces of the core 6736 and the core flexor 6740 may be directly bonded to the interior faces of faceplates 6744.

Core flexor 6740 assists in isolating the primary sweet spot and impact regions of the paddle 6720 from the handle portion 6724 of the paddle 6720. Core flexor 6740 may dampen vibration and other forces resulting from impact with the pickleball, inhibiting such forces from being transmitted to the handle portion 6724 of the pickleball paddle 6720. Core flexor 6740 may enhance responsiveness of the impact portion of the pickleball by facilitating a degree of floating or movement of the impact region (sometimes referred to as the core) relative to the handle portion 6724.

Similar to faceplates 6044, faceplates 6744 extend on opposite faces of head portion 6728 and provide the surfaces against which the pickleball impacts. Faceplates 6744 extend over and cover both core 6736 and core flexor 6740. In some implementations, faceplates 6744 completely cover front and rear faces of outer frame 6732. In other implementations, faceplates 6744 partially extend over and partially cover the front and rear faces of outer frame 6732. Faceplates 6744 are generally smooth and may be formed from a polymer, cellulose material or other materials or combinations of materials. In the example illustrated, faceplates 6744 satisfy the requirements set forth in the November 2023 USA Pickleball Equipment Standards Manual. Each of faceplates 6744 has a maximum kinetic coefficient of friction less than or equal to 0.1875 when tested pursuant to protocol IAW ASTM D1894-14.

Although pickleball paddle 6720 is illustrated as having the hollow interior, void of any internal filling, and as having core flexor 6740, in other implementations, pickleball paddle 6720 may have any of the particular example configurations shown and described above with respect to FIGS. 42-45. For example, outer frame 6732 may be in the particular form of outer frame 6132 or outer frame 6232. Core 6736 may be in the form of core 6036 or core 6336. Core flexor 6740 may have a composition and cross-sectional architecture of flexor 6140 or flexor 6440.

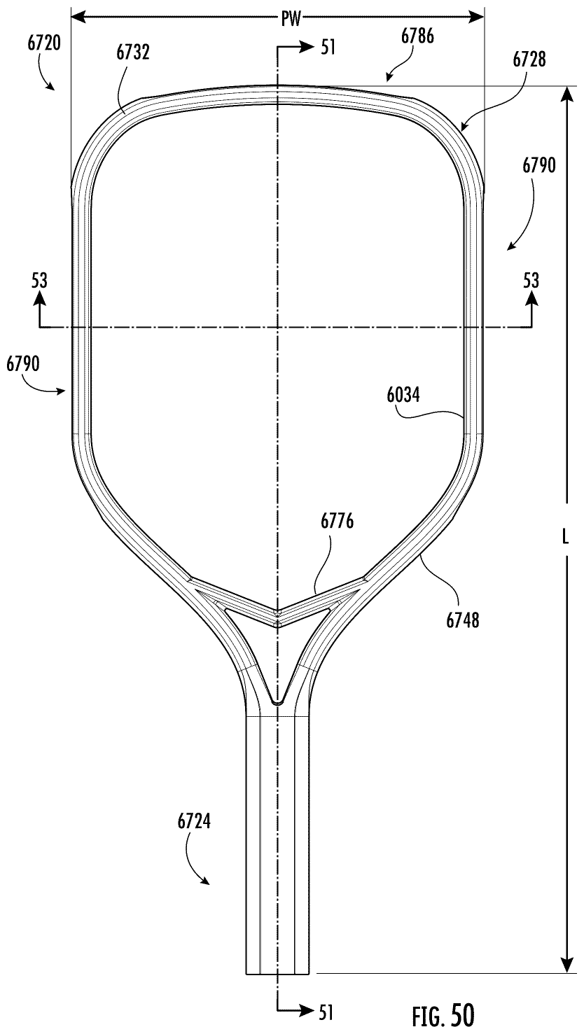

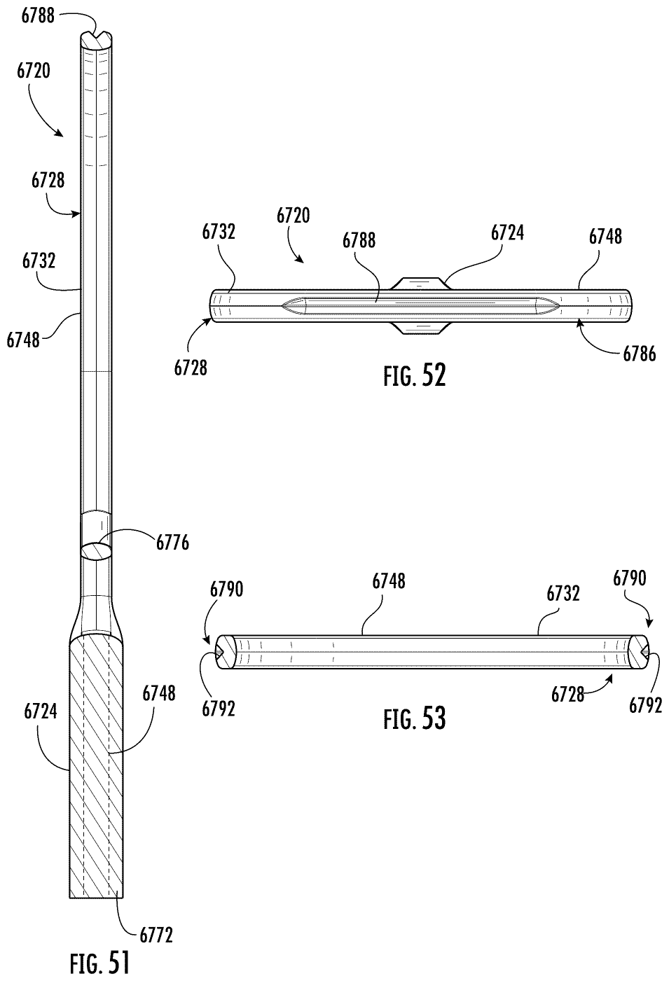

FIGS. 50-53 illustrate pickleball paddle 6720 without core 6736, core flexor 6740 or handle wrap 6774. FIGS. 50-53 illustrate tube 6748 and the remaining components that form handle portion 6724. FIG. 50 is a front view of the depicted portion of paddle 6720. FIG. 51 is a sectional view of the depicted portion of paddle 720 taken along line 51-51 of FIG. 50. FIG. 52 is a top view of the depicted portion of paddle 6720. FIG. 52 is a sectional view of paddle 6720 taken along line 52-52 of FIG. 50.

As noted above, outer frame 6732 and handle portion 6724 define the maximum length L of paddle 6720. Outer frame 6732 further defines the maximum paddle width PW. Outer frame 6732 and handle portion 6724 satisfy the requirements set forth in the November 2023 USA Pickleball Equipment Standards Manual. The sum of the maximum length L and the maximum paddle width PW of paddle 6720 is less than or equal to 24 inches.

As further shown by FIGS. 51-53, the outer frame 6732 has an outer perimeter comprising grooves or channels. As shown by FIGS. 51 and 52, the top 6786 of outer frame 6732 has an indentation or groove 6788 projecting inwards into the tube 6748. The groove 6788 has ends and terminates prior to reaching the sides 6790 of outer frame 6732. As shown by FIG. 53, the sides 6790 of outer frame 6732 have indentation the grooves 6792 projecting inwards into tube 6748. The grooves 6788 and 6792 do not impair the structural integrity of tube 6748, merely comprise outer perimeter surfaces of tube 6748 that are bent inwardly deformed. Such grooves may assist in increasing the stiffness or rigidity of outer frame 6732. Although such grooves 6788 and 6792 are illustrated having a V-shape, for aesthetics, it should be appreciated such grooves may have other cross-sectional shapes, such as U-shaped, semicircular, semi-ovular and other curved or irregular shapes, and may have other relative sizes and depths. In some implementations, grooves 6788 and 6792 may replace with a single continuous groove or channel that continuously extends around and along the top 6786 and the sides 6790. In some implementations, the grooves 6788 and 6792 are molded during the shaping of tube 6748. In one implementation the top 6786 can be formed without groove 6788 and sides 6790 can include grooves 6792. In another implementation, the top 6786 can be formed with groove 6788 while the sides can be formed without groove 6792.

In some implementations, tube 6748 and yoke 6776 are formed from a fiber composite material. As used herein, the term “fiber composite material” or “composite material” refers to a plurality of fibers within and permeated throughout a resin. The fibers can be co-axially aligned in sheets, layers or plies, or braided or weaved in sheets or layers, and/or chopped and randomly dispersed in one or more layers. A single ply typically includes hundreds or thousands of fiber bundles that are initially arranged to extend coaxially and parallel with each other through the resin that is initially uncured. Each of the fiber bundles includes a plurality of fibers. The fibers are formed of a high tensile strength material such as carbon. Alternatively, the fibers can be formed of other materials such as, for example, glass, graphite, boron, basalt, carrot, Kevlar, Spectra, poly-para-phenylene-2,6-benzobisoxazole (PBO), hemp, flax, other natural fibers and combinations thereof. In one set of preferred implementations, the resin is preferably a thermosetting resin such as an epoxy or a polyester resin. In other sets of preferred implementations, the resin can be a thermoplastic resin. The composite material is typically wrapped about a mandrel and/or a comparable structure and cured under heat and/or pressure. While curing, the resin is configured to flow and fully disperse and extend throughout the matrix of fibers. In multiple layer or ply constructions, the fibers can be aligned in different directions with respect to the longitudinal axis, and/or in braids or weaves from layer to layer.

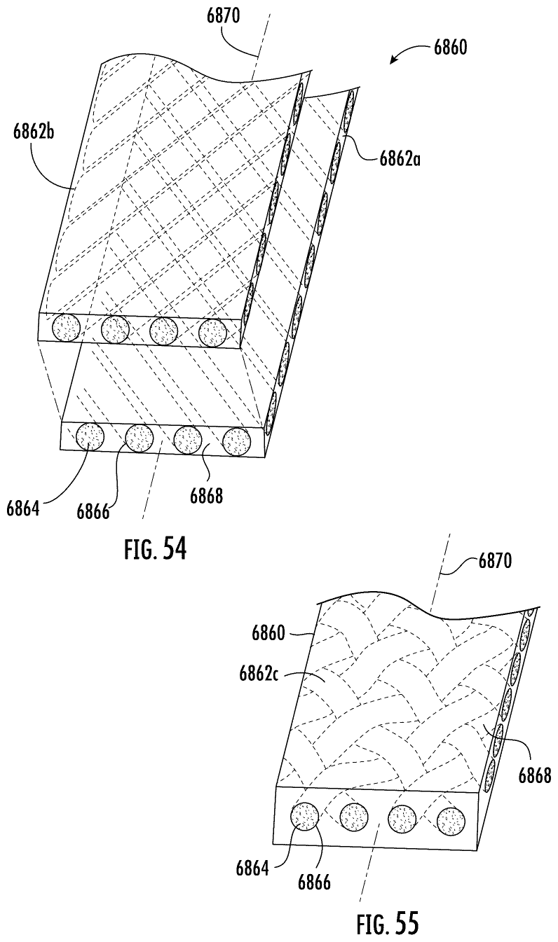

Referring to FIG. 54, a portion of a layer 6860 of fiber composite material is illustrated. The layer 6860 is formed by one or two plies 6862 (6862a and 6862b) of fiber composite material. A ply 6862 of fiber composite material refers to an arrangement of fibers 6864 and fiber bundles 6866 in a resin 6868, wherein the fibers 6864 and the fiber bundles 6866 are arranged and aligned such that the fibers 6864 and the fiber bundles 6866 generally extend coaxially with respect to each other and are generally parallel to one another. The fibers 6864 or fiber bundles 6866 are preferably formed such that they extend along the ply 6862 and form generally the same angle with respect to an axis, such as a composite axis 6870. The plies 6862 are typically identified, at least in part, by the size and polarity of the angle defined by the fibers 6864 or fiber bundles 6866 with respect to the axis 6870. As shown in FIG. 43, the ply 6862a has fibers 6864 and fiber bundles 6866 aligned at a positive 45 degree angle ply, and the ply 6862b has fibers 6864 and fiber bundles 6866 aligned at a negative 45 degree angle ply. In other implementations, the plies 6862 can include fibers 6864 or fiber bundles 6866 defining a positive 30 degree angle ply, a negative 30 degree angle ply, a positive 45 degree angle ply, a negative 45 degree angle ply, a positive 40 degree angle ply, a negative 40 degree angle ply, a positive 35 degree angle ply, a negative 35 degree angle ply, a 90 degree angle ply (extending perpendicular to the axis), and a 0 degree angle ply (or extending parallel to the axis). Other positive or negative angles for plies can also be used. Accordingly, in the present application, a single ply 6862 refers to a single layer of fiber composite material in which the fiber bundles 6866 extend in substantially the same direction with respect to a longitudinal axis along the single layer, such as plus or positive 45 degrees or minus or negative 30 degrees. A layer 6860 formed of a pair of plies 6862 having fibers 6864 of generally the same angle but arranged with opposite polarities is also referred to a ply arrangement. This pattern typically extends throughout a fiber composite material. The alternating angular arrangement of the fiber bundles 6866 and fibers 6864 is important to achieving and maintaining the structural integrity of the component or structure being formed of the fiber composite material. The overlapped region of the two plies 6862a and 6862b can be essential for ensuring that, once cured, the fiber composite material has the desired strength, durability, toughness and/or reliability.

During heating/molding and curing, the resin 868 can flow between plies 862 and within the fiber bundles 6866. The plies 6862 preferably typically have a thickness within the range of 0.002 to 0.015 inch. In other implementations, other thickness ranges can also be used.

As shown by FIG. 55, in other implementations, one or more of the layers 6860 can include a plurality of braided fibers 6862c. The braided fibers 6862c can extend at angles with respect to the lay-up axis 6870 of at least 35 degrees with positive and negative polarities. In other implementations, the braided fibers 6862c can extend at angles with respect to the lay-up axis 6870 of at least 40 degrees (with positive and negative polarities).

Although each of the paddles 6020, 6120, 6220, 6320, 6420, 6520, 6620 and 6720 are described as having the particular inner layers or cores as shown, it should be appreciated that any of the cores or inner layers described in the present disclosure may be interchanged. For example, paddle 6020 may alternatively have any of the cores 6536, 6636, 6736 in place of core 6036. Likewise, any of paddles 6020, 6120, 6220, 6320, 6420, 6520, 6620 and 6720 may alternatively have any of the internal layers 4642, 4742, 4842, 4942, 5042 and 5142 described above, wherein such inner layers are positioned within opening 6039 within the associated core flexor.

In some implementations, rather than the entirety of the particular inner layer or core being formed from a single integral unitary body (such as a single extruded panel formed from multiple layers of unit cells), an inner layer or core may alternatively be formed from multiple pieces that are positioned adjacent to one another to form the head of the paddle or positioned within opening 6039. The pieces may be bonded, welded or interlocked to one another. In some implementations, each of the pieces may have a different honeycomb arrangement of unit cells. For example, the paddle may comprise a core or inner layer comprising a first piece having a honeycomb arrangement of unit cells similar to that of core 6036, a second piece having a honeycomb arrangement of unit cells similar to that of inner layer 4642 and a third piece having a honeycomb arrangement of unit cells similar to that of inner layer 4742. In such a manner, the performance and sound dampening offered by the core construction may be tuned to a player's preferences or tuned based upon its proximity to a sweet spot (or primary hitting region) of the hitting surface of the paddle.

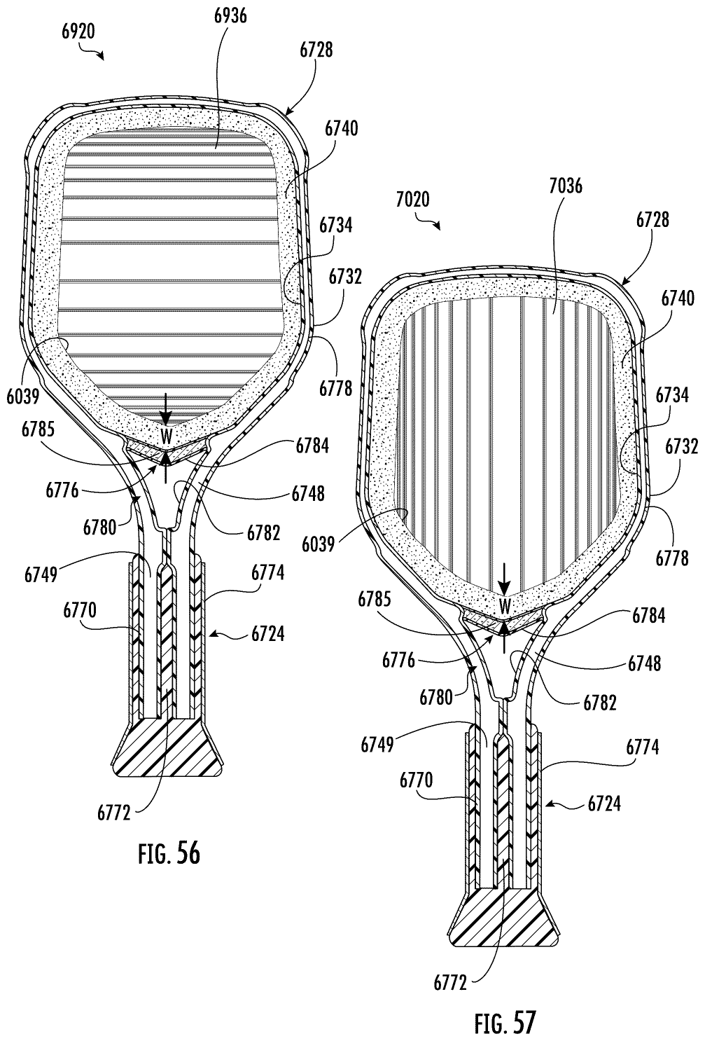

FIG. 56 is a sectional view of an example pickle ball paddle 6920. Paddle 6920 is similar to paddle 6720 except that paddle 6920 comprises an inner layer or core 6936. Core 6936 may be formed from one or more materials and in a manner similar to that described above with respect to the forming of core 6036. Core 6936 is similar to internal layer 4742 of paddle 4720 (in that each of the unit cells have centerlines extending perpendicular to the longitudinal axis of the handle 6724 and parallel to the planes of faceplates 6744 (shown in FIG. 48), except that core 6936 comprises unit cells 6950 that have a density (number of unit cells per area in a plane parallel to the plane of faceplates 6744) that is largest near the longitudinal ends of opening 6039 and gradually or abruptly decreases as the unit cells 6050 approach longitudinal midpoint of opening 6039. The unit cells 6050 closer to the longitudinal midpoint of opening 6039 may have a larger cross-sectional area (being narrower or smaller) than those unit cells closer to the longitudinal ends of opening 6039. In some implementations, the change in density may be a gradual transition. In other implementations, the change in density of unit cells may be abrupt.

In one implementation, the unit cells 6950 comprise elongate hollow tubes having a polygon cross-sectional shape, such as a hexagonal cross-sectional shape or other polygon shapes. In one implementation, the unit cells 950 comprise elongate hollow tubes having a non-polygon shapes, such as a circular or oval cross-sectional shape. In one implementation, core 6936 comprises two layers of unit cells 6950 with the unit cells of one layer being longitudinally offset from those unit cells of a adjacent layer such that the unit cells of the layers inter-nest. In some implementations, the unit cell 6950 have aligned centerlines (as described above with respect to paddle 5620). In some implementations, core 6936 may comprise multiple layers. The layers may be fused or bonded to one another or may be loose so as to be permitted to move relative to one another. In some implementations, layers may be spaced from one or both of the faceplates 6744 or from one another by intervening layers (such as described above with respect to paddle 5420). In some implementations, core flexor 6740 may be omitted, wherein the unit cells extend completely to the internal sides of outer frame 6732. In some implementations, rather than linearly extending across opening 6039, unit cells 6950 may nonlinearly extend across opening 6039 (similar to the unit cells of paddles 5020, 5120 or 6020).

FIG. 57 is a sectional view of an example pickle ball paddle 7020. Paddle 7020 is similar to paddle 6720 except that paddle 6920 comprises an inner layer or core 7036. Core 7036 may be formed from one or more materials and in a manner similar to that described above with respect to the forming of core 6036. Core 7036 is similar to internal layer 4742 of paddle 4720 (each of the unit cells having centerlines extending parallel to the longitudinal axis of the handle 6724 and parallel to the planes of faceplates 6744 (shown in FIG. 48), except that core 7036 comprises unit cells 7050 that have a density (number of unit cells per area in a plane parallel to the plane of faceplates 6744) that is largest near the transverse sides of opening 6039 and gradually or abruptly decreases as the unit cells 7050 approach a transverse midpoint of opening 6039 (as a approach the longitudinal centerline of handle 6724). The unit cells 7050 closer to the transverse or lateral midpoint of opening 6039 may have a larger cross-sectional area (being narrower or smaller) than those unit cells closer to the transverse or lateral sides of opening 6039. In some implementations, the change in density may be a gradual transition. In other implementations, the change in density of unit cells may be abrupt.

In one implementation, the unit cells 7050 comprise elongate hollow tubes having a polygon cross-sectional shape, such as a hexagonal cross-sectional shape or other polygon shapes. In one implementation, the unit cells 7050 comprise elongate hollow tubes having a non-polygon shapes, such as circular or oval cross-sectional shapes. In one implementation, core 6936 comprises two layers of unit cells 6950 with the unit cells of one layer being laterally offset from those unit cells of an adjacent layer such that the unit cells of the layers inter-nest. In some implementations, the unit cells 7050 have aligned centerlines (as described above with respect to paddle 5620). In some implementations, core 7036 may comprise a single layer or more than two layers. The layers may be fused or bonded to one another or may be loose so as to be permitted to move relative to one another. In some implementations, layers may be spaced from one or both of the faceplates 6744 and/or from one another by intervening layers (such as described above with respect to paddle 5420). In some implementations, core flexor 6740 may be omitted, wherein the unit cells 7050 extend completely to the internal longitudinal ends of outer frame 6732. In some implementations, rather than linearly extending across opening 6039, unit cells 7050 may nonlinearly extend across opening 6039 (similar to the unit cells of paddles 5920 or 6620).

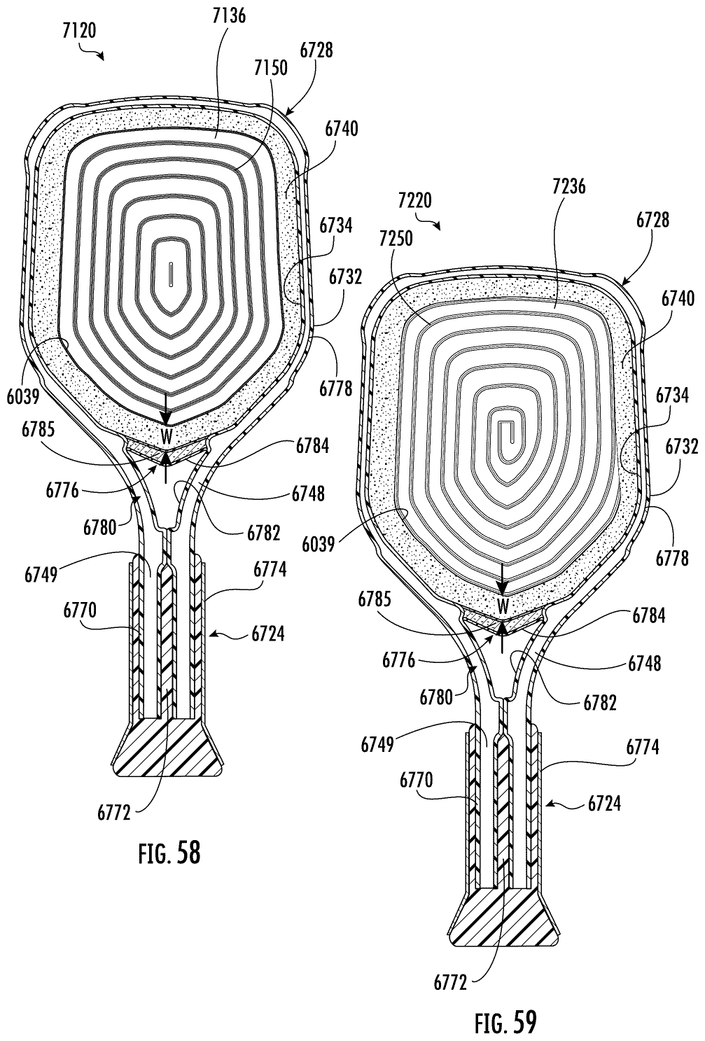

FIG. 58 is a sectional view of an example pickle ball paddle 7120. Paddle 7120 is similar to paddle 6720 except that paddle 6920 comprises an inner layer or core 7136. Core 7136 may be formed from the same material described above for forming core 6036. In some implementations, core 7136 may be molded. In some implementations, core 7136 may be formed by forming differently sized rings (circular or noncircular) and fusing or bonding such rings within one another.

Core 7136 is similar to internal layer 4742 of paddle 4720 (in that each of the unit cells having centerlines extending parallel to the planes of faceplates 6744 (shown in FIG. 48), except that core 7136 comprises unit cells 7151. Unit cells 7151 comprise elongate hollow tubes having centerlines that form closed curves. In the example illustrated, the closed curves are symmetrical with different sizes such that the closed curves lie adjacent to one another within one another. In the example illustrated, the unit cells 7151 have centerlines that form closed curves in the shape of opening 6039 which corresponds to interior profile of outer frame 6732. The multiple closed curves are successively smaller going inward such that the closed curves are nested within one another. In other implementations cells 7151 may comprise centerlines that form closed curves in the shape of circles, wherein the circles are concentrically arranged within one another. Any space between the outermost circular tube may be filled with the material of core flexor 6740. In yet other implementations, the unit cell 7151 may form oval or of other close curve shapes. In some implementations, core flexor 6740 may be omitted, wherein the outermost formed by the outermost tube extends adjacent to the interior side of frame 6732, along the interior side of opening 6734.

The hollow tubes forming unit cells 7150 may have a non-polygon cross-sectional shape, such as a circular or oval cross-sectional shape. In other implementations, the tubes may have a polygon cross-sectional shape, such as a hexagonal cross-sectional shape or other polygon shapes. In one implementation, core 7136 comprises two layers of unit cells 7150 with the unit cells of one layer are offset from those unit cells of an adjacent layer such that the unit cells of the layers inter-nest. For example, the unit cell 7150 of a first layer may have a slightly different size (radius as in the case of a circle) as compared to a second adjacent layer such that inter-nest. In some implementations, the unit cells 7150 have aligned centerlines (as described above with respect to paddle 5620). In some implementations, core 7136 may comprise a single layer or more than two layers. The layers may be fused or bonded to one another or may be loose so as to be permitted to move relative to one another. In some implementations, layers may be spaced from one or both of the faceplates 6744 and/or from one another by intervening layers (such as described above with respect to paddle 5420).

FIG. 59 is a sectional view of an example pickle ball paddle 7220. Paddle 7220 is similar to paddle 6720 except that paddle 7220 comprises an inner layer or core 7236. Core 7236 is similar to internal layer 4742 of paddle 4720 in that each of the unit cells having centerlines extending parallel to the planes of faceplates 6744 (shown in FIG. 48). Core 7236 differs from internal layer 4742 in that core 7136 comprises a single unit cell 7250, a single continuous hollow tube, having a centerline that extends along a helix. In the example illustrated, the helix has a cross-sectional shape or path corresponding to shape of opening 6039 (when core flexor 6740 is provided) or corresponding to the shape of opening 6734 (when core flexor 6740 is omitted). In other implementations, unit cell 7250 may have a centerline in the form of an oval or circular helix, wherein regions between the outermost extent of the helix and the interior side of either the opening 6734 are filled with the material of core flexor 6740, filled with other unit cells in the form of other helixes, filled with other unit cells that linearly or nonlinearly extend about the unit cell 7250, or filled with other unit cells that form closed curves about the helix of unit cells 7250.

The hollow tube forming unit cell 7250 may have a non-polygon cross-sectional shape, such as a circular or oval cross-sectional shape. In other implementations, the tube may have a polygon cross-sectional shape, such as a hexagonal cross-sectional shape or other polygon shapes. In one implementation, core 7236 comprises two layers of unit cells 7150 with the unit cells of one layer are offset from those unit cells of an adjacent layer such that the unit cells of the layers inter-nest. For example, the unit cell 7250 of a first layer may have the same shape but a slightly different path inward of the outward of the unit cell 7250 of a second adjacent layer such that the unit cell 7250 of the two layers inter-nest. In some implementations, the unit cells 7250 have aligned centerlines (as described above with respect to paddle 5620). In some implementations, core 7236 may comprise a single layer or more than two layers. The layers may be fused or bonded to one another or may be loose so as to be permitted to move relative to one another. In some implementations, layers may be spaced from one or both of the faceplates 6744 and/or from one another by intervening layers (such as described above with respect to paddle 5420).

Core 7236 may be formed from the same material described above with respect to core 6036. In some implementations, core 7236 is formed by molding the helical shape with the single continuous tube. In some implementations, core 7236 may be formed by molding single elongate linear tube and then winding the tube, while it is in a flexible state, into the helical shape. When in the helical shape, the outer side of a first portion of the tube contacts and abuts (and in some implementations, is fused or bonded to) the outer side of the second portion of the same tube. In some implementations, the single elongate tube may remain flexible as part of paddle 7220. In some implementations, the elongate tube may be compressible. In some implementations, the single elongate tube/unit cell may be wound, while in a flexible state, into a helix to form a single layer which is then subsequently positioned adjacent to other similarly formed layers. In some implementations, a linear stack of multiple tubes/unit cells may be molded or extruded as a single integral or unitary piece, wherein the stack is then wound into the helix shown to form multiple layers of the core 7236. In such implementations, the tube or tubes may be permanently flexible or the tubes or tubes may be in a partially molten, uncured are un-solidified flexible state during the helical winding, wherein the tube or tubes cure (as with a thermoset) or harden (as with a thermoplastic) after being wound into a helix, the tumor tubes assuming a permanent helical shape.

Each of the above examples describe multiple combinations of different features. It should be understood that although the examples illustrate particular features as being combined or employed with one another, each of such features may be independently used or employed as part other combinations of features in other implementations of a pickle ball paddle. Individual aspects or features such as the size of unit cells, cross-sectional shapes of unit cells, number of layers, orientation of the layers with respect to the faceplates and/or longitudinal axis of the handle, alignment of the unit cells of consecutive layers, linear, wavy, zigzag or other path of the unit cells, the provision of spacer layers, the varying density of unit cells longitudinally or transversely across the face of the paddle, the maximum density of the unit cells being proximate a longitudinal or transverse midpoint or proximate an end or sides of the head, as shown and described above in the various examples, may likewise be combined or independently used with any other of such features in a pickleball paddle. For example, any of the inner layers or cores may be used to form any of the head portions of any of the pickleball paddles. By way of a particular example, the cores shown in FIGS. 40, 46, 47, 49 and 56-59 may be used in any paddle, such as those paddles that omit the core flexor or omit an outer frame (where the core forms a perimeter of the head portion or is directly covered with a bumper or edge cover). Any of the above-described cells or layers of unit cells may be used to form any of the cores or inner layers of any of the example pickle ball paddles.

The claims of the present disclosure are generally directed to a pickleball paddle comprising a handle extending along a longitudinal axis; and a head portion coupled to the handle and comprising a first plate extending in a first plane, a second plate extending in a second plane parallel to the first plane and a honeycomb arrangement of unit cells between the first plate and the second plate, wherein each of the unit cells has a centerline extending non-perpendicular to the first plane and the second plane, the present disclosure is additionally directed to the features set forth in the following definitions.
1. A pickleball paddle comprising:
a handle extending along a longitudinal axis; and
a head portion coupled to the handle and comprising a first plate extending in a first plane, a second plate extending in a second plane parallel to the first plane and at least one unit cell between the first plate and the second plate, the at least one unit cell having a centerline extending non-perpendicular to the first plane and the second plane.
2. The pickle ball paddle of Definition 1, wherein the at least one unit cell comprises unit cells that are arranged in a first layer proximate the first plate and a second layer proximate the second plate.
3. The pickle ball paddle of Definition 2, wherein the first layer is offset from the second layer such that unit cells of the first layer and the second layer inter-nest.
4. The pickle ball paddle of Definition 2, wherein unit cells of the first layer are aligned with unit cells of the second layer.
5. The pickle ball paddle of Definition 2, wherein the first layer is fused or bonded to the second layer.
6. The pickle ball paddle of Definition 2, wherein the first layer is movable relative to the second layer.
7. The pickle ball paddle of Definition 2 further comprising at least one intermediate layer between and adjacent to the first layer and the second layer, the at least one intermediate layer omitting unit cells.
8. The pickle ball paddle of Definition 2 further comprising at least one outer layer between adjacent to the first layer and the first panel, the least one outer layer omitting unit cells.
9. The pickle ball paddle of Definition 8, wherein the outer layer is foamed.
10. The pickle ball paddle of Definition 2, wherein the unit cells of the first layer comprise a first unit cell having a first geometry and a first cross-sectional size and a second cell having the first geometry and a second cross-sectional size different than the first cross-sectional size.
11. The pickle ball paddle of Definition 2, wherein the unit cells of the first layer comprise a first unit cell having a first geometry and a second unit cell having a second geometry different than the first geometry.
12. The pickle ball paddle of Definition 2, wherein the first layer comprises a first unit cell having a first geometry and a first cross-sectional size, wherein the second layer comprise a second unit cell having a second geometry and a second cross-sectional size, and wherein at least one of the first geometry and the first cross-sectional size is different than the second geometry and the second cross-sectional size, respectively.
13. The pickle ball paddle of any of Definitions 1-12 further comprising an edge cover along a perimeter of the head portion, the edge cover being translucent or transparent.
14. The pickle ball paddle of any of Definitions 1-12 further comprising a edge cover along a perimeter of the head portion, the bumper being perforate with an opening in communication with an axial end opening of the at least one unit cell.
15. The pickle ball paddle of any of Definitions 1-14, wherein the head portion comprises an outer frame about an opening, wherein the at least one unit cell forms a core within the opening and wherein the pickle ball paddle further comprises a core flexor between the core and the outer frame.
16. The pickle ball paddle of any of Definitions 1-14, wherein the at least one unit cell comprises unit cells that have a varying density across a face of the head portion.
17. The pickle ball paddle of Definition 1, wherein the at least one unit cell comprises unit cells, wherein a density of the unit cells increases from a transverse midpoint of the head portion towards lateral sides of the head portion.
18. The pickle ball paddle of Definition 1, wherein the at least one unit cell comprises unit cells, wherein a density of the unit cells decreases from a transverse midpoint of the head portion towards lateral sides of the head portion.
19. The pickle ball paddle of Definition 1, wherein the at least one unit cell comprises unit cells, wherein a density of the unit cells decreases from a longitudinal midpoint of the head portion towards longitudinal ends of the head portion.
20. The pickle ball paddle of Definition 1, wherein the at least one unit cell comprises unit cells, wherein a density of the unit cells increases from a longitudinal midpoint of the head portion towards longitudinal ends of the head portion.
21. The pickle ball paddle of Definition 1, wherein the at least one unit cell comprises unit cells, wherein the unit cells have centerlines forming respective closed curves.
22. The pickle ball paddle of Definition 21, wherein the head portion has a shape and wherein the closed curves correspond to the shape.
23. The pickle ball paddle of Definition 1, wherein the at least one unit cell comprises a unit cell extending in a helix.
24. The pickle ball paddle of Definition 1, wherein the head portion has a first shape and wherein the helix has a second shape corresponding to the first shape.

Although the present disclosure has been described with reference to example implementations, workers skilled in the art will recognize that changes may be made in form and detail without departing from disclosure. For example, although different example implementations may have been described as including features providing various benefits, it is contemplated that the described features may be interchanged with one another or alternatively be combined with one another in the described example implementations or in other alternative implementations. Because the technology of the present disclosure is relatively complex, not all changes in the technology are foreseeable. The present disclosure described with reference to the example implementations and set forth in the following claims is manifestly intended to be as broad as possible. For example, unless specifically otherwise noted, the claims reciting a single particular element also encompass a plurality of such particular elements. The terms “first”, “second”, “third” and so on in the claims merely distinguish different elements and, unless otherwise stated, are not to be specifically associated with a particular order or particular numbering of elements in the disclosure.

What is claimed is:

1. A pickleball paddle comprising:
a handle extending along a longitudinal axis; and
a head portion coupled to the handle and comprising a first plate extending in a first plane, a second plate extending in a second plane parallel to the first plane and a honeycomb arrangement of unit cells between the first plate and the second plate, each of the unit cells having a centerline extending non-perpendicular to the first plane and the second plane.

2. The pickleball paddle of claim 1, wherein the centerline of each of the unit cells extends parallel to the first plane and the second plane.

3. The pickleball paddle of claim 2, wherein the centerline of each of the unit cells extends parallel to the longitudinal axis of the handle.

4. The pickleball paddle of claim 2, wherein the centerline of each of the unit cells extends perpendicular to the longitudinal axis of the handle.

5. The pickleball paddle of claim 2, wherein the centerline of each of the unit cells extends oblique to the longitudinal axis of the handle.

6. The pickleball paddle of claim 1, wherein the centerline of each of the unit cells extends oblique to the first plane and the second plane.

7. The pickleball paddle of claim 1, wherein the unit cells have parallel centerlines.

8. The pickleball paddle of claim 1, wherein the centerline of each of the unit cells extends from a first side edge of the head portion to a second side edge of the head portion.

9. The pickleball paddle of claim 1, wherein each of the unit cells has an identical base geometry.

10. The pickleball paddle of claim 9, wherein the unit cells comprises a partial unit cell omitting a wall adjacent to the first plate and a complete unit cell between the partial unit cell and the second plate.

11. The pickleball paddle of claim 1, wherein the unit cells comprise a complete unit cell adjacent the first plate.

12. The pickleball paddle of claim 11, wherein the unit cells comprise a second complete unit cell adjacent to the second plate.

13. The pickleball paddle of claim 1, wherein the first plate and the unit cells are integrally formed as a single unitary body.

14. The pickleball paddle of claim 1, wherein the first plate is bonded to the unit cells.

15. The pickleball paddle of claim 1 further comprising a bumper continuously extending about the head portion, the bumper being integrally formed as part of a single unitary body with the unit cells.

16. The pickleball paddle of claim 1, wherein the centerline of each non linearly extends along at least a portion of a length of each of the unit cells.

17. A pickleball paddle comprising:
a handle extending along a longitudinal axis; and
a head portion coupled to the handle and comprising a first plate, a second plate, and a honeycomb arrangement of unit cells, each of the unit cells having a centerline extending along an axis parallel to the first plate and the second plate.

18. The pickleball paddle of claim 17, wherein the centerline of each of the unit cells extends perpendicular to the longitudinal axis.

19. The pickleball paddle of claim 17, wherein the centerlines of each the unit cells extends parallel to the longitudinal axis.

20. The pickleball paddle of claim 17, wherein the centerlines of each the unit cells extends oblique to the longitudinal axis.
